(19) United States
(12) Patent Application Publication
(10) Pub. No.: US 2017/0329892 A1
(43) Pub. Date: Nov. 16, 2017

(54) COMPUTATIONAL METHOD FOR CLASSIFYING AND PREDICTING PROTEIN SIDE CHAIN CONFORMATIONS

(71) Applicant: ACCUTAR BIOTECHNOLOGY INC., Brooklyn, NY (US)

(72) Inventors: Jie FAN, New York, NY (US); Ke Liu, Shanghai (CN)

(73) Assignee: ACCUTAR BIOTECHNOLOGY INC., Brooklyn, NY (US)

(21) Appl. No.: 15/591,075

(22) Filed: May 9, 2017

Related U.S. Application Data
(60) Provisional application No. 62/334,173, filed on May 10, 2016.
(60) Provisional application No. 62/357,634, filed on Jul. 1, 2016.
(60) Provisional application No. 62/475,328, filed on Mar. 23, 2017.

(51) Int. Cl. G06F 19/16; G06F 19/28; G06F 19/24; G06N 99/00; G06F 17/50

(52) U.S. Cl. CPC G06F 19/16; G06N 99/005; G06F 17/5009; G06F 19/24; G06F 19/28

(57) ABSTRACT

Computational methods for classifying and predicting protein side chain conformations utilizing a data driven scoring function are disclosed. According to some embodiments, the methods may include obtaining structure data representing a plurality of conformations of a compound. The methods may also include determining structural differences among the conformations. The methods may also include classifying, based on the structural differences, the conformations into one or more clusters. The methods may also include determining representative conformations of the dusters, wherein an average structural difference between a representative conformation of a duster and conformations in the duster is below a predetermined threshold. The method may further include determining the representative conformations as poses of the compound.

### RELATED APPLICATIONS

This application claims priority from U.S. Provisional Patent Application Nos. 62/334,173, filed on May 10, 2016, 62/357,634, filed on Jul. 1, 2016, and 62/475,328, filed on Mar. 23, 2017, the entire contents of all of which are incorporated by reference in the present application.

### TECHNICAL FIELD

The present disclosure generally relates to the technical field of computational biology and, more particularly, to computational methods for classifying and predicting protein side chain conformations.

### BACKGROUND

Conventional drug discovery is a costly and lengthy process that typically involves large-scale compound screening or semi-rational design largely unguided by the structure information of the drug target. In the past two decades, the advances in protein structural determination techniques and the establishment of proteomics and protein structure databases gave medicinal chemists unprecedented access to vast structure information of numerous known and new drug targets. Knowledge of protein structure at atomic resolution is essential for modeling biological function and structure-based drug discovery approaches. Structure-based drug design holds great promises since it allows synthesizing more focused compound libraries, improving hit rates and potency of candidates, and reducing the time and cost associated with the drug discovery process. While structure information of drug targets is now commonly used for explaining and validating drug-target interactions, it remains challenging to predict valid drug candidates based on the structure of a drug target.

The challenges for structure-based drug design in part lie in how to accurately predict side chain conformations of a given drug target. For any given peptide sequence, there may be a significant number of biologically relevant conformations, not to mention possible structural reorganization associated with ligand binding or with protein-protein interactions. It is thus crucial to accurately predict the changes in side chain conformation associated with ligand binding, drug-target interactions, and protein-protein interactions.

Many computer-based methods have been developed for determination of side chain conformations. These methods, however, only have limited predictive value because they often need to be tailored to restricted groups of targets and re-calibrated for a given target. Moreover, conventional methods like Side Chain With Rotamer Library 4 (SCWRL4) (Krivov et al. Proteins: Structure, Function, and Bioinformatics (2009)77:778-795) can only predict a conformation with the lowest energy based on certain arbitrarily defined energy functions, without providing other conformation variances, and thus have low tolerance to errors. For example, SCWRL4 performs especially poor for aromatic residues, such as tyrosine and tryptophan. In addition, the algorithm of SCWRL4 uses an arbitrary workflow that is lack of biological foundations. For example, SCWRL4 determines disulfide bonds before other types of bonds, which often introduces errors.

Accordingly, there is a need to develop a reliable and efficient method to accurately predict the protein side chain conformations for a broad range of drug targets. The disclosed methods and systems are directed to overcoming one or more of the problems and/or difficulties set forth above, and/or other problems of the prior art.

### SUMMARY

According to a first aspect of the present disclosure, a method for constructing a side chain pose library is provided. The method may include obtaining structure data representing a plurality of conformations of a compound. The method may also include determining structural differences among the conformations. The method may also include classifying, based on the structural differences, the conformations into one or more clusters. The method may also include determining representative conformations of the clusters, wherein an average structural difference between a representative conformation of a cluster and conformations in the cluster is below a predetermined threshold. The method may further include determining the representative conformations as poses of the compound.

According to a second aspect of the present disclosure, there is provided a non-transitory computer-readable storage medium storing instructions that, when executed by one or more processors, cause the processors to perform a method for generating molecular pose library. The method may include obtaining structure data representing a plurality of conformations of a compound. The method may also include determining structural differences among the conformations. The method may also include classifying, based on the structural differences, the conformations into one or more dusters. The method may also include determining representative conformations of the dusters, wherein an average structural difference between a representative conformation of a duster and conformations in the cluster is below a predetermined threshold. The method may further include determining the representative conformations as poses of the compound.

According to a third aspect of the present disclosure, a method for predicting a conformation of an amino acid side chain is provided. The method may include determining one or more poses of the side chain in a protein or peptide environment, the poses being representative conformations of the side chain. The method may also include extracting features associated with the poses of the side chain. The method may also include constructing, based on the extracted features, feature vectors associated with the poses of the side chain. The method may also include computing, based on the feature vectors, energy scores of the poses. The method may further include determining a proper conformation for the side chain based on the energy scores.

According to a fourth aspect of the present disclosure, there is provided a non-transitory computer-readable storage medium storing instructions that, when executed by one or more processors, cause the processors to perform a method for predicting a conformation of an amino acid side chain. The method may include determining one or more poses of the side chain in a protein or peptide environment, the poses being representative conformations of the side chain. The method may also include extracting features associated with the poses of the side chain. The method may also include constructing, based on the extracted features, feature vectors associated with the poses of the side chain. The method may also include computing, based on the feature vectors, energy scores of the poses. The method may further include determining a proper conformation for the side chain based on the energy scores.

It is to be understood that both the foregoing general description and the following detailed description are exemplary and explanatory only and are not restrictive of the invention, as claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this specification, illustrate embodiments consistent with the present disclosure and, together with the description, serve to explain the principles of the present disclosure.

FIG. 1 is a schematic diagram illustrating the structures of 20 common amino acids.

FIG. 2 is a schematic diagram illustrating the detailed structure of methionine (MET).

FIG. 3 shows a snippet of a particular Protein Data Bank (PDB) file.

FIG. 4 is a schematic diagram illustrating a dihedral angle formed by four atoms, according to an exemplary embodiment.

FIG. 5A is a schematic diagram illustrating the dihedral angles in arginine (ARG) side chain, according to an exemplary embodiment.

FIG. 5B a schematic diagram illustrating a particular conformation of the ARG side chain shown in FIG. 5A.

FIG. 6 A is a schematic diagram illustrating a process of converting atomic coordinates representing a side chain conformation to corresponding Chi angles, according to an exemplary embodiment.

FIG. 6B is a schematic diagram illustrating a process of converting Chi angles representing a side chain conformation to corresponding atomic coordinates, according to an exemplary embodiment.

FIG. 7A is a schematic diagram illustrating a process of identifying unqualified conformation data, according to an exemplary embodiment.

FIG. 7B is a schematic diagram illustrating a process of identifying qualified conformation data, according to an exemplary embodiment.

FIG. 8A is a schematic diagram illustrating two pose libraries for leucine (LEU), according to certain exemplary embodiments.

FIG. 8B is a schematic diagram illustrating two pose libraries for tryptophan (TRP), according to certain exemplary embodiments.

FIG. 9 is a flowchart of a method for generating a side chain pose library, according to an exemplary embodiment.

FIG. 10 is a schematic diagram illustrating three backbone poses, according to an exemplary embodiment.

FIG. 11 is a schematic diagram illustrating a local structure of a protein side chain, according to an exemplary embodiment.

FIG. 12 is a schematic diagram illustrating correct and incorrect side chain conformations used in a training process, according to an exemplary embodiment.

FIG. 13 is a flowchart of a method for predicting the conformation of a side chain, according to an exemplary embodiment.

FIG. 14 is a schematic diagram illustrating probe points uniformly distributed around an oxygen atom, according to an exemplary embodiment.

FIG. 15 is a schematic diagram illustrating pairwise interaction between two atoms, according to an exemplary embodiment.

FIG. 16A is a schematic diagram illustrating multiple pairwise interactions associated with an atom that has a covalent bond, according to an exemplary embodiment.

FIG. 16B is a schematic diagram illustrating multiple pairwise interactions associated with an atom that has two covalent bonds, according to an exemplary embodiment.

FIG. 17 is a flowchart of a method for constructing a feature vector, according to an exemplary embodiment.

FIG. 18 is a flowchart of a method for predicting conformations of a side chain, according to an exemplary embodiment.

FIG. 19 is a schematic diagram illustrating training samples used for generating a classification model, according to an exemplary embodiment.

FIG. 20 is a schematic diagram illustrating training samples used for generating a ranking model, according to an exemplary embodiment.

FIG. 21 is a flowchart of a method for predicting conformations of a side chain, according to an exemplary embodiment.

FIG. 22 is a block diagram of a device for predicting side chain conformations, according to an exemplary embodiment.

FIG. 23 is a schematic diagram showing comparison of the disclosed rotamer library and current standard rotamer library.

FIG. 24A is a schematic diagram showing a deep convolutional neural network (CNN) layout, according to an exemplary embodiment.

FIG. 24B is a schematic diagram showing a deep CNN layout, according to another exemplary embodiment.

FIG. 25 is a schematic diagram showing a comparison of prediction results of the disclosed method and prior art methods.

FIG. 26A is a schematic diagram showing the disclosed energy scores used to judge model quality, according to an exemplary embodiment.

FIG. 26B is a schematic diagram showing the disclosed energy scores used to judge model quality, according to another exemplary embodiment.

FIG. 26C is a schematic diagram showing the disclosed energy scores used to judge model quality, according to another exemplary embodiment.

FIG. 27A is a schematic diagram showing a pie chart of side chain the disclosed Leave-one-out (LOO) score outliers of all protein data bank (PDB) structures.

FIG. 27B is a schematic diagram showing examples of the disclosed side chain predictor used to predict side chain conformational error of published high resolution crystal structures.

FIG. 28A is a schematic illustration of a cumulative-distribution-function (CDF) plot for certain amino acid types in the disclosed rotamer library, the conventional SCWRL4 rotamer library, and their difference.

28B is a schematic illustration of a cumulative-distribution-function (CDF) plot for certain amino acid types in the disclosed rotamer library, the conventional SCWRL4 rotamer library, and their difference.

28C is a schematic illustration of a cumulative-distribution-function (CDF) plot for certain amino acid types in the disclosed rotamer library, the conventional SCWRL4 rotamer library, and their difference.

28D is a schematic illustration of a cumulative-distribution-function (CDF) plot for certain amino acid types in the disclosed rotamer library, the conventional SCWRL4 rotamer library, and their difference.

28E is a schematic illustration of a cumulative-distribution-function (CDF) plot for certain amino acid types in the disclosed rotamer library, the conventional SCWRL4 rotamer library, and their difference.

28F is a schematic illustration of a cumulative-distribution-function (CDF) plot for certain amino acid types in the disclosed rotamer library, the conventional SCWRL4 rotamer library, and their difference.

FIG. 29A is a schematic illustration of internal ranking model performance with respect to different amino acid types.

FIG. 29B is a schematic illustration of an internal ranking model performance with respect to different amino acid types.

FIG. 29C is a schematic illustration of an internal ranking model performance with respect to different amino acid types.

FIG. 29D is a schematic illustration of an internal ranking model performance with respect to different amino acid types.

FIG. 29E is a schematic illustration of an internal ranking model performance with respect to different amino acid types.

FIG. 30A is a schematic illustration of the performance difference between the disclosed protein side-chain prediction method and the conventional SCWRL4 method.

FIG. 30B is a schematic illustration of the performance difference between the disclosed protein side-chain prediction method and the conventional SCWRL4 method.

FIG. 30C is a schematic illustration of the performance difference between the disclosed protein side-chain prediction method and the conventional SCWRL4 method.

FIG. 30D is a schematic illustration of the performance difference between the disclosed protein side-chain prediction method and the conventional SCWRL4 method.

FIG. 30E is a schematic illustration of the performance difference between the disclosed protein side-chain prediction method and the conventional SCWRL4 method.

FIG. 30F is a schematic illustration of the performance difference between the disclosed protein side-chain prediction method and the conventional SCWRL4 method.

FIG. 30G is a schematic illustration of the performance difference between the disclosed protein side-chain prediction method and the conventional SCWRL4 method.

FIG. 31A is a histogram of probability scores computed based on all types of PDB models.

FIG. 31B is a histogram of probability scores computed based on electron microscopy PDB models.

FIG. 31C is a histogram of probability scores computed based on nuclear-magnetic-resonance (NMR) PDB models.

FIG. 31D is a histogram of probability scores computed based on X-ray PDB models.

FIG. 31E is a histogram of probability scores computed based on high-resolution PDB models.

FIG. 31F is a histogram of probability scores computed based on low-resolution PDB models.

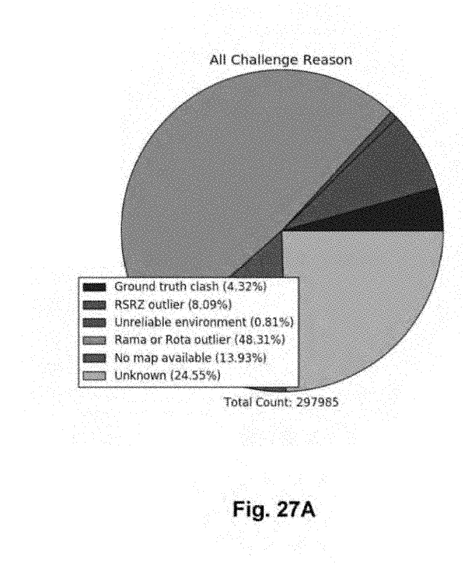

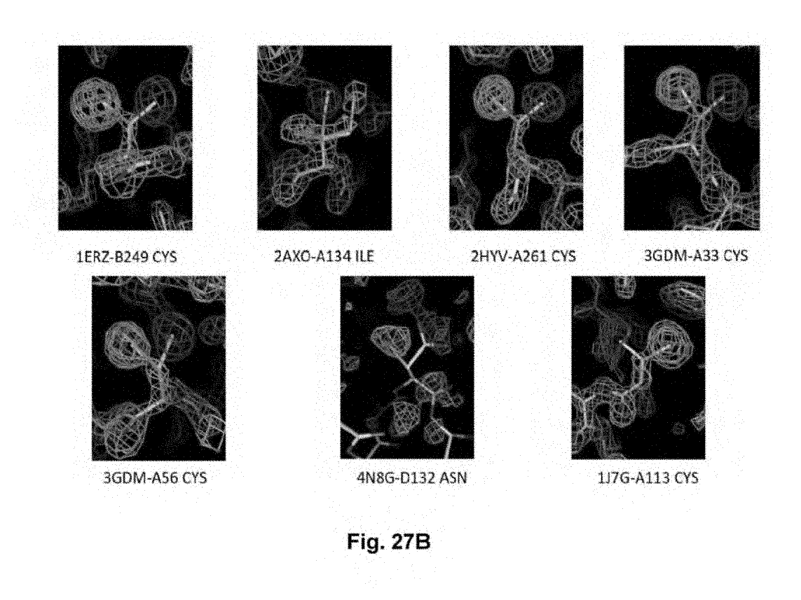

FIG. 32A is a pie chart of the LOO outliers for certain amino acid types created using same color label as in FIG. 27A.

FIG. 32B is a pie chart of the LOO outliers for certain amino acid types created using same color label as in FIG. 27A.

FIG. 32C is a pie chart of the LOO outliers for certain amino acid types created using same color label as in FIG. 27A.

FIG. 32D is a pie chart of the LOO outliers for certain amino acid types created using same color label as in FIG. 27A.

FIG. 32E is a pie chart of the LOO outliers for certain amino acid types created using same color label as in FIG. 27A.

FIG. 32F is a pie chart of the LOO outliers for certain amino acid types created using same color label as in FIG. 27A.

FIG. 32G is a pie chart of the LOO outliers for certain amino acid types created using same color label as in FIG. 27A.

FIG. 32H is a pie chart of the LOO outliers for certain amino acid types created using same color label as in FIG. 27A.

FIG. 32I is a pie chart of the LOO outliers for certain amino acid types created using same color label as in FIG. 27A.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the invention as recited in the appended claims.

Side chain prediction is a fundamental component of many protein modeling applications such as docking, structural prediction, and design. The goal of side chain prediction is to identify the most energy favorable conformations of a side chain for a given backbone of amino acids. The present disclosure provides a computational approach to predict the conformations of one or more side chains of amino acids in a protein or peptide, with the rest of the protein or peptide (i.e., the protein environment of the side chains in question) assumed to be at the atomic positions of the native structure. The disclosed methods exhaustively sample side chain conformations at a high resolution. Clash-free conformations are evaluated and sorted according to one or more statistically representative conformations, hereinafter referred to as “poses.” The collection of a plurality of poses forms a side-chain pose library. Similarly, the disclosed methods also construct a backbone pose library.

The resulted pose libraries transform what is a continuum search space into a discretized problem for which machine-learning algorithms are used to train a prediction model for predicting the most appropriate conformation for a side chain. Specifically, features relating to the potential energy of each pose of the side chain may be extracted and used to form a feature vector representative of the respective pose. Sample feature vectors are used to train the prediction model, such that the model may be used to compute the energy scores of side chain conformations. The conformation with the highest energy score is the most appropriate conformation for the side chain in the given protein environment.

The features, aspects, and principles of the disclosed embodiments may be implemented in various environments. Such environments and related applications may be specifically constructed for performing the various processes and operations of the disclosed embodiments or they may include a general purpose computer or computing platform selectively activated or reconfigured by program code to provide the necessary functionality. The processes disclosed herein may be implemented by a suitable combination of hardware, software, and/or firmware. For example, the disclosed embodiments may implement general purpose machines that may be configured to execute software programs that perform processes consistent with the disclosed embodiments. Alternatively, the disclosed embodiments may implement a specialized apparatus or system configured to execute software programs that perform processes consistent with the disclosed embodiments.

The disclosed embodiments also relate to tangible and non-transitory computer readable media that include program instructions or program code that, when executed by one or more processors, perform one or more computer-implemented operations. For example, the disclosed embodiments may execute high level and/or low level software instructions, such as machine code (e.g., such as that produced by a compiler) and/or high level code that can be executed by a processor using an interpreter.

For illustrative purpose only, the following description uses protein molecules to Illustrate the implementations of the disclosed methods. However, it is contemplated the disclosed methods may also be applied to peptides, or any other molecules having flexible conformations.

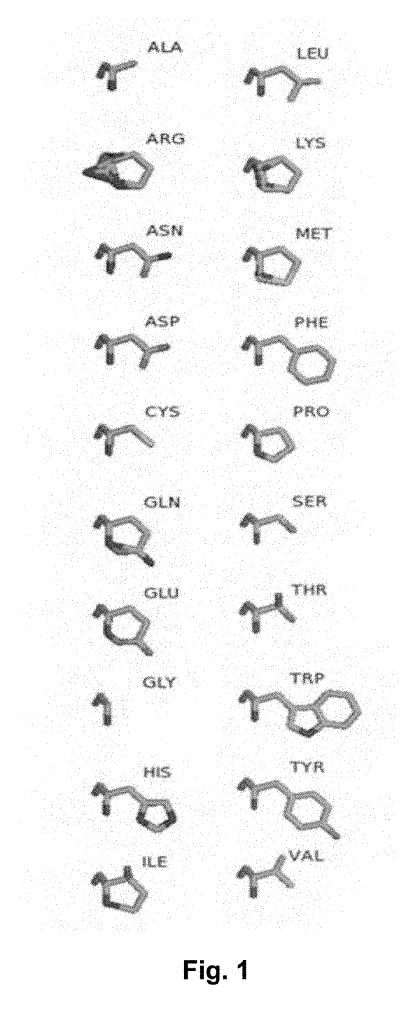

FIG. 1 is a schematic diagram illustrating the structures of 20 types of amino acids that are commonly found in proteins and peptides. In the present disclosure, an “amino acid” is defined to include both a “backbone” and a “side chain.” The “backbone” refers to the part of the “amino acid,” i.e., the amine and carboxylic groups, that forms part of a protein/peptide backbone. The “side chain” refers to the part of the “amino acid” that attaches to the protein/peptide backbone. Accordingly, in the following description, the conformation of an “amino acid” may include both the “backbone” conformation and the “side chain” conformation.

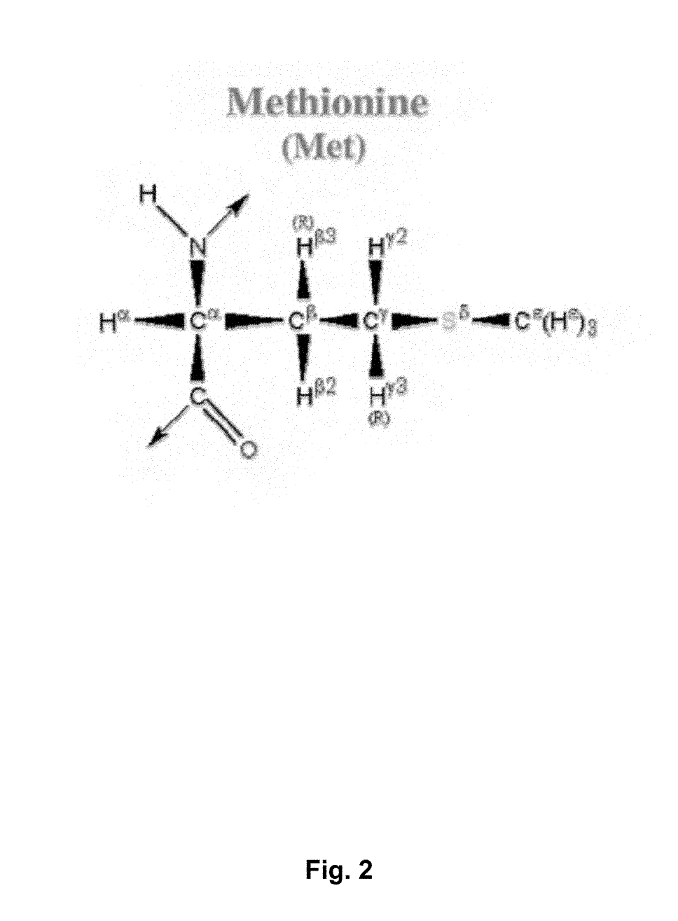

Each type of amino acid contains a fixed number and type of atoms. Each atom in an amino acid may be given a unique name for identification. For example, FIG. 2 is a schematic diagram illustrating the detailed structure of methionine (MET). Referring to FIG. 2, MET contains the following heavy atoms: N, C, O, C^{α}, C^{β}, C^{γ}, S^{δ}, and C^{ε}. Although FIG. 2 also shows the hydrogen atoms, they are often hard to be determined in crystallography and are often missing in Protein Data Bank (PDB) data. Thus, in some embodiments, hydrogen atoms are not explicitly considered unless they have structural significance.

The protein structural information used in the disclosed embodiments may be extracted from the PDB data, which may be organized in various file formats, such as PDB file format, Extensible Markup Language (XML) file format, or macromolecular Crystallographic Information File (mmCIF) format. For illustrative purpose only, the following description assumes the PDB data is represented as PDB files. However, it is contemplated that the PDB data used by the disclosed methods may be represented in any formats.

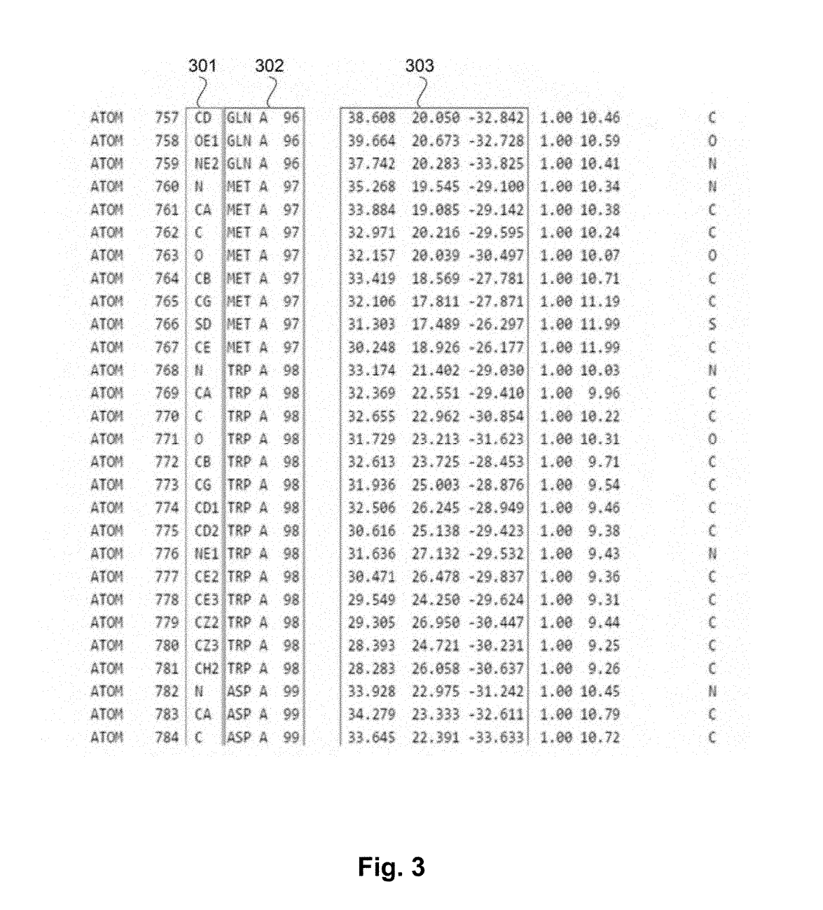

In the PDB data representing a protein, the main information of interest includes the spatial position of each heavy atom in the amino acids of the protein. FIG. 3 shows a snippet of a particular PDB file. Referring to FIG. 3, each row corresponds to a single atom in the protein. The main information of interest is identified by regions 301-303. Region 301 includes the name of each atom. Region 302 identifies the type and index of the amino acid in which the atom resides, used to specify the sequences and the positions of the atoms. Region 303 includes the spatial coordinates of the atom. For example, the following row of data in FIG. 3

| | | | | | | | | | | | |
|---|---|---|---|---|---|---|---|---|---|---|---|
| ATOM | 766 | SD | MET | A | 97 | 31.303 | 17.489 | −26.297 | 1.00 | 11.99 | S |

indicates that the spatial coordinates of the S^{δ} atom of the MET located at index A97 is (31.303, 17.489, −26.297).

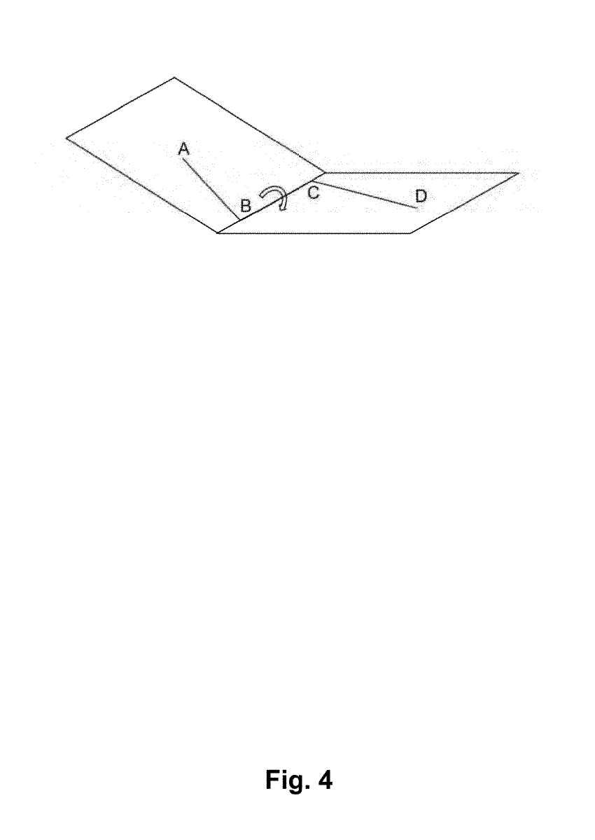

The conformations of a side chain may be described by dihedral angles (hereinafter referred to as “Chi” or “χ”). Every set of four non-collinear atoms can define a dihedral angle. FIG. 4A is a schematic diagram illustrating a dihedral angle formed by four atoms. Referring to FIG. 4, atoms A, B, and C define a first plane (hereinafter referred to as plane ABC), and atoms B, C, and D define a second plane (hereinafter referred to as plane BCD). The dihedral angle defined by atoms A, B, C, and D is the angle between the first and second planes. The positive rotation of the dihedral angle may be defined as the clockwise rotation from plane ABC to plane BCD when looking in B→C direction.

Mathematically, the dihedral angle χ may be defined by three vectors \vec{AB}, \vec{BC}, \vec{CD} according to the following equations:

$$X = atan 2 ( ( [ \vec{AB} \times \vec{BC} ] \times [ \vec{BC} \times \vec{CD} ] \cdot \frac{\vec{BC}}{\vert \vec{BC} \vert} ) , [ \vec{AB} \times \vec{BC} ] \cdot [ \vec{BC} \times \vec{CD} ] ) \qquad Eq . 1$$

where the a tan 2( ) function is defined as:

$$atan 2 ( y , x ) = \{ \begin{matrix}arctan ( \frac{y}{x} ) & if x > 0 \\ \frac{π}{2} - arctan ( \frac{y}{x} ) & if y > 0 \\ - \frac{π}{2} - arctan ( \frac{y}{x} ) & if y < 0 \\ arctan ( \frac{y}{x} ) \pm π & if x > 0 \\ undefined & if x = 0 and y = 0\end{matrix} \qquad Eq . 2$$

In the disclosed embodiments, to simplify the molecule conformation model, the bond lengths and bond angles in a side chain are assumed to be fixed with minimal deviations. Accordingly, the processor for implementing the disclosed methods may treat each type of bond length and bond angle as a constant in the computation. The processor may determine the constants by averaging all equivalent bond lengths and bond angles in sample protein structures. This way, only the dihedral angles in a side chain may vary. That is, the different conformations of a side chain may be completely described by the associated dihedral angles.

Among the 20 common amino acids shown in FIG. 1, except for alanine (ALA) and glycine (GLY) that contain no dihedral angles, all the other amino acids have one or more distinct dihedral angles. The number of distinct Chi angles for a specific type of amino acid is fixed, and different amino acids may have different numbers of Chi angles. For example, arginine (ARG) has five Chi angles while asparagine (ASN) has two Chi angles. The Chi angles of different types of amino acids have no relations and thus are not comparable.

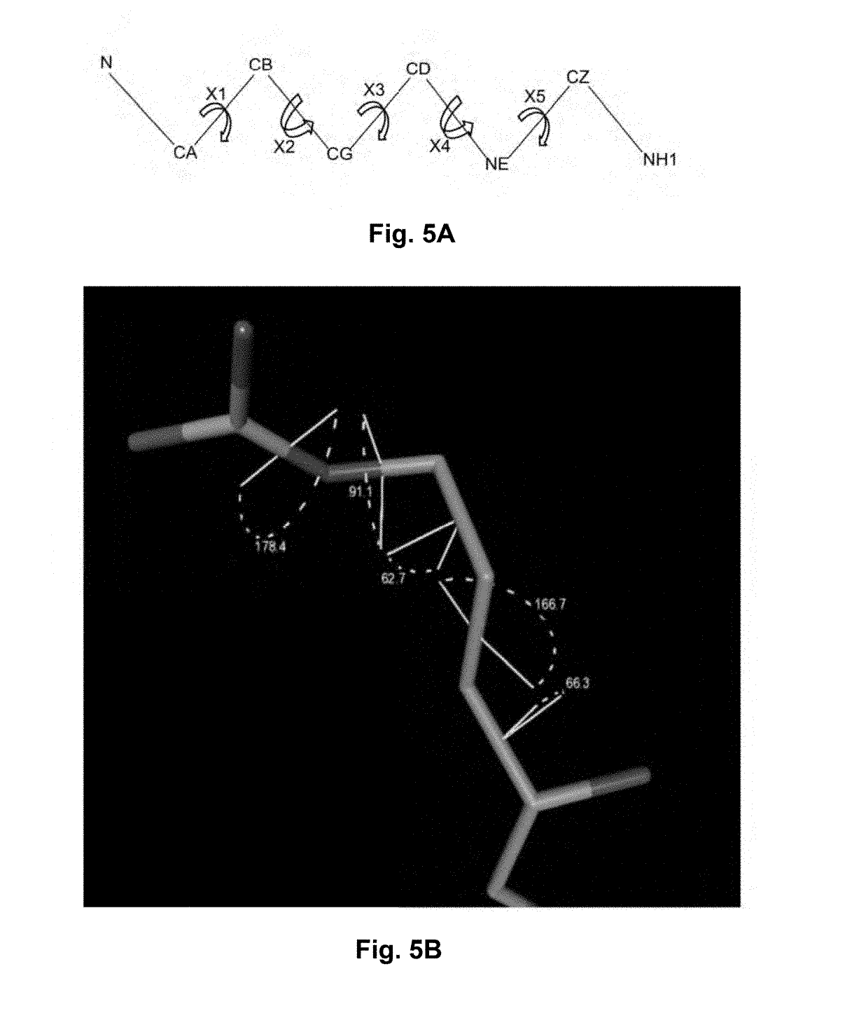

The dihedral angles (or Chi angles) for the bonds along a side chain of an amino acid are successively denoted as χ₁, χ₂ . . . . For example, χ₁ is defined by atoms N, C^{α}, C^{β}, and C^{γ}. X₂ is defined by atoms C^{α}, C^{β}, C^{γ}, and C^{δ}. FIG. 5A is a schematic diagram illustrating the dihedral angles in arginine (ARG). Referring to FIG. 5A, the ARG side chain contains five dihedral angles. The conformation of the ARG side chain may be completely described by these five dihedral angles. FIG. 5B is a schematic diagram illustrating a particular conformation of the ARG side chain. Referring to FIG. 58, the conformation can be completely described by the Chi angles (56.8, 143.1, 160.9, 166.0, 179.9).

Consistent with the above description, a side chain of an amino acid may change its conformation by varying the Chi angles. In one embodiment, an initial conformation may be built for each type of amino acid, and any other possible conformations of the side chain may be generated by rotating bonds in the side chain, i.e., by changing some or all dihedral angles of the side chain. The initial conformation may be defined by setting the C^{α} atom at the original of a Cartesian coordinate system, aligning the N—C^{α} bond along the positive X-axis direction, laying the N—C^{α}—C plane on the X-Y plane, and setting all the Chi angles as zero. For example, the following Table 1 lists the atomic coordinates in the initial conformation of tryptophan (TRP) side chain.

The initial conformations constructed in such manner do not necessarily exist in the reality. However, after the atomic coordinates corresponding to the initial conformation of a side chain are determined, the atomic coordinates corresponding to other conformations may be obtained by changing the Chi angles of the side chain.

As described above, because the bond lengths and bond angles in a side chain of an amino acid are treated as constants, the atomic coordinates and Chi angles representing a conformation of the same side chain are interconvertible. In one embodiment, using predetermined bond-length and bond-angle constants, a “ToChiAngles( )” function can be constructed to convert atomic coordinates to the corresponding Chi angles,

TABLE 1

| Atom Name | Spatial Coordinate (x, y, z) | | |
|---|---|---|---|
| N | 1.458554 | 0.000000 | 0.000000 |
| C^{α} | 0.000000 | 0.000000 | 0.000000 |
| C | −0.545340 | 1.418901 | 0.000000 |
| O | 0.221602 | 2.382888 | −0.000975 |
| C^{β} | −0.536359 | −0.770623 | 1.210525 |
| C^{γ} | 0.534597 | −1.333551 | 2.095066 |
| C^{δ}₁ | 1.887874 | −1.224844 | 1.924013 |
| C^{δ}₂ | 0.341188 | −2.100165 | 3.289995 |
| N^{ε}₁ | 2.546287 | −1.876084 | 2.940181 |
| C^{ε}₂ | 1.622464 | −2.421854 | 3.792138 |
| C^{ε}₃ | −0.789507 | −2.545403 | 3.985428 |
| C^{ζ}₂ | 1.801297 | −3.168558 | 4.958212 |
| C^{ζ}₃ | −0.609419 | −3.287687 | 5.144388 |
| C^{η}₂ | 0.675409 | −3.590514 | 5.617013 |

and a “BuildFromChiAngles( )” function can be constructed to convert Chi angles to the corresponding atomic coordinates.

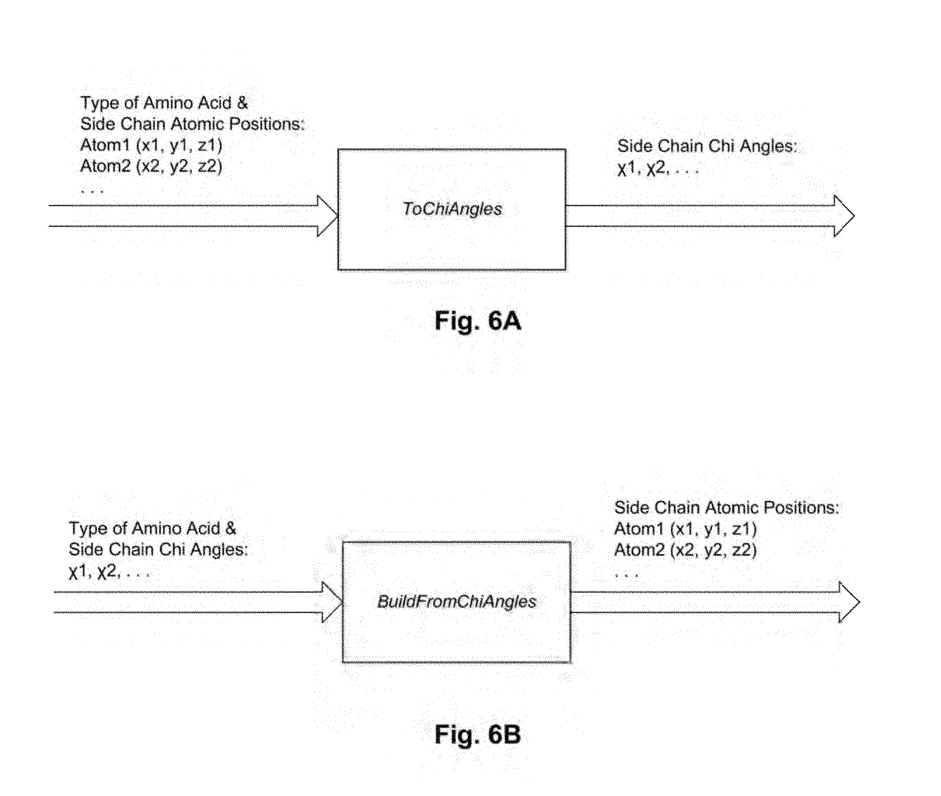

FIG. 6 A is a schematic diagram illustrating a conversion process performed by the ToChiAngles( ) function, according to an exemplary embodiment. Referring to FIG. 6A, the atomic coordinates representing a side chain conformation and the type of amino acid are given as the input, and the corresponding Chi angles of the side chain are outputted by the ToChiAngles( ) function.

FIG. 6B is a schematic diagram illustrating a conversion process performed by the BuildFromChiAngles( ) function, according to an exemplary embodiment. Referring to FIG. 6B, BuildFromChiAngles( ) is the reverse operation of ToChiAngles( ). The Chi angles representing a side chain conformation and the type of amino acid are given as the input, and the corresponding atomic coordinates of the side chain are outputted by the BuildFromChiAngles( ) function.

Here, the type of amino acid is part of the input for both ToChiAngles( ) and BuildFromChiAngles( ). This is because both functions use different bond-length and bond-angle constants for different types of amino acids.

The disclosed embodiments use root-mean-square deviation of atomic positions (or simply root-mean-square deviation, RMSD) to make a quantitative similarity comparison between two different conformations of a side chain. Specifically, the same heavy atoms in two different conformations of a side chain (e.g., C^{α} in two different conformations) form an equivalent atom pair. The RMSD is the measure of the average distance between the equivalent atom pairs of two different side chain conformations. The RMSD may be calculated according to the following equation:

$$RMSD = \sqrt{\frac{1}{N} {\sum }_{i = 1}^{N} {δ}_{i}^{2}} \qquad Eq . 3$$

In Eq. 3, N is the number of equivalent atom pairs in a side chain, and δᵢ is the distance between the ith pair of equivalent atoms.

In exemplary embodiments, the RMSD may be computed based on the atomic coordinates representing the two conformations. Moreover, with the help of BuildFromChiAngles( ), the RMSD may also be computed based on the Chi angles.

Several types of amino acids also contain interior equivalent atoms. Interior equivalent atoms refer to different atoms that are in the same conformation of a side chain but cannot be distinguished based on the electron-density map or structural file (i.e., PDB data) of the side chain. The amino acid side chains having interior equivalent atoms are shown in the following Table 2. Referring to Table 2, the interior equivalence may be real. That is, the equivalent atoms are in the same atom type, e.g., N^{η}₁/N^{η}₂ in ARG. The interior equivalence may also be formal. That is, the equivalent atoms are in different atom types, e.g., O^{δ}₁/N^{δ}₂ in ASN.

TABLE 2

| Amino Acid | ARG | ASN | ASP | GLN | GLU | HIS | PHE | TYR |
|---|---|---|---|---|---|---|---|---|
| Real | N^{η}₁/ | | O^{δ}₁/ | | O^{ε}₁/ | | C^{δ}₁/ | C^{δ}₁/ |
| Interior | N^{η}₂ | | O^{δ}₂ | | O^{ε}₂ | | C^{δ}₂; | C^{δ}₂; |
| Equivalent | | | | | | | C^{ε}₁/ | C^{ε}₁/ |
| Atoms | | | | | | | C^{ε}₂ | C^{ε}₂ |
| Formal | | O^{δ}₁/ | | O^{ε}₁/ | | N^{δ}₁/ | | |
| Interior | | N^{δ}₂ | | N^{ε}₂ | | C^{ε}₂; | | |
| Equivalent | | | | | | C^{ε}₁/ | | |
| Atoms | | | | | | N^{ε}₂ | | |

Because the interior equivalent atoms in the same conformation are undistinguishable, RMSD in tolerance version is used for side chains containing interior equivalent atoms. The RMSD in tolerance version is the lowest among all the RMSDs obtained by placing the interior equivalent atoms at each possible position. For example, O^{δ}₁ and N^{δ}₂ are the interior equivalent atoms in ASN. Four RMSDs may be obtained by placing O^{δ}₁ and N^{δ}₂ at the possible positions. The RMSD in tolerance version is the lowest among the four RMSDs.

In the disclosed embodiment, the processor extracts protein conformation data from multiple PDB files and constructs the side chain and backbone pose libraries. As data in the Protein Data Bank is contributed by different entities or people all over the world, data quality varies across different PDB files. Data entries in the PDB repository may be missing, redundant, or incorrect. Therefore, to improve the performance of side chain prediction, the disclosed embodiments employ various methods to evaluate the data quality of PDB files before extracting information from these files.

In one embodiment, the processor may examine the integrity of a PDB file. Specifically, the processor may check whether there are missing atoms in the PDB file. If there are missing atoms, the processor may conclude that the PDB file is lack of integrity and thus reject the PDB file.

In one embodiment, the processor may determine whether any two non-bonded atoms in a PDB file dash. Specifically, the processor may consider two non-bonded atoms are dashing if the spatial positions of the two atoms overlap or the distance therebetween is smaller than a given constant. The constant is determined based on the types and roles of the two atoms. If the PDB file contains clashing atoms, the processor may reject the PDB file.

In one embodiment, the processor may check the bond lengths indicated a PDB file and reject the PDB file with incorrect bond lengths.

In one embodiment, the processor may determine whether a PDB file contains multiple conformations for a side chain. If the PDB file contains multiple conformations for the same side chain, the process may conclude that the PDB file has a low quality and thus reject the PDB file.

In one embodiment, the processor may evaluate the data quality of a PDB file by comparing a side chain conformation (hereinafter referred to as original conformation) represented by the PDB file and a rebuilt conformation of the same side chain. The rebuilt conformation is generated using the function BuildFromChiAngles(ToChiAngles(x)), wherein x denotes the coordinates extracted from the PDB file. Because the functions BuildFromChiAngles( ) and ToChiAngles( ) use the bond lengths and bond angles from the standard amino acid models, the rebuilt conformation will be the same as the original conformation only if the bond lengths and bond angles in the PDB file are the same as the standard amino acid models. The processor may use the RMSD between the original and rebuilt conformations to evaluate the errors of the bond lengths and bond angles in the PDB file. When the RMSD exceeds a predetermined threshold, the processor may conclude that the conformation data in the PDB file is unqualified and thus reject the PDB file.

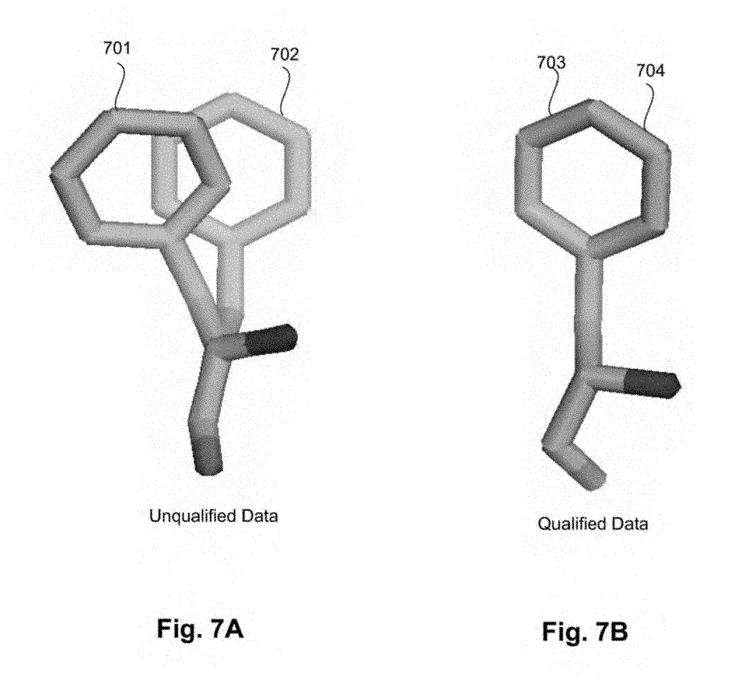

FIG. 7A is a schematic diagram illustrating a process of identifying unqualified conformation data, according to an exemplary embodiment. Referring to FIG. 7A, the original side chain conformation extracted from a PDB file is labeled as 701 and the corresponding rebuilt conformation is labeled as 702. Because the rebuilt conformation 702 drastically deviates from the original conformation 701, the conformation data contained in the PDB file is unqualified.

As a comparison, FIG. 7B is a schematic diagram illustrating a process of identifying qualified conformation data, according to an exemplary embodiment. Referring to FIG. 7B, the original conformation extracted from another PDB file and the corresponding rebuilt conformation are labeled as 703 and 704 respectively. Because the rebuilt conformation 704 largely overlaps with the original conformation 703, the conformation data contained in the PDB file is qualified.

The prediction of side chain conformation means producing correct side chain Chi angles for each amino acid in a given protein. However, Chi angles are continuous variables and changing a Chi angle in a side chain may affect other Chi angles in the same side chain. For example, altering a Chi angle of a side chain may affect all the atoms in the side chain. Therefore, it has been difficult to directly predict exact Chi angle values.

However, the conformations represented by different Chi angles may have different potential energies. Statistically, for a specific amino acid, some Chi angles correspond to lower potential energies and thus are more common than other Chi angles corresponding to higher potential energies.

The disclosed embodiments construct a side chain pose library to classify all the possible side chain conformations of an amino acid into one or more poses. A pose is a specific side chain conformation that is suitable to represent a duster of similar side chain conformations of an amino acid. By using side chain poses, the prediction of side chain conformation is limited to several discrete conformations instead of continuous Chi angle values, and thus can be executed efficiently. For example, the processor may classify the possible conformations of ARG into a finite discrete set of side chain poses. Each pose may be given a score indicating the likelihood for the pose to occur in the actual protein environment. This way, the number of prediction outputs can be reduced without sacrificing the prediction accuracy. Thus, the prediction process can be made more efficient.

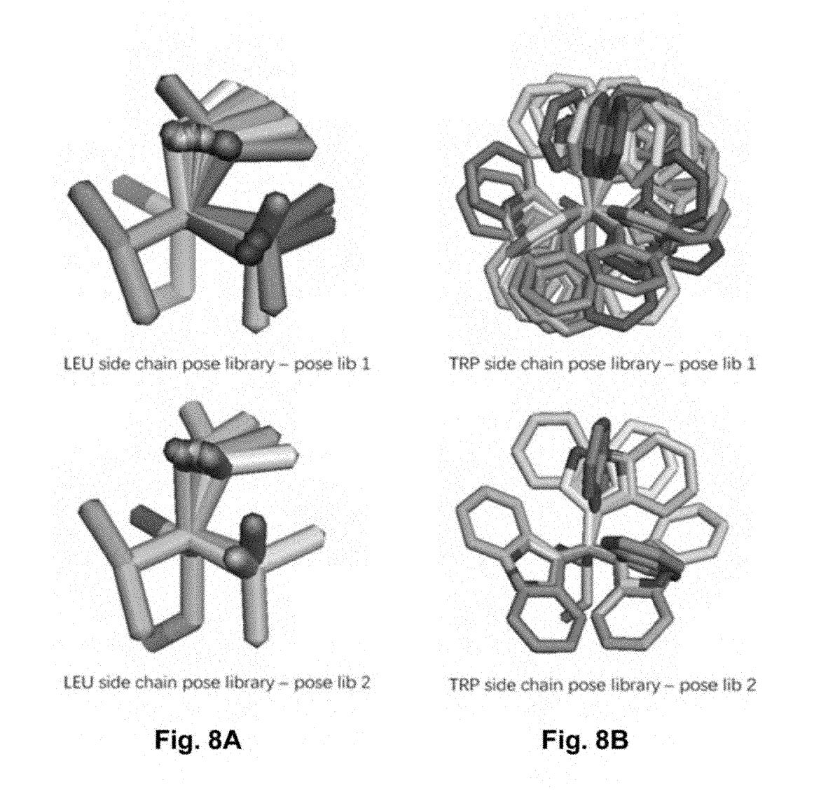

Different types of amino acids may have different number of side chain poses. The number of poses used for a particular side chain may also be adjusted based on practical considerations, such as the desired accuracy, computation cost, etc. FIG. 8A is a schematic diagram illustrating two pose libraries for leucine (LEU), according to certain embodiments. Referring to FIG. 8A, the two LEU pose libraries have different clustering grading, i.e., containing different number of poses. Generally, the denser of a pose library, the more accurately a prediction of conformation may be made based on the pose library. Similarly, FIG. 8B is a schematic diagram illustrating two pose libraries for TRP, according to certain embodiments. Referring to FIG. 8A, the two TRP pose libraries also have different clustering grading.

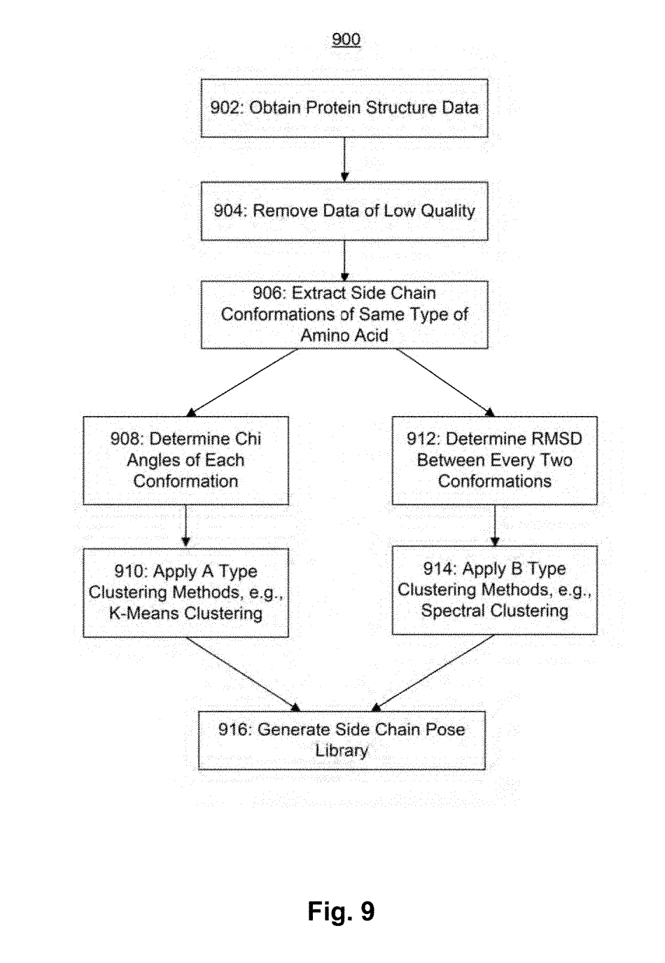

FIG. 9 is a flowchart of a method 900 for generating a side-chain pose library, according to an exemplary embodiment. For example, method 900 may be performed by a processor. Referring to FIG. 9, method 900 may include the following steps.

In step 902, the processor obtains a protein structure data. The protein structure data may be drawn from one or more PDB files. As shown in FIG. 3, the processor may read the information of interest from the PDB files. The information of interest includes the spatial coordinates of the atoms in the proteins.

In step 904, the processor removes data of low quality. The processor may use the above-described methods to examine the data quality. For example, the processor may check the integrity of the data. The processor may also determine whether the data contains clashing non-bonded atoms, incorrect bond lengths, and/or multiple conformations for the same side chain. The processor may further compare the original conformation extracted from a PDB file with the corresponding rebuilt conformation. Based on the analysis, the processor may discard the side chain data that has low quality. Step 904 is optional and may be skipped in some embodiments.

In step 906, the processor extracts the side chain conformation data for each type of amino acid. The same type of amino acid may appear at multiple locations on a protein and may have different conformations at different locations. Thus, for each type of amino acid, the extracted conformation data includes multiple side chain conformations of the amino acid.

The side chain poses may be generated based on a parameter indicative of the similarity between two different conformations. Such parameter may be structure information or RMSDs. Depending on the type of parameters, different clustering methods may be used to generate the poses. Steps 908-910 describe a clustering process based on the structure information, and steps 912-914 describe a clustering process based on the RMSDs.

In step 908, for each type of amino acid, the processor determines the structure information associated with different conformations. Structure information has various expressing methods such as atomic coordinates and Chi angles. For example, the processor may use the function ToChiAngles( ) to compute the Chi angles.

In step 910, the processor uses a first clustering method (hereinafter referred to as “A Type” clustering method) to divide the extracted conformations into a plurality of dusters (i.e., poses) based on the structure information. The A Type clustering method may be a K-means clustering method.

Specifically, the K-means clustering method may include the following steps:
1. Select a plurality of random cluster centers (i.e., poses) X={xₚ}_{p=1 . . . k′} k is the number of clusters (or poses) to be generated. In practice, k may be determined by a user according to the practical need.
2. Assign each side chain conformation to a pose that has the minimal RMSD from the side chain conformation.
3. For each pose p, designate Xₚ as the ensemble of side chain conformations assigned to this pose. Calculate x′ₚ as the average of the conformations in Xₚ.
4. Set X′={x′ₚ}_{p=1 . . . k} as the new poses. That is, let X′=X.
5. Repeat the above steps 2-4 until X′ and X converge, i.e., when Σₚ₋₁^{k}|x′ₚ−xₚ| is below a predetermined value.

If RMSDs are the parameters used for the clustering process, steps 912-914 may be implemented. In step 912, for each type of amino acid, the processor determines the RMSDs between every two different conformations.

In step 914, the processor uses a second clustering method (hereinafter referred to as “B Type” clustering method) to divide the extracted conformations into a plurality of dusters (i.e., poses) based on the RMSDs. The B Type clustering method may be a spectral clustering method.

Specifically, in the spectral clustering method, the RMSDs are expressed as a similarity matrix, which is defined as a symmetric matrix A. A diagonal matrix D can be calculated from matrix A. The Laplacian matrix L=A−D is then obtained. The spectrum (eigenvectors) of L is then used for clustering and generating the cluster (i.e., poses).

In the disclosed embodiments, one or both A Type clustering and B Type clustering may be used to generate the poses. Moreover, different types of clustering may be used for different types of amino acids. When both types of clustering are used for the same type of amino acid, their clustering results may be compared to determine the accuracy of the results.

In step 916, the processor generates the pose library. The pose library includes the side chain poses for all the 20 types of amino acids. Each type of amino acid may have one or more poses. As described above, a pose is the center of a conformation duster and may comprise one or more Chi angles sufficiently to represent the conformation cluster.

For each type of amino acid, method 900 can generate sufficient side chain poses to represent all the side chain conformation occurring in the real world. In practice, a proper number of side chain poses may be selected for a type of amino acid to achieve two goals: 1) the number of the poses is kept as small as possible, in order to enable efficient search of side chain conformations; and 2) the average RMSD between the real-world conformations and their most similar poses are as small as possible, in order to ensure the accuracy of predicting the side chain conformations.

Table 3 lists the number of poses for each type of amino acid, according to an exemplary embodiment. Referring to Table 3, ARG has the highest number of poses. As an example, Table 4 lists some poses of ARG, according to the exemplary embodiment. Referring to Table 4, the side chain conformation of ARG has 5 dihedral angles. Accordingly, each pose of ARG is represented by 5 dihedral angles.

TABLE 3

| Amino Acid | Number of Poses |
|---|---|
| ALA | 1 |
| ARG | 81 |
| ASN | 27 |
| ASP | 27 |
| CYS | 7 |
| GLN | 60 |
| GLU | 60 |
| GLY | 1 |
| HIS | 36 |
| ILE | 27 |
| LEU | 27 |
| LYS | 72 |
| MET | 54 |
| PHE | 36 |
| PRO | 12 |
| SER | 7 |
| THR | 7 |
| TRP | 60 |
| TYR | 36 |

As illustrated by Table 4, a difference between the disclosed method and SCWRL4 is that the disclosed side chain pose library is not constructed in a hierarchical manner along the Chi angles. Depending on the lengths of the respective side chains, the amino acids have 1 to 5 Chi angles. The amino acid rotamer library used in SCWRL4 is constructed by first dividing the side chain conformations of an amino acid into 3 classes according to a first Chi angle, and then dividing each of the three classes into multiple subclasses based on a second Chi angle if the amino acid has more than 1 Chi angle. Such dividing process is continued until the last Chi angle is reached.

TABLE 4

| | Chi | Chi | Chi | Chi | Chi |
|---|---|---|---|---|---|
| Pose # | Angle 1 | Angle 2 | Angle 3 | Angle 4 | Angle 5 |
| 0 | −1.04675 | 2.98455 | −3.01832 | 1.59654 | −0.00275 |
| 1 | −3.03765 | 3.13808 | −1.10239 | 1.9646 | −0.01294 |
| 2 | 1.1308 | −3.06838 | 1.21496 | 1.39321 | 0.006762 |
| 3 | 1.03607 | −3.07725 | −1.03257 | 2.8889 | 0.037129 |
| 4 | −1.1957 | −3.05257 | −3.06189 | 1.73844 | 0.079245 |
| 5 | −1.17894 | −1.27709 | −3.01154 | 3.09138 | −0.02047 |
| 6 | 1.14289 | 3.07635 | −3.11094 | 2.80708 | 0.088315 |
| 7 | −1.05271 | −3.12785 | −3.01701 | 3.13863 | 0.002262 |
| 8 | −3.06692 | −3.0417 | −1.08893 | 2.93915 | 0.000839 |
| 9 | −1.03943 | −1.30476 | 1.40579 | −2.93863 | 3.13826 |
| 10 | −0.92327 | −1.08101 | −2.94196 | −1.84031 | 3.12169 |
| 11 | 3.05146 | 1.14619 | 1.12913 | −2.82164 | 0.003159 |
| 12 | −1.29709 | −3.09978 | 3.07323 | −1.59559 | −0.03166 |
| 13 | −2.98805 | −3.10419 | −0.9319 | −1.52884 | −0.00589 |
| 14 | −3.03172 | 2.93809 | 1.22178 | 1.55738 | −0.0252 |
| 15 | −1.13662 | −2.92957 | 1.22595 | −2.16558 | 0.019862 |
| 16 | −1.15738 | 3.04876 | −1.09455 | 2.99623 | 0.004476 |
| 17 | 3.12213 | 2.94104 | −1.11451 | 2.87308 | 0.001188 |
| 18 | −1.22416 | −1.34076 | −1.12112 | 2.41225 | −3.11867 |

Moreover, the rotamer library is backbone dependent. That is, different rotamer libraries need to be constructed for different backbone conformations.

In contrast, the disclosed side chain pose library uses a flat structure to classify the side chain conformations of each amino acid into one or more classes based on the geometrical differences among the side chain conformations. Moreover, the side chain pose library is backbone independent, and thus reduces the number of side chain poses. To consider the energy differences caused by different backbone conformations, the disclosed method instead generates a backbone pose library independent from the side chain pose library.

Similar to a side chain pose, a backbone pose means a specific backbone conformation representative of a duster of structurally similar backbone conformations. To predict the conformation of a side chain, the backbone formed by the neighboring amino acids may influence the potential energy of the side chain at question. Backbone poses describe the relative positions of the atoms in the preceding and subsequent amino acids.

In some embodiments, for generating backbone poses, a continuous range of up to three preceding and three subsequent amino acids of the side chain at question are considered. If the side chain of an amino acid at question is near an endpoint of a protein chain, only the existing preceding and subsequent amino acids are used. That is, the number of preceding or subsequent amino acids used for generating backbone poses may be less than three if the side chain at question is near an endpoint of a protein.

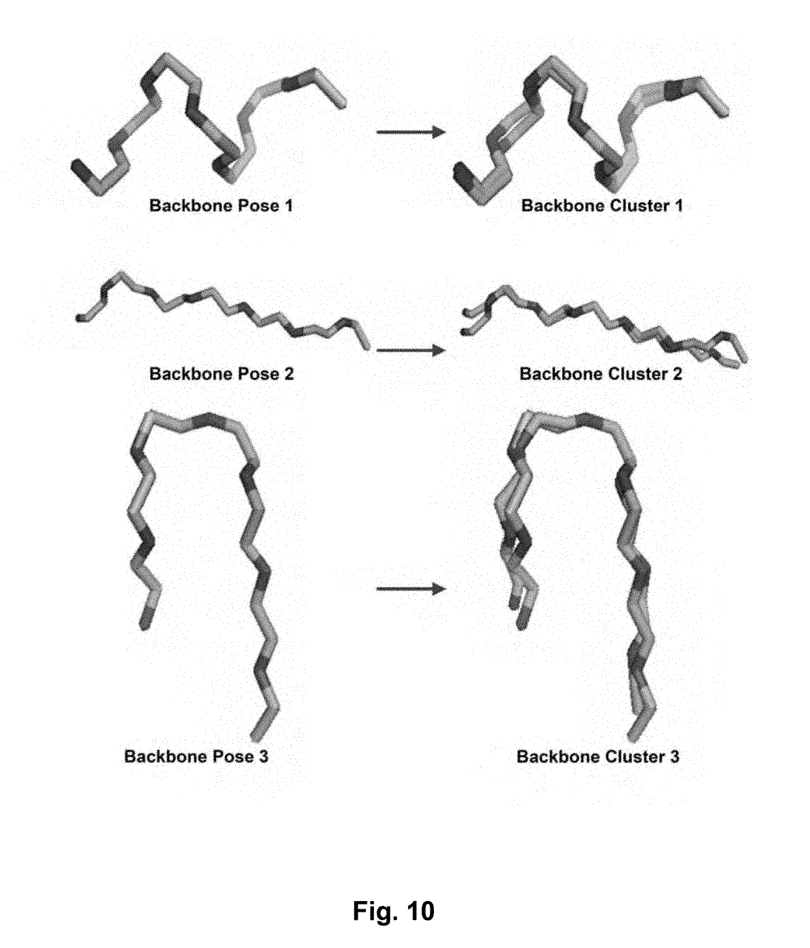

Backbone poses capture the secondary structure information and enable finer grained categorization of backbone conformations than conventionally used secondary structure labels such as a helix, p sheets, etc. FIG. 10 is a schematic diagram illustrating three backbone poses, according to an exemplary embodiment. Referring to FIG. 10, backbone poses 1-3 represent backbone clusters 1-3 respectively. Each backbone duster comprises multiple backbone conformations, each of which deviates from the corresponding backbone pose by a RMSD less than a predetermined value.

In exemplary embodiments, the generation of a backbone pose library is similar to the process of generating a side chain pose library (method 900). The following outlines an exemplary method for generating a backbone pose library:
1. Read spatial coordinates of the atoms in protein backbones from a plurality of PDB files.
2. For an amino acid in a protein, extract backbone structural data for the l preceding amino acids and r subsequent amino acids in the same protein chain. Each of l and r is an integer between 0 to 3 (l and r are less than 3 when the side chain at question is near an endpoint of a protein). This way, a plurality of backbone sequences are extracted. Each backbone sequence includes l+r+1 amino acids.
3. Evaluate the data quality and reject data in low quality.
4. Determine the dihedral angles (i.e., Chi angles) descriptive of the conformation of each backbone sequence. For example, the processor may use the function ToChiAngles( ) to determine the dihedral angles.
5. Use a clustering method to classify the backbone sequences into one or more backbone dusters. For example, the processor may use the K-means clustering method to generate the dusters based on the dihedral angles.
6. Determine the backbone pose representative of each backbone cluster. These backbone poses form the backbone pose library.

To further improve the accuracy of predicting side chain conformations, the disclosed embodiments use atom types to distinguish the chemical Identities of different atoms. Atom types are essential for ranking the potential energies of the possible side chain conformations. The disclosed embodiments presume that atoms with the same electronic, chemical, and structural properties share the same atom type, and classify each atom by its neighboring atoms and bonds.

Several strategies have been developed in the related art to define the atom types, such as the strategies described in, e.g., Summa C M, Levitt M, DeGrado W F, An atomic environment potential for use in protein structure prediction, Journal of Molecular Biology (2005) 352(4): 986-1001; or the CHARMM force field (see www.charmm.org). These strategies are incorporated in the present disclosure by reference.

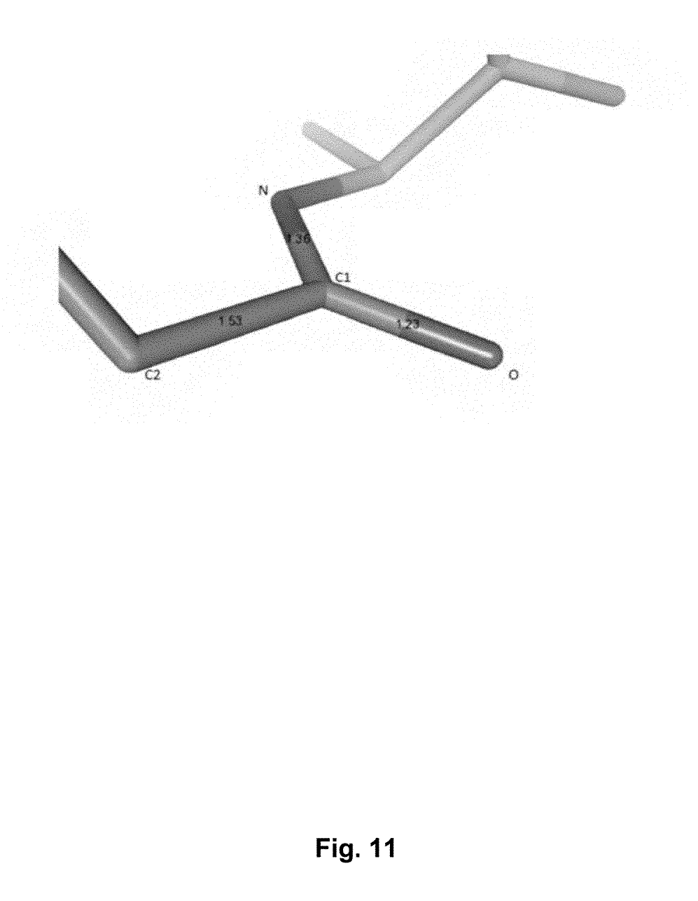

In addition, the present disclosure provides the following method for generating the atom types:
1. Extract information regarding the bond environment of each atom in the amino acids of a protein. The bond environment may include: the element of the atom at question, the bond lengths of the atom at question, and the elements of the atoms bonding with the atom at question. For example, FIG. 11 is a schematic diagram illustrating a local structure of an amino acid side chain. Referring to FIG. 11, the bond environment for atom C1 may be presented as: (C, (1.23,1.36,1.53)). That is, the element of the atom at question is carbon. The atom's bond lengths are 1.23 Å, 1.36 Å, and 1.53 Å, respectively.
2. Classify the atoms into one or more dusters according to the atoms' bond environments. The atoms in the same cluster have similar bond environments. Any of the above-described clustering methods, e.g., K-means clustering method or spectral clustering method, may be used to classify the atoms.
3. Assign a unique atom type to each cluster.

In one embodiment, atoms found in the 20 common amino acids are classified into 23 atom types, using the above-describe method. Any unclassified atoms are classified as “unknown atom type.” Table 5 lists the 23 atom types.

In the disclosed embodiments, after the side chain pose library, the backbone pose library, and the atom types are defined, machine-learning methods may be used to predict the energy-favorable side chain conformation in a specific protein structure or environment.

Specifically, a feature vector \vec{F} may be constructed to describe a conformation of a side chain at a given position of a protein. The feature vector is a high-dimensional real vector. The components of the feature vector are features that relate to the potential energy of the conformation.

In exemplary embodiments, a scoring function may be used to evaluate the likelihood for a side chain conformation to occur in the real world. For example, if (x₁, x₂, x₃, . . . xₙ) is the feature vector for the correct side chain conformation (i.e., the conformation to be predicted) and (y₁, y₂, y₃, . . . yₙ) is the feature vector for the incorrect side chain conformation, a weight vector \vec{W}=(w₁, w₂, w₃, . . . , wₙ) may be obtained such that

(Σᵢ₌₁ⁿwᵢxᵢ−Σᵢ₌₁ⁿwᵢyᵢ)>0 Eq. 4

This way, the feature vector with the highest \vec{W}·\vec{F} corresponds to the side chain conformation that is most energy favorable. Here, \vec{W}·\vec{F} is the scoring function to measure the energy scores of side chain conformations. The conformations with higher energy scores are more likely to occur in the reality.

TABLE 5

| Type | Atoms |
|---|---|
| 1 | ALA C; ARG C; ASN C; ASN CG; ASP C; CYS C; GLN C; GLN |
| | CD; GLU C; GLY C; HIS C; ILE C: LEU C; LYS C; MET C; |
| | PHE C; PRO C; SER C; THR C; TRP C; TYR C; VAL C; |
| 2 | ALA C^{α}; ARG C^{α}; ASN C^{α}; ASP C^{α}; CYS C^{α}; GLN C^{α}; |
| | GLU C^{α}; HIS C^{α}; ILE C^{α}; LEU C^{α}; LYS C^{α}; MET C^{α}; |
| | PHE C^{α}; PRO C^{α}; SER C^{α}; THR C^{α}; THR C^{α}; TRP C^{α}; |
| | TYR C^{α}; VAL C^{α}; |
| 3 | ALA C^{β}; ILE C^{δ}₁; ILE C^{γ}₂; LEU C^{δ}₁; LEU C^{δ}₂; THR C^{γ}₂; |
| | VAL C^{γ}₁; VAL C^{γ}₂; |
| 4 | ALA N; ARG N; ARG N^{ε}; ASN N; ASP N; CYS N; GLN N; |
| | GLU N; GLY N; HIS N; ILE N; LEU N; LYS N; MET N; PHE |
| | N; SER N; THR N; TRP N; TYR N; VAL N; |
| 5 | ALA O; ARG O; ASN O; ASN O^{δ}₁; ASP O; ASP O^{δ}₁; ASP O^{δ}₂; |
| | CYS O; GLN O; GLN O^{ε}₁; GLU O; GLU O^{ε}₁; GLU O^{ε}₂; GLY O; |
| | HIS O; ILE O; LEU O; LYS O; MET O; PHE O; PRO O; SER |
| | O; THR O; TRP O; TYR O; VAL O; |
| 6 | ARG C^{β}; ARG C^{γ}; ASN C^{β}; ASP C^{β}; GLN C^{β}; GLN C^{γ}; |
| | GLU C^{β}; GLU C^{γ}; HIS C^{β}; ILE C^{γ}₁; LEU C^{β}; LYS C^{β}; |
| | LYS C^{δ}; LYS C^{ε}; LYS C^{γ}; MET C^{β}; PHE C^{β}; PRO C^{β}; |
| | PRO C^{δ}; PRO C^{γ}; TRP C^{β}; TYR C^{β}; |
| 7 | ARG C^{δ}; GLY C^{α}; SER C^{β}; |
| 8 | ARG C^{ζ}; |
| 9 | ARG N^{η}₁; ARG N^{η}₂; ASN N^{δ}₂; GLN N^{ε}₂; |
| 10 | ASP C^{γ}; GLU C^{δ}; |
| 11 | CYS C^{β}; MET C^{γ}; |
| 12 | CYS S^{γ}; |
| 13 | HIS C^{δ}₂; HIS C^{ε}₁; PHE C^{δ}₁; PHE C^{δ}₂; PHE C^{ε}₁; PHE |
| | C^{ε}₂; PHE C^{ζ}; TRP C^{δ}₁; TRP C^{ε}₃; TRP C^{η}₂; TRP C^{ζ}₂; |
| | TRP C^{ζ}₃; TYR C^{δ}₁; TYR C^{δ}₂; TYR C^{ε}₁; TYR C^{ε}₂; |
| 14 | HIS C^{γ}; PHE C^{γ}; TYR C^{γ}; |
| 15 | HIS N^{δ}₁; HIS N^{ε}₂; TRP N^{ε}₁; |
| 16 | ILE C^{β}; LEU C^{γ}; VAL C^{β}; |
| 17 | LYS N^{ζ}; |
| 18 | MET C^{ε}; |
| 19 | MET S^{δ}; |
| 20 | PRO N; |
| 21 | SER O^{γ}; THR O^{γ}₁; TYR O^{η}; |
| 22 | TRP C^{δ}₂; TRP C^{ε}₂; TYR C^{ζ}; |
| 23 | TRP C^{γ}; |

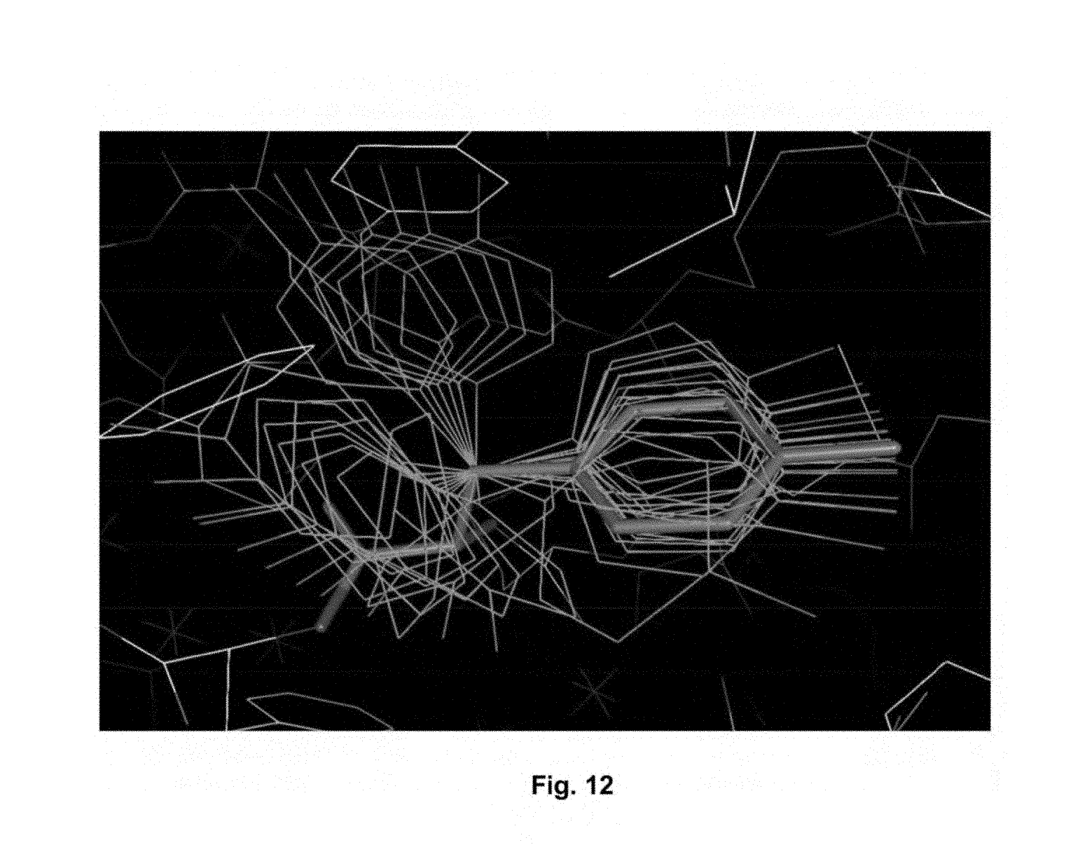

In exemplary embodiments, a machine-learning algorithm may be used to train the weight vector \vec{W}. The training data may be obtained from real-world protein structure data, such as PDB files. FIG. 12 is a schematic diagram illustrating correct and incorrect side chain conformations used in a training process, according to an exemplary embodiment. Referring to FIG. 12, the correct conformation of a TRP side chain is extracted from a PDB file and is shown in stick model, while the incorrect conformations of the TRP side chain are shown in lines model. A feature vector may be constructed for each conformation. A machine-learning algorithm, e.g., a linear regression process, is then executed to search for the \vec{W} satisfying Eq. 4.

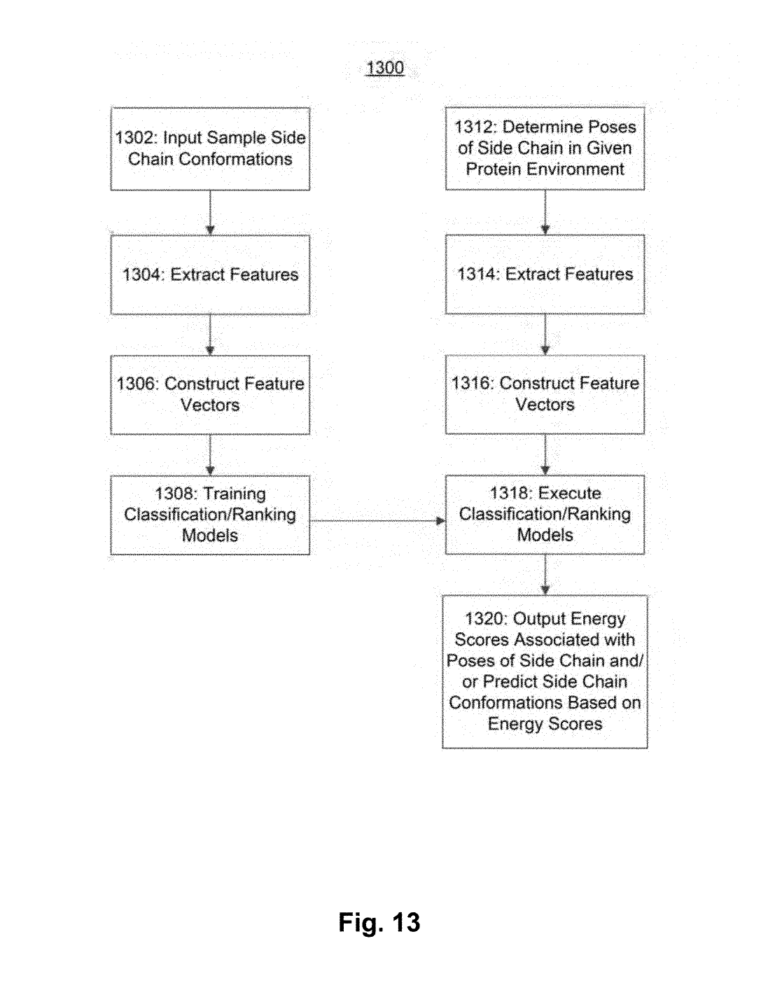

FIG. 13 is a flowchart of a method 1300 for predicting the conformation of a side chain, according to an exemplary embodiment. For example, method 1300 may be executed by a processor. Referring to FIG. 13, steps 1302-1308 describe the training process for searching for the weight vector \vec{W}. Specifically, in step 1302, the processor obtains the training data. The processor may obtain correct side chain conformations from PDB files. The processor may also generate incorrect side chain conformations used for the training. In step 1304, the processor extracts the features related to each conformation. In step 1306, the processor uses the extracted features to construct a feature vector for each conformation. In step 1308, the processor trains a classification model or a ranking model to search for the weight vector \vec{W}.

With continued reference to FIG. 13, Steps 1312-1320 describe the process of predicting an unknown conformation using the weight vector \vec{W}. Specifically, in step 1312, the processor determines the poses of the side chain in a given protein environment. Data regarding the protein environment may be extracted from a PDB file and include the conformations and sequences of other amino acids surrounding the side chain to be predicted.

In step 1314, the processor extracts the features associated with the poses of the side chain to be predicted. In step 1316, the processor uses the extracted features to construct the feature vector associated with each pose of the side chain. For example, if the side chain pose library contains 18 poses for the side chain, the processor needs to construct 18 feature vectors. In step 1318, the processor uses the classification model or ranking model trained in steps 1302-1308 to calculate the energy scores of the poses. In step 1320, the processor outputs the energy scores. The poses with higher energy scores are more appropriate for the side chain. Moreover, the processor may predict the conformations of the side chain based on the energy scores associated with the poses. For example, the processor may compute the likelihood for each pose to occur in the real world. For another example, the processor may determine the statistical average of the poses based on the energy score.

The above-described prediction process is performed with the assumption that protein environment of the side chain to be predicted is in the native structure. In the present disclosure, the prediction process is referred to as “Leave-One-Out (LOO)” prediction. Moreover, the classification and ranking models are collectively referred to as LOO models. Further, the energy scores are referred to as LOO scores.

Method 1300 uses the feature vectors and weight vectors to construct implicit energy terms and use a machine-learning algorithm to derive the correct energy scoring functions. This way, method 1300 ties the energy of a side chain with the conformation of the side chain, and avoids artificial construction of energy terms. Thus, method 1300 can accurately predict the side chain conformations.

In the disclosed embodiments, the features constituting the feature vector may be divided into three parts: self-potential features, solvent-exposure-potential features, and atom-pairwise-potential features. Accordingly, the portions of the feature vector attributable to these parts are referred to as self-potential vector, solvent-exposure-potential vector, and atom-pairwise-potential vector, respectively. The detailed processes of extracting these features are described in the following.

In the present disclosure, self-potential energy is defined as the free energy determined solely by an amino acid residue's side chain conformation and backbone conformation. Accordingly, the portion of the feature vector associated with the self-potential energy may be expressed only by the side chain poses and backbone poses. If the pose library of an amino acid includes N poses (N being a positive integer), the RMSD values between a conformation of the side chain and the N poses form an N-dimensional real vector, hereinafter referred to as side chain “pose vector.” For example, the pose library associated with a side chain may include 18 poses, and a conformation of this side chain may be expressed as an 18-dimensional pose vector shown below:
(0.804857, 1.20659, 0.287016, 0.897721, 0.00263, 0.698575, 0.004017, 0.033441, 0.890976, 0.015908, 0.001548, 1.20922, 0.90694, 0.001494, 0.002316, 1.48737, 1.10267, 0.975936).
   Each component of the pose vector may be calculated according to:

PoseVector_{PoseNum}=(RMSD(Pose_{PoseNum},conformation)) Eq. 5

Similarly, a backbone vector may be constructed using the RMSD values between a conformation of a l+r+1 backbone sequence and the associated backbone poses. Collectively, the side chain pose vector and the backbone vector are referred to as “pose vector.” The pose vector is used to describe a specific side chain and/or backbone conformation.

Eq. 5 is merely one way of constructing a pose vector. In exemplary embodiments, the pose vector may be generally expressed as:

PoseVector_{PoseNum}=(f(RMSD(Pose_{PoseNum},conformation))) Eq. 6

where f(x) is a pre-determined function that is capable of mapping the RMSD to a reasonable expressive feature value. For example, when f(x)=x, Eq. 6 becomes Eq. 5. For another example, f(x)=k^{x}, where k is a constant and tuned for best performance. In one embodiment, the pose vector is generated according to:

PoseVector_{PoseNum}=0.5^{(4×(RMSD(Pose}^{_{PoseNum}}^{,confirmation)-0.35))} Eq. 7

The essential idea is to use a f(x) that enables sparse coding, i.e. to make large RMSD values more weighted and to ignore the small RMSD values. This way, a linear model can be used to fit the energy functions.

In the disclosed embodiments, to construct the feature vector related to the solvent exposure potential energy, several algorithms may be used to calculate the exposure area for a given atom in a molecule. One such method is to calculate the accessible surface area (ASA), which is the surface area of a biomolecule that is accessible to a solvent. For example, the Shrake-Rupley algorithm may be used to calculate the ASA. Similar to the process of “rolling a ball” along the surface, the Shrake-Rupley algorithm draws a mesh of points equidistant from each atom of the molecule and uses the number of points that are solvent accessible to determine the surface area.

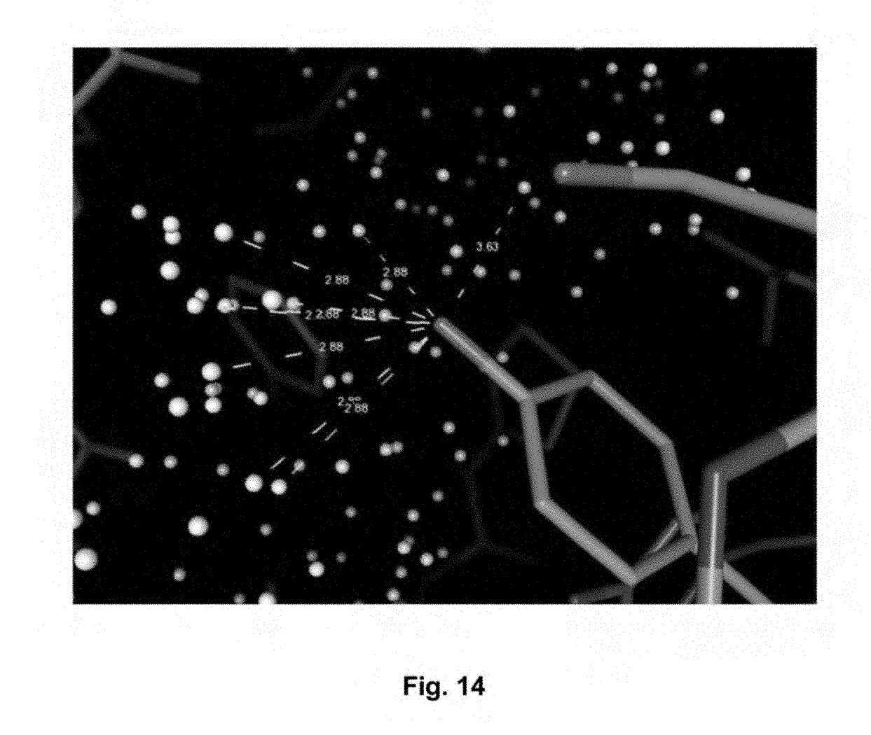

In some embodiments, a rapid approximation method may be used during the calculation of the ASA. Specifically, the surface of the atoms may be assumed as spheres. The rapid approximation method translates a sphere area (i.e., the surface of an atom) to discrete points according to the following process:
1. Generate N probe points uniformly distributed around a surface of an atom at question. FIG. 14 is a schematic diagram illustrating the probe points uniformly distributed around an oxygen atom.
2. Identify the positions occupied by probe points that do not dash with other atom spheres as free positions. Free positions are used to describe the exposure area of the atom at question. If it is determined that M points do not clash with other atoms, the solvent exposure area of the atom at question is approximated according to:

Exposure Area=Atom Surface Area×M/N Eq. 8

In the disclosed embodiments, the solvent exposure potential energy associated with the current side chain may be determined by modeling the exposure area deviations of nearby atoms when placing the current side chain with a specific pose into the protein. The exposure area deviations may then be converted to a real vector, i.e., a solvent-exposure-potential vector, for measuring the contribution of solvent exposure potential.

The solvent-exposure-potential vector associated with a side chain in a specific pose may be generated according to the following steps:
1. Identify nearby atoms of the current side chain. If the current side chain is denoted as A, the protein is denoted as B, then the atom satisfying

aε(B−A) Eq. 9

and ∃bεA,∥a−b∥<R Eq. 10
are recorded as C. ∥a−b∥ is the distance between atoms a and b.
2. For each atom aεC, calculate approximated exposure area using, for example, the above-described methods for calculating the ASA. Let eₐ be the exposure area of atom a when the side chain is present, and e′ₐ be the exposure area of atom a when the side chain is absent from the protein. Define fₐ=eₐ−e′ₐ as the exposure area deviation of atom a when placing the current side chain in protein B.
3. Group fₐ by each atom type. That is, calculate the set {Fₜ}, where AtomType(a) denotes the atom type of atom a, and Fₜ={fₐ|AtomType(a)=t}.
4. For each atom type, convert the set of exposure area deviation values Fₜ to a soft-bin histogram. The minimum value of the histogram is 0, and the maximum value of the histogram is the surface area of the respective atom.
5. Concatenate histograms of each atom type to form the solvent potential feature vector.

In some embodiments, the above steps 4 and 5 may be changed to other summation schemes. For example, a direct sum over all exposure values of each atom type may be used.

Atom pairwise potential relates to internal force among non-bonding atom pairs, such as van der Waals force and electrostatic force. The internal force between two atoms is determined by the type of the atoms, the distances between the atoms, and the angle between the force and the bonds of the atoms. For example, traditional force field including CHARMM use several type of pairwise potentials, such as Lennard-Jones and electrostatic terms. See, e.g., MacKerell Jr A D, Bashford D, Bellott M, et al. All-atom empirical potential for molecular modeling and dynamics studies of proteins, The journal of physical chemistry B (1998) 102(18): 3586-3616.

In some embodiments, different terms of the atom pairwise potential may be merged. For example, if the atom pairwise potential includes a term F expressed in F(distance), a term G expressed in G(distance), then a new term I may be defined according to:

H(distance)=F(distance)+G(distance) Eq. 11

This way, the pairwise potential is described by implicit potential terms instead of explicit potential terms.

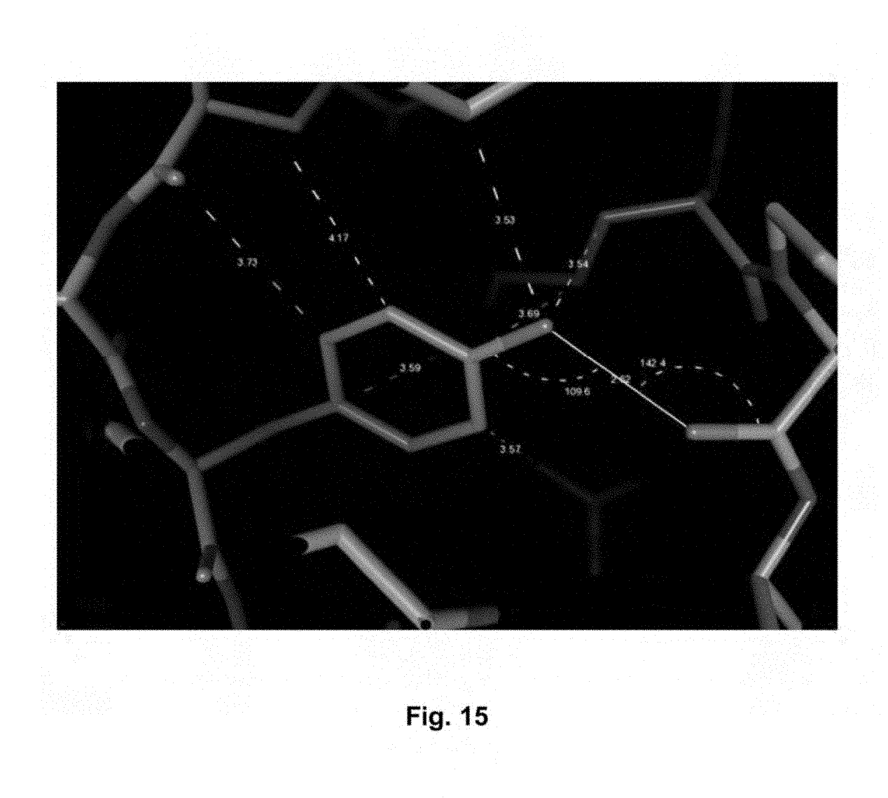

Besides distances between the atoms, the pairwise potential also depends on the direction of the pairwise interactions between the atoms. The direction is particularly important in the cases involving polar atoms. Generally, bonded atoms contributed more to the pairwise potential than non-bonded atoms. FIG. 15 is a schematic diagram illustrating pairwise interaction between two atoms. Referring to FIG. 15, the distance between two oxygen atoms (identified as 1501 and 1502) is 2.57 Å, and the angles between the pairwise force vector and the bonds associated with the two oxygen atoms are 109.1° and 108.0°, respectively. An angle score may be defined to measure the influence of the bonds on the pairwise potential. The angle score is the dot product between an atom's pairwise force vector and bond vector. For an atom with more than one covalent bond, the dot product is between the atom's pairwise force vector and the sum of all the bond vectors. The angle score may be normalized and thus have a range of [−1,1].

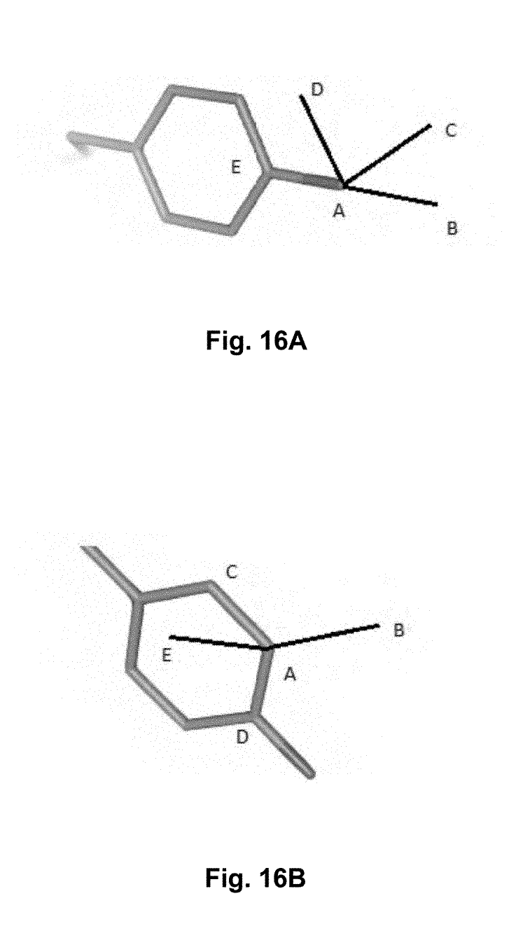

FIG. 16A is a schematic diagram illustrating multiple pairwise interactions associated with an atom that has a covalent bond. Referring to FIG. 16 A, the oxygen atom A has only one covalent bond. The covalent bond is represented by the vector \vec{EA}. An angle score of atom A may be defined as the dot product between a pairwise force vector associated with atom A and the bond vector \vec{EA}. For example, the pairwise interaction formed between atom A and atom B has the highest possible angle score, since \vec{EA}·\vec{AB}=1. Conversely, the pairwise interaction formed between atom A and atom E has the lowest angle score since \vec{EA}·\vec{AE}=−1. Moreover, the pairwise interactions formed between atom A and atom C or D have an angle score in between ˜1 and 1.

FIG. 16B is a schematic diagram illustrating multiple pairwise interactions associated with an atom that has two covalent bonds. Referring to FIG. 16B, atom A has two bond vectors \vec{CA} and \vec{DA}. The pairwise interaction formed between atom A and atom B has a pairwise force vector \vec{AB}, which is in the same direction as the net vector \vec{CA}+\vec{DA}. Accordingly, the pairwise interaction formed between atom A and atom B has the highest angle score. Conversely, pairwise force vector \vec{AE} is in the opposite direction of the net vector \vec{CA}+\vec{DA}, and thus the pairwise interaction formed between atom A and atom E has the lowest angle score. For atoms with more than two covalent bonds, the angle score is similarly defined.

After the distances and angle scores are determined, the atom pairwise potential energy may be determined. The information regarding the atom pairwise potential energy may then be converted to an atom-pairwise-potential vector using a method similar to the above-described method for generating the solvent-exposure-potential vector.

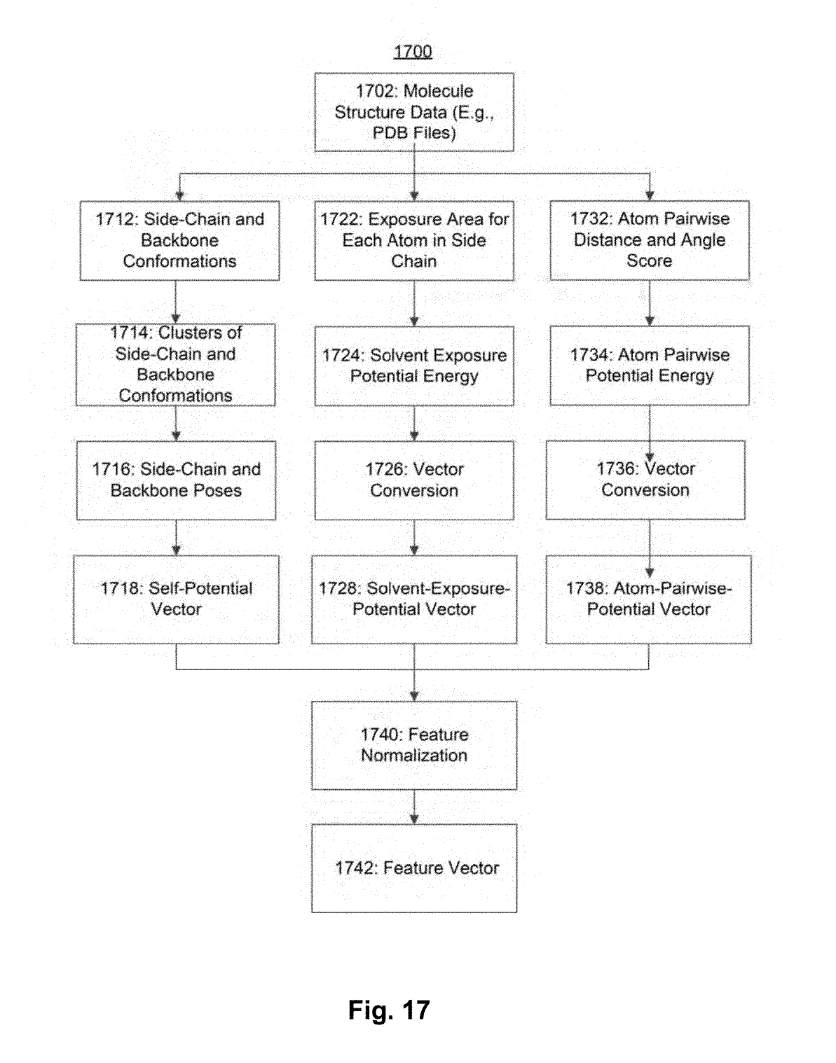

The above-described processes of extracting the self-potential features, solvent-exposure-potential features, and atom-pairwise-potential features are summarized in FIG. 17. FIG. 17 is a flowchart of a method 1700 for constructing a feature vector, according to an exemplary embodiment. For example, method 1700 may be performed by a processor.

Referring to FIG. 17, in step 1702, the processor obtains protein structure data from PDB files. In steps 1712-1718, the side chain pose library and backbone pose library are constructed. Then, the pose vectors and backbone vectors are constructed based on the pose libraries. Further, the pose vectors and backbone vectors are combined to form the self-potential vectors.

In steps 1722-1728, the processor determines the exposure area for each atom in the side chain to be predicted, and computes the solvent exposure potential score of the side chain based on the exposure areas. The processor then converts the solvent exposure potential score into feature terms and constructs the solvent-exposure-potential vector.

In steps 1732-1738, the processor determines the atom pairwise distances and angle scores, and computes the atom pairwise score based on the distances and angle scores. The processor then converts the atom pairwise potential score into feature terms and constructs the atom-pairwise-potential vector.

In step 1740, the processor normalizes the self-potential vector, the solvent-exposure-potential vector, and the atom-pairwise-potential vector. Finally, in step 1742, the processor combines these vectors into the feature vector.

In one embodiment, the feature vector may have more than 50,000 dimensions. For example, the dimensions attributable to the self-potential are determined by the number of side chain poses in the side chain pose library (e.g., Table 3). Moreover, the backbone pose library may include 39 backbone poses. Thus, for each side chain pose, there are 20*39=780 dimensions related to the backbone poses. Furthermore, for each of the 23 atom types, 4 dimensions may be used to describe the solvent exposure deviations, i.e., collectively 23*4=92 dimensions for the 23 atom types. In addition, to describe the pairwise potential, every possible pairwise distances and pairwise angles scores need to be considered.

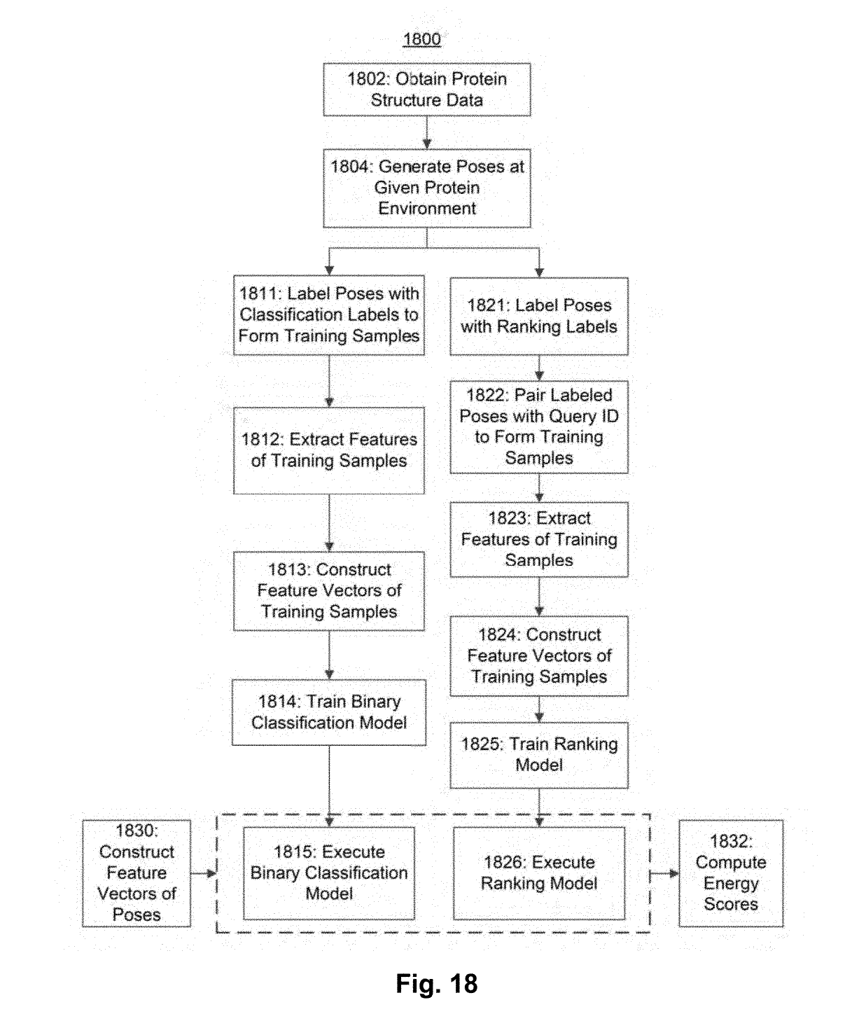

Referring back to method 1300, LOO models (i.e., a classification model and/or a ranking model) are trained for predicting the energy scores. FIG. 18 is a flowchart of a method 1800 for predicting the conformations of a side chain, according to an exemplary embodiment. For example, method 1800 may be performed by a processor. Referring to FIG. 18, methods 1800 may include the following steps.

In step 1802, the processor obtains protein structure data from PDB files. The processor may evaluate the quality of the structure data and reject data in low quality.

In step 1804, the processor obtains poses of side chains at given protein environment. The processor may retrieve the poses from the side chain pose library. The side chain conformations contained in the PDB files are true conformations occurring in the actual proteins. The process may be the same as or different from the true conformations.

Next, if a classification model is used, steps 1811-1814 are performed. If a ranking model is used, steps 1821-1825 are performed.

In step 1811, the processor labels the poses with classification labels. The classification labels indicate whether the poses are positive or negative. For a particular side chain, the positive pose is the pose of the side chain with the lowest RMSD from the true conformation, and the negative poses differ from the true conformation by RMSDs above a predetermined threshold. The labeled poses constitute the training samples for the classification model.

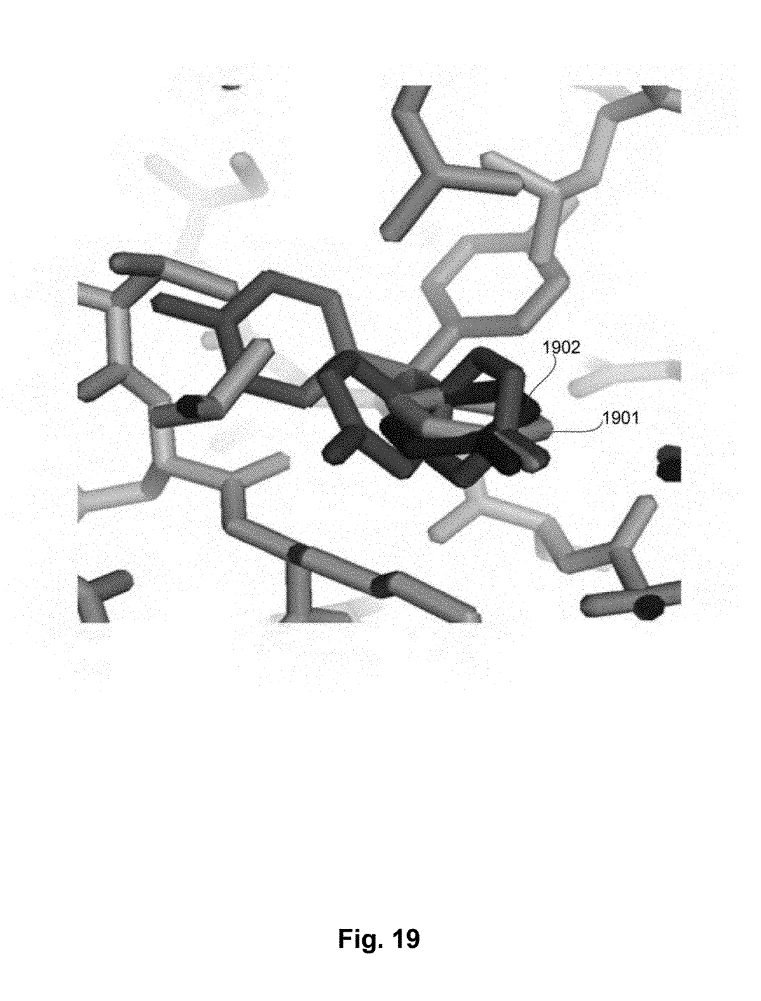

FIG. 19 is a schematic diagram illustrating training samples used for generating a classification model, according to an exemplary embodiment. Referring to FIG. 19, the true conformation of a TRP side chain is labeled as 1901. The TRP pose with the lowest RMSD from the true conformation is labeled as 1902 and is chosen as a positive training sample. Other TRP poses shown in FIG. 19 have RMSDs above a predetermined value and are chosen as negative training samples.

In step 1812, the processor extracts LOO features from each training sample. The features are a concatenation of self-potential features, solvent-exposure-potential features, and atom-pairwise-potential features.

In step 1813, the processor uses the extracted features to construct the feature vector for each training sample. The feature vector is labeled by the corresponding classification label.

In step 1814, the processor runs a machine-learning algorithm to generate a binary classification model. The binary classification model includes but is not limited to logistic regression, support vector machines (SVM), gradient boosting decision tree (GBDT), etc.

To use a classification model to predict the conformation of a side chain at a given protein environment, the processor may construct the feature vectors for all the poses of the side chain (step 1830). The processor may then execute the trained classification model (step 1815) to compute a classification score, i.e., energy score, for each pose (step 1832). The pose with the highest classification score is determined as the most appropriate pose.

The above-described process for generating and using the classification model treats the prediction of side chain conformations as a multiclass classification problem. This problem is reduced into multiple binary classifications, using strategies such as One-vs.-Rest (OvR) and One-vs.-One (OvO).

Alternatively or jointly, steps 1821-1825 may be performed to train a ranking model. In step 1821, the processor labels the poses with ranking labels. The ranking labels indicate the structural similarity between the poses and the true conformation of the side chain.

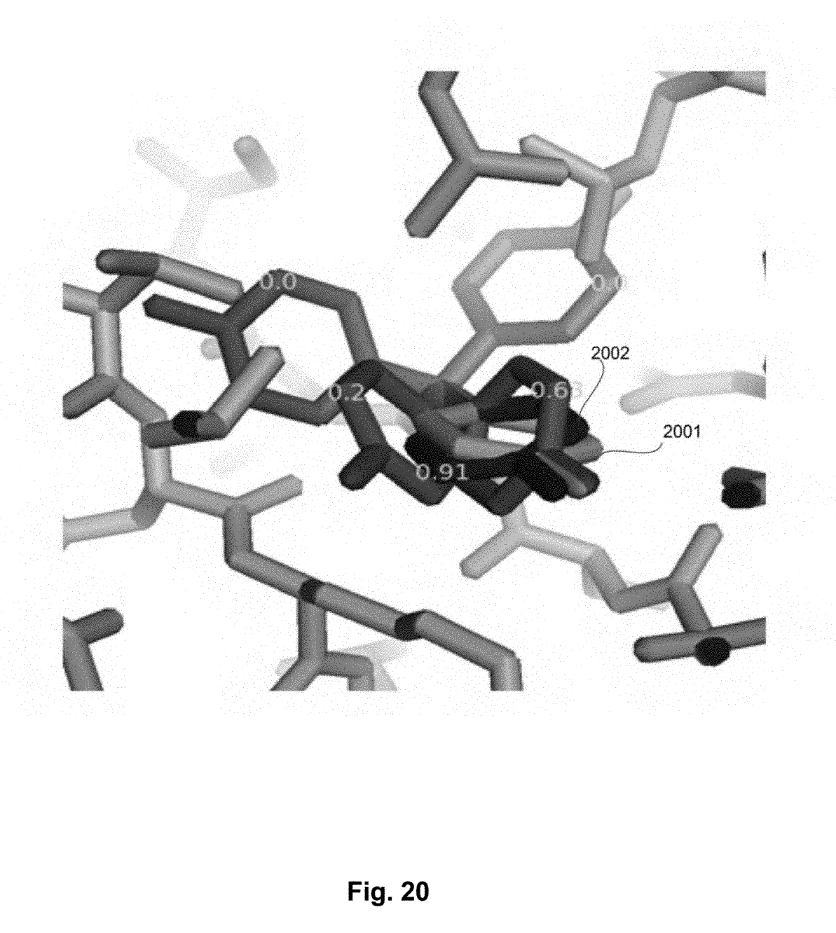

FIG. 20 is a schematic diagram illustrating training samples used for generating a ranking model, according to an exemplary embodiment. Referring to FIG. 20, the true conformation of a TRP side chain is labeled as 2001. The TRP poses are given ranking labels according to their RMSDs from the true TRP conformation. For example, the TRP pose labeled as 2002 has the lowest RMSD and is given a high ranking label approaching 1. Conversely, the TRP poses with large RMSDs (the TRP poses other than 2001 and 2002) have ranking labels approaching 0.

In step 1822, the processor pairs the poses with query IDs to form training samples. Specifically, the processor treats the position of a side chain and the protein environment of the side chain as a query of the ranking model. Each query is given a query ID. The processor then sorts the poses of the side chain according to the ranking labels to generate a list of sorted poses. Here, the ranking labels, i.e., the RMSDs, indicate the relevance of the poses to the query ID. The processor further pairs the list of sorted poses with the query ID, to form a training sample

In step 1823, the processor extracts LOO features from each training sample. Since a training sample may include more than one pose, the processor may extract the LOO features of each pose. The features are a concatenation of self-potential features, solvent-exposure-potential features, and atom-pairwise-potental features.

In step 1824, the processor uses the extracted features to construct the feature vectors for the poses included in each training sample.

In step 1825, the processor runs a machine-learning algorithm to generate a ranking model. The ranking model computes the relevance of a pose to a given query (i.e., position and protein environment of a side chain). The ranking model includes but is not limited to RankLinear, RankSVM, LambdaMART, etc.

To use a ranking model to predict the conformation of a side chain at a given protein environment, the processor may construct the feature vectors for all the poses of the side chain (step 1830). The processor may then execute the trained ranking model (step 1826) to compute a relevance score, i.e., energy score, for each pose (step 1832). The most relevant pose is determined as the most appropriate pose.

In exemplary embodiments, the generation of the LOO models (i.e., classification and ranking models) depends on the dimensions of the feature vectors. Accordingly, when the feature vectors used for different types of amino acids have different dimensions, separate LOO models need to be created from different amino acids. Conversely, when the feature vectors used for different types of amino acids have the same dimension, a unified LOO model may be created for all the 20 amino acids.

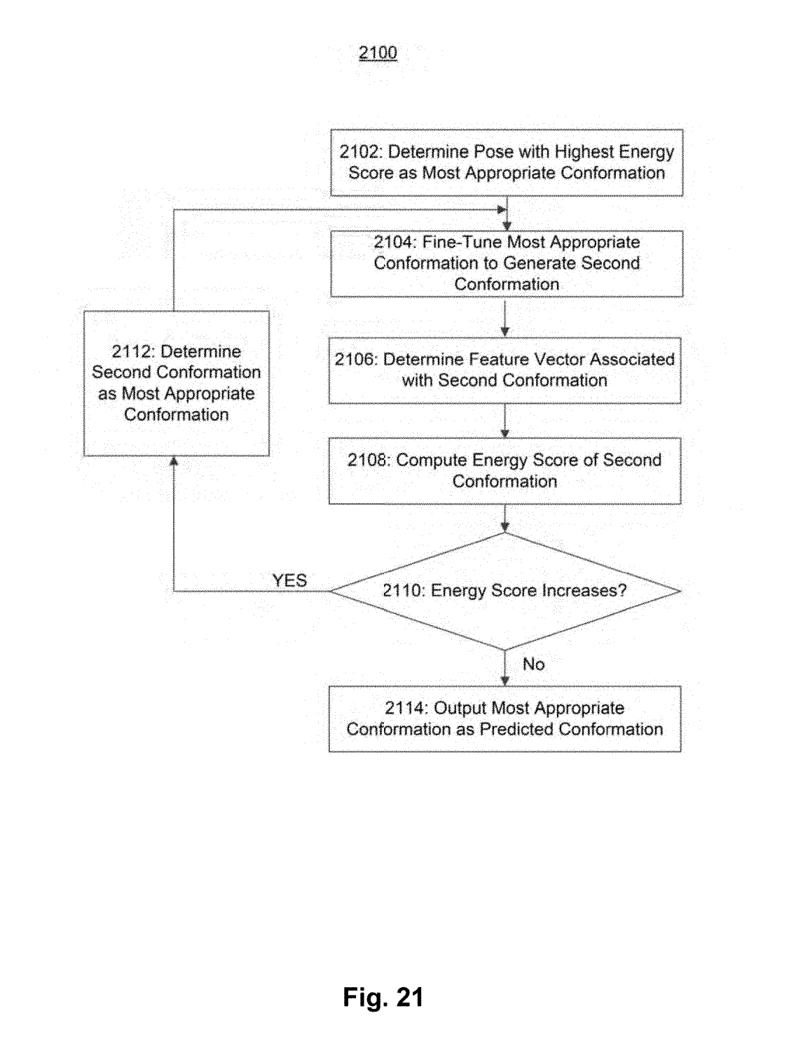

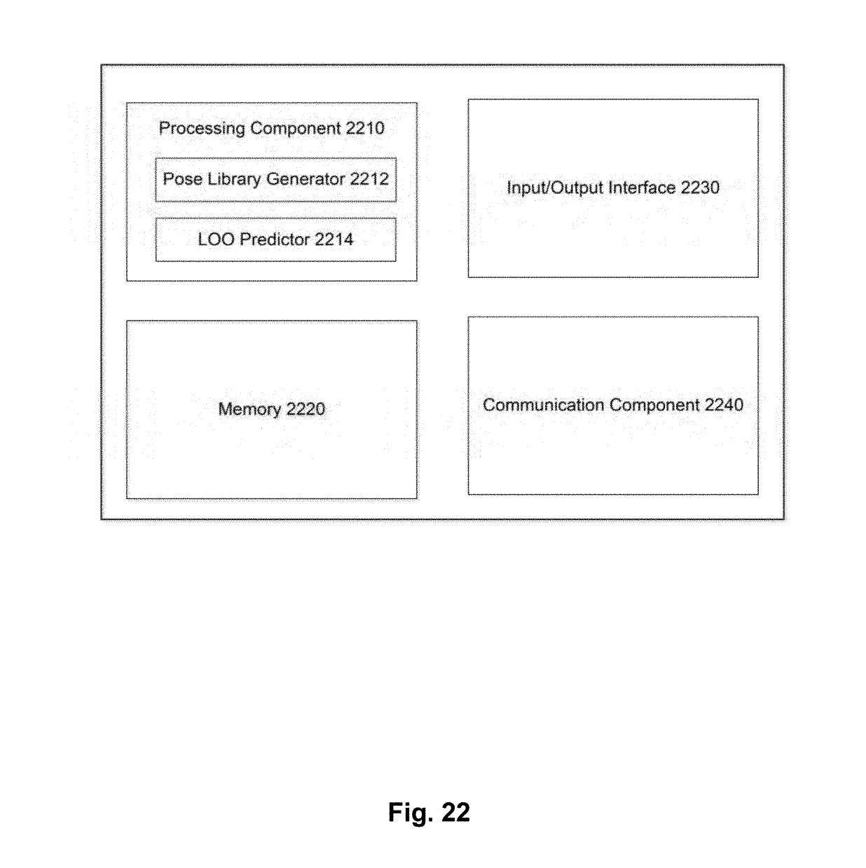

In exemplary embodiments, after the pose with the highest energy score is determined for a side chain in a given position and protein environment, the pose may be fine-tuned to search for the most energy favorable conformation. FIG. 21 is a flowchart of a method 2100 for predicting conformations of a side chain, according to an exemplary embodiment. For example, method 2100 may be executed by a processor. Referring to FIG. 21, method 2100 may include the following steps.

In step 2102, the processor determines the pose with the highest energy score for the side chain in a given position and protein environment. For example, the processor may perform method 1800 to determine the pose with the highest energy score. The processor may further treat this pose as the most appropriate conformation for the side chain in the given position and protein environment.

In step 2104, the processor fine-tunes the most appropriate conformation to generate a second conformation of the side chain. For example, the processor may compute the Chi angles associated with the most appropriate conformation. The processor may then adjust some or all of the Chi angles in small steps to generate the second conformation, which slightly deviates from the most appropriate conformation.

In step 2106, the processor determines the feature vector associated with the second conformation. For example, the processor may perform method 1700 to determine the feature vector based on the newly obtained Chi angles.

In step 2108, the processor computes the energy score associated with the conformation. For example, the processor may perform method 1300 to compute the energy score based on the feature vector determined in step 2106.

In step 2110, the processor determines whether the energy score increases. That is, the processor determines whether the energy score of the second conformation is higher than the most appropriate conformation. If the energy score increases, the processor determines the second conformation as the most appropriate conformation (step 2112) and returns to step 2104 to further fine-tune the side chain conformation. The processor may repeat steps 2104-2112 until the energy score no longer increases. Then the processor proceeds to step 2114 and outputs the second conformation as the predicted conformation.

FIG. 22 is a block diagram of a device 2200 for predicting side chain conformations, according to an exemplary embodiment. For example, device 2200 may be a desktop, a laptop, a server, a server duster consisting of a plurality of servers, a cloud computing service center, etc. Referring to FIG. 22, device 2200 may include one or more of a processing component 2210, a memory 2220, an input/out (I/O) interface 2230, and a communication component 2240.

Processing component 2210 may control overall operations of device 2200. For example, processing component 2210 may include one or more processors that execute instructions to perform all or part of the steps in the following described methods. In particular, processing component 2210 may include a pose library generator 2212 configured to generate the side chain and/or backbone pose libraries according to the above-described methods. Moreover, processing component 2210 may include a LOO predictor 2214 configured to use the disclosed machine-learning methods to generate the LOO models, and to execute the LOO models to predict the most appropriate side chain conformations. Further, processing component 2210 may include one or more modules (not shown) which facilitate the interaction between processing component 2210 and other components. For instance, processing component 2210 may include an I/O module to facilitate the interaction between I/O interface and processing component 2210.

Processing component 2210 may include one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing all or part of the steps in the above-described methods.

Memory 2220 is configured to store various types of data and/or instructions to support the operation of device 2200. Memory 2220 may include a non-transitory computer-readable storage medium including instructions for applications or methods operated on device 2200, executable by the one or more processors of device 2200. For example, the non-transitory computer-readable storage medium may be a read-only memory (ROM), a random access memory (RAM), a CD-ROM, a magnetic tape, a memory chip (or integrated circuit), a hard disc, a floppy disc, an optical data storage device, or the like.

I/O interface 2230 provides an interface between the processing component 2210 and peripheral interface modules, such as input and output devices of device 2200. I/O interface 2230 may employ communication protocols/methods such as audio, analog, digital, serial bus, universal serial bus (USB), infrared, PS/2, BNC, coaxial, RF antennas, Bluetooth, etc. For example, I/O interface 2230 may receive user commands from the input devices and send the user commands to processing command 2210 for further processing.

Communication component 2240 is configured to facilitate communication, wired or wirelessly, between device 2200 and other devices, such as devices connected to the Internet. Communication component 2240 can access a wireless network based on one or more communication standards, such as Wi-Fi, LTE, 2G, 3G, 4G, 5G, etc. In some embodiments, communication component 2240 may be implemented based on a radio frequency identification (RFID) technology, an infrared data association (IrDA) technology, an ultra-wideband (UWB) technology, a Bluetooth (BT) technology, or other technologies. For example, communication component 2240 may access the PDB files via the Internet and/or send the prediction results to a user.

This application is intended to cover any variations, uses, or adaptations of the present disclosure following the general principles thereof and including such departures from the present disclosure as come within known or customary practice in the art. Other embodiments of the present disclosure will be apparent to those skilled in the art from consideration of the specification and practice of the present disclosure. It is intended that the specification and examples be considered as exemplary only, with a true scope and spirit of the invention being indicated by the following claims.

In particular, variations of the disclosed methods will be apparent to those of ordinary skill in the art, who may rearrange and/or reorder the steps, and add and/or omit certain steps without departing from the spirit of the disclosed embodiments. Non-dependent steps may be performed in any order, or in parallel.

Consistent with the present disclosure, the following description is about an embodiment in which the disclosed methods are applied to predict amino acid side chain using a deep neural network.

### 1.1 Summary of the Embodiment

As described above, amino acid side chain conformation prediction is essential for protein homology modeling and protein design. Current, widely-adopted methods use physics-based energy functions to evaluate side chain conformation. As described in detail below, using a deep neural network architecture, side chain conformation prediction accuracy can be improved by more than 25%, especially for aromatic residues compared with current standard methods. More strikingly, the prediction method described herein is robust enough to identify individual conformational outliers from high resolution structures in a protein data bank without providing its structural factors. It will be appreciated by those skilled in the art that the amino acid side chain predictor could be used as a quality check step for future protein structure model validation and many other potential applications such as side chain assignment in electron microscopy, crystallography model auto-building, and protein folding.

### 1.2 Introduction

Prediction of amino acid side chain conformations on a given peptide backbone is essential for protein homology modeling, protein-protein docking (see, e.g., Gray, J. J. et al. Protein-Protein Docking with Simultaneous Optimization of Rigid-body Displacement and Side-chain Conformations. Journal of Molecular Biology 331, 281-299, doi: http://dx.doi.org/10.1016/S0022-2836(03)00670-3 (2003)), protein ab initio folding (see, e.g., Kussell, E., Shimada, J. & Shakhnovich, E. I. Side-chain dynamics and protein folding. Proteins: Structure, Function, and Bioinformatics 52, 303-321, doi: 10.1002/prot.10426 (2003)), and small molecule drug docking and design (see, e.g., Leach, A. R. Ligand docking to proteins with discrete side-chain flexibility. Journal of Molecular Biology 235, 345-356, doi: http://dx.doi.org/10.1016/S0022-2836(05)80038-5 (1994); Meiler, J. & Baker, D. ROSETTALIGAND: Protein-small molecule docking with full side-chain flexibility. Proteins: Structure, Function, and Bioinformatics 65, 538-548, doi:10.1002/prot.21086 (2006)). Over the past 20 years, many computational methods have been developed to solve the fundamental problem of side chain prediction (see, e.g., Anna, M. Modeling the Conformation of Side Chains in Proteins: Approaches, Problems and Possible Developments. Current Chemical Biology 2, 200-214, doi: http://dx.doi.org/10.2174/2212796810802030200 (2008); Krivov, G. G., Shapovalov, M. V. & Dunbrack, R. L. Improved prediction of protein side-chain conformations with SCWRL4. Proteins 77, 778-795, doi:10.1002/prot.22488 (2009)). Historically, side chain prediction involves two steps. First, a side-chain conformation library (rotamer library) is constructed based on statistical clustering of observed side chain conformations in the protein data bank (PDB), allowing the side chain being predicted to sample in this artificially constructed search space (see, e.g., Dunbrack Jr, R. L. Rotamer Libraries in the 21st Century. Current Opinion in Structural Biology 12, 431-440, doi: http://dx.doi.org/10.1016/S0959-440X(02)00344-5 (2002)). Second, a physics-based scoring function is used to evaluate the likelihood of the sampled conformations (see, e.g., Bower, M. J., Cohen, F. E. & Dunbrack, R. L., Jr. Prediction of protein side-chain rotamers from a backbone-dependent rotamer library; a new homology modeling tool. J Mol Biol 27, 1268-1282, doi:10.1006/jmbi.1997.0926 (1997); Liang, S. & Grishin, N. V. Side-chain modeling with an optimized scoring function. Protein science: a publication of the Protein Society 11, 322-331, doi:10.1110/ps.24902 (2002); Rohl, C. A., Strauss, C. E., Misura, K. M. & Baker, D. Protein structure prediction using Rosetta. Methods in enzymology 383, 66-93, doi:10.1016/s0076-6879(04)83004-0 (2004); Lu, M., Dousis, A. D. & Ma, J. OPUS-Rota: a fast and accurate method for side-chain modeling. Protein science: a publication of the Protein Society 17, 1576-1585, doi: 10.1110/ps.035022.108 (2008)). Of the prediction methods currently available, Side Chain With Rotamer Library 4 (SCWRL4) is the most widely-used method because it is accurate and fast (see, e.g., Krivov, G. G., Shapovalov, M. V. & Dunbrack, R. L. Improved prediction of protein side-chain conformations with SCWRL4. Proteins 77, 778-795, doi: 10.1002/prot.22488 (2009); Canutescu, A. A., Shelenkov, A. A. & Dunbrack, R. L. A graph-theory algorithm for rapid protein side-chain prediction. Protein Science 12, 2001-2014, doi:10.1110/ps.03154503 (2003)).

However, the side chain prediction problem has been largely overlooked, in part, due to the use of relatively less-stringent evaluation criteria. Using current standards, a prediction is considered correct if the predicted side chain position has a Chi angles within 40 degrees of the X-ray positions (see, e.g., Dunbrack, R. L., Jr. & Karplus, M. Backbone-dependent rotamer library for proteins. Application to side-chain prediction. J Mol Biol 230, 543-574, doi:10.1006/jmbi.1993.1170 (1993)). The reported performance for the current standard method, SCWRL4, is ˜90% according to this criterion (see, e.g., Krivov, G. G., Shapovalov, M. V. & Dunbrack, R. L. Improved prediction of protein side-chain conformations with SCWRL4. Proteins 77, 778-795, doi:10.1002/prot.22488 (2009)). Additionally, the SCWRL4 method predicts side chain conformations without providing variances of the estimate, which limits the justification of the method itself. More importantly, aromatic residues, such as tyrosine and tryptophan, are especially sensitive to these types of Chi-angle based errors. In addition, the SCWRL4 algorithm determines disulfide bonds before other types of bonds (see id.), which lacks biological foundations and will potentially introduce errors.

Thanks to the structural genomic initiative, the deposit number in the PDB database has seen explosive growth in the past decade with over 100,000 protein structures now available. This has been accompanied by the development of more transformative statistical analysis tools such as deep learning neural networks (see, e.g., LeCun, Y., Bengio, Y. & Hinton, G. Deep learning. Nature 521, 436-444, doi:10.1038/nature14539 (2015); LeCun, Y., Bottou. L., Bengio, Y. & Haffner, P. Gradient-based learning applied to document recognition. Proceedings of the IEEE 86, 2278-2324 (1998)), which have been shown to surpass human performance in multiple tasks from object recognition to strategic board games such as Go (see, e.g., Mnih, V. et al. Human-level control through deep reinforcement learning. Nature 518, 529-533, doi:10.1038/nature14236 http://www.nature.com/naturejoumal/v518/n7540/abs/nature14236.html#supp lementary-information (2015)).

The present disclosure tackles this old side chain prediction problem using a more data-driven approach. The following description outlines the development of a deep neural network architecture for side chain conformation prediction. First, each amino acid side chain is classified into a backbone-independent rotamer library. By further modeling amino acids side chains with 3-Dimensional (3D) images, a deep neural network is used to predict the likelihood for targeting amino acids adopting each pose. The most likely pose ranked by the disclosed convolutional neural network (CNN) architecture was the output for the prediction. Using this approach, side chain prediction accuracy can be improved by more than 25% according to an unbiased Root Mean Square Deviation (RMSD) calculation. More importantly, when the distribution of the prediction score of a large training set is modeled, the disclosed approach not only provides a favorable pose for a side chain in a given environment, but also provides information on how likely the side chain adopts a certain pose. This statistical property of the predictive score enables a pan-PDB database side chain quality evaluation to be performed without supplying structure factor information. As a result, thousands of conformational outliers for each amino acid type in the database can be identified, including clashes, mis-assigned conformers or residues that lack electron density. Many of the conformational outliers have been independently confirmed by real space validation methods including real-space R-value Z-score (RSRZ) methods (see, e.g., Kleywegt, G. J. et al. The Uppsala Electron-Density Server. Acta Crystallographica Section D 60, 2240-2249, doi: 10.1107/S0907444904013253 (2004)).

### 1.3 Results and Discussion

1.3.1 Construction of the Amino Acid Rotamer Library

Historically, the side chain conformation prediction problem has relied on efficient clustering of available side chain conformations, thereby the side chain prediction problem has been reduced to a side chain subclass assignment problem. In practice, an ideal rotamer library should satisfy the following requirements: the number of the rotamer should be kept as small as possible, in order to enable efficient searching of side chain conformations; and the average RMSD between the true conformations and their most similar rotamers in the library should be as small as possible, in order to ensure the accuracy of predicting side chain conformations. Current popular methods include the use of back-bone independent (see, e.g., Lovell, S. C., Word, J. M., Richardson, J. S. & Richardson, D. C. The penultimate rotamer library. Proteins 40, 389-408 (2000)) and back-bone dependent rotamer libraries (see, e.g., Dunbrack Jr, R. L. Rotamer Libraries in the 21st Century. Current Opinion in Structural Biology 12, 431-440, doi: http://dx.doi.org/10.1016/S0959-440X(02)00344-5 (2002); Dunbrack, R. L., Jr. & Karplus, M. Backbone-dependent rotamer library for proteins. Application to side-chain prediction. J Mol Biol 230, 543-574, doi:10.1006/jmbi.1993.1170 (1993)).

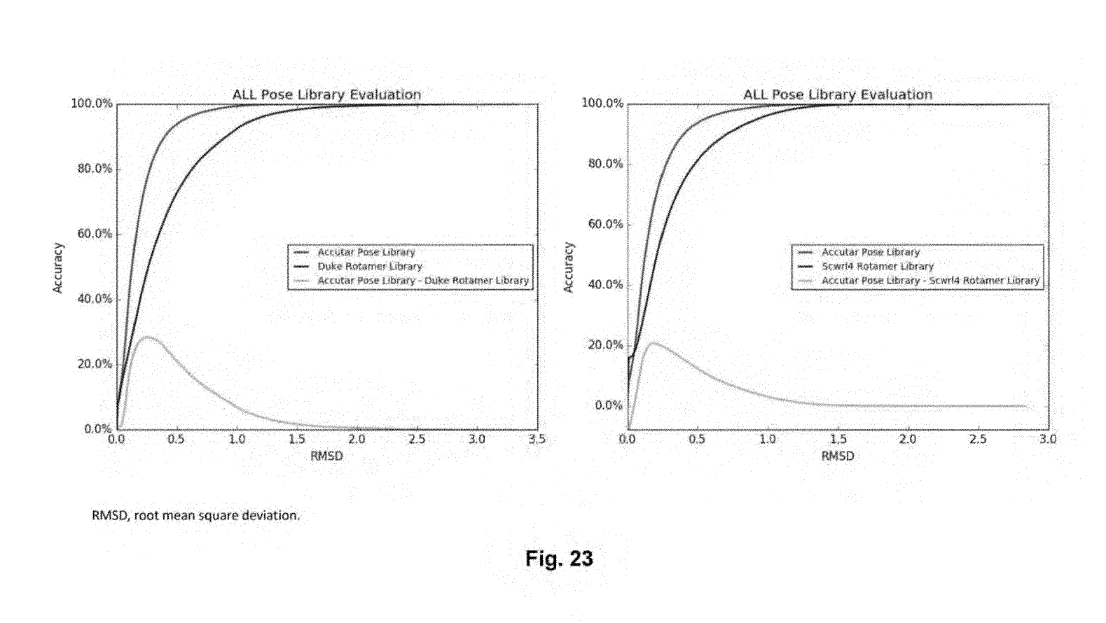

Amino acids have 1 to 5 Chi angles, depending on the lengths of the respective side chains. Accordingly, the SCWRL4 side chain rotamer library is constructed in a hierarchical manner along the multiple Chi angles of each side chain (see, e.g., Dunbrack, R. L., Jr. & Karplus, M. Backbone-dependent rotamer library for proteins. Application to side-chain prediction. J Mol Biol 230, 543-574, doi:10.1006/jmbi.1993.1170 (1993)). As a result, in the SCWRL4 side chain rotamer library, Arg has 81 subclasses and Phe has 27 subclasses. Such a hierarchical classification method, however, may be spatially too sparse to cover enough conformational space. Unlike SCWRL4, the present embodiment adopts a flat structure to classify the side chain conformations of each amino add based on the geometrical differences among the side chain conformations using a k-means clustering algorithm (1.4 Methods) (see, e.g., Hartigan, J. A. & Wong, M. A. Alogorithm AS 136: A K-means clustering algorithm. Journal of the Royal Statistical Society. Series C (Applied statistics) 28(1), 100-108 (1979)). Detailed disclosed rotamer library is provided in Supplementary Table 1. Protein conformation can be encoded by both backbone information and side chain conformation. Since the backbone conformation encoded in 3D image format was going to be used in the disclosed CNN model, the amino acid side chain rotamer library is constructed in a backbone-independent fashion, which also reduces the number of side chain poses. In fact, using this strategy, the side chains can be classified into fewer classes, which covere conformational space more efficiently as shown by the theoretic limit cumulative distribution functions (CDF) plot (FIG. 23). In this analysis, the theoretic limit CDF function measures the probability of a theoretical model deviates from its genuine structure at a certain RMSD cutoff. The CDF was defined as follows:

Fₓ(x)=P(X_{deviation}(RMSD measured in Å)≦x)

This calculation was based on the assumption that the side chain conformations of all amino acids in a protein have been fully represented by the rotamer nearest to the genuine conformation. Hence, the deviation (measured by RMSD) between the genuine structure and models, represented by different rotamer libraries including the SCWRL4 rotamer library, Duke rotamer library or the disclosed rotamer library, could be measured and used to calculate the CDF functions. Under this assumption, an ideal classification method should produce a lower theoretical limit RMSD using a relatively low number of classes. FIG. 23 is a schematic diagram showing comparison of the disclosed rotamer library and current standard rotamer library. In FIG. 23, the cumulative distribution function (CDF) plot of the disclosed rotamer library and SCWRL4 rotamer library are shown, with CDF being defined as

Fₓ(x)=P(X_{deviation}(RMSD measured in Å)≦x)

The individual entries in the PDB database, assuming the side chain conformation of all amino acids were represented by the nearest side chain class pose (or rotamer), the deviation (measured by RMSD) between the true structure and model represented by SCWRL4 rotamer library or the disclosed rotamer library are used to calculate the CDF functions 1. The CDF functions of the disclosed rotamer library and the SCWRL4 rotamer library and their differences are colored by red, green and blue, respectively.

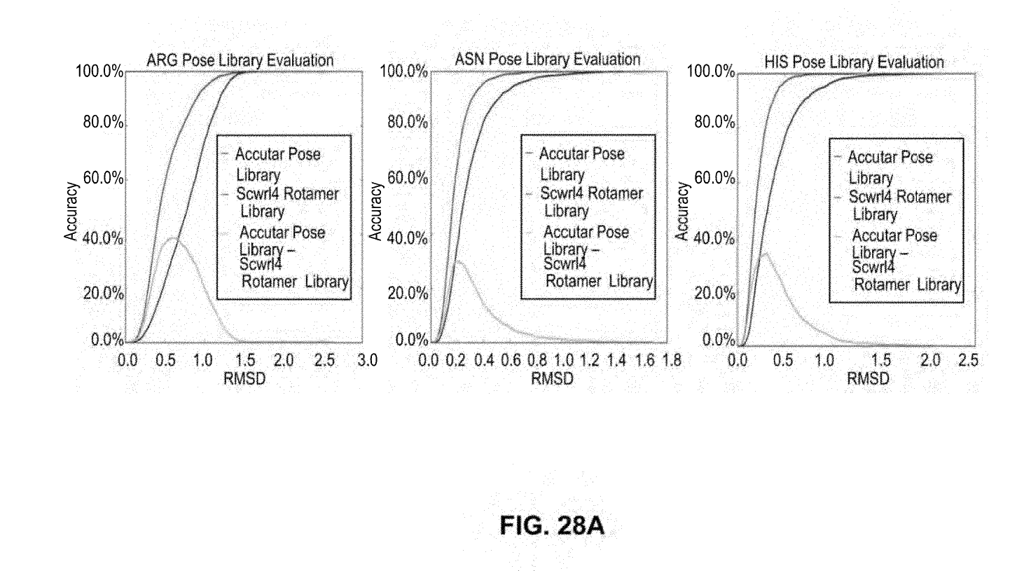

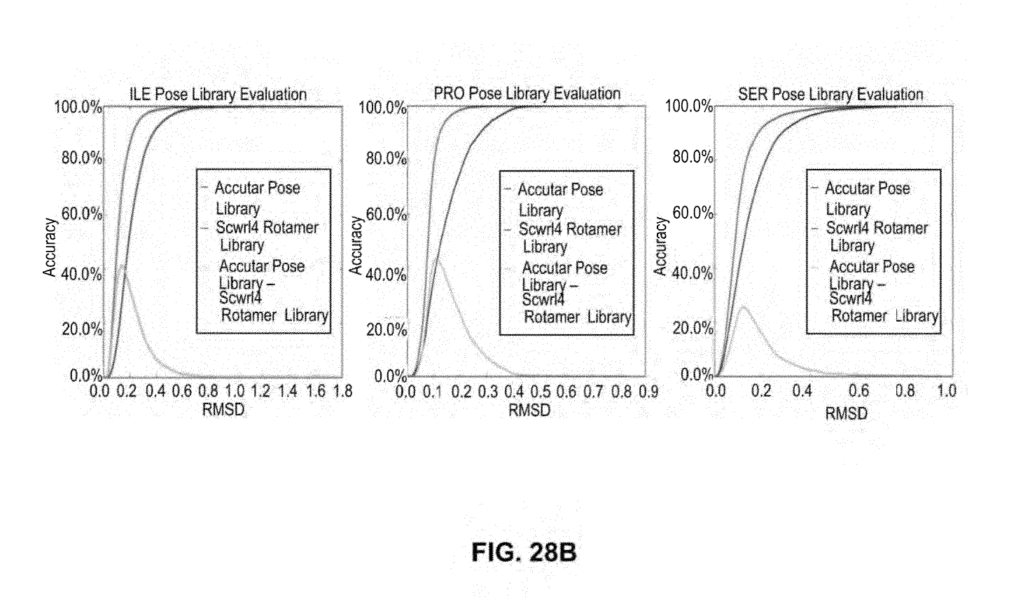

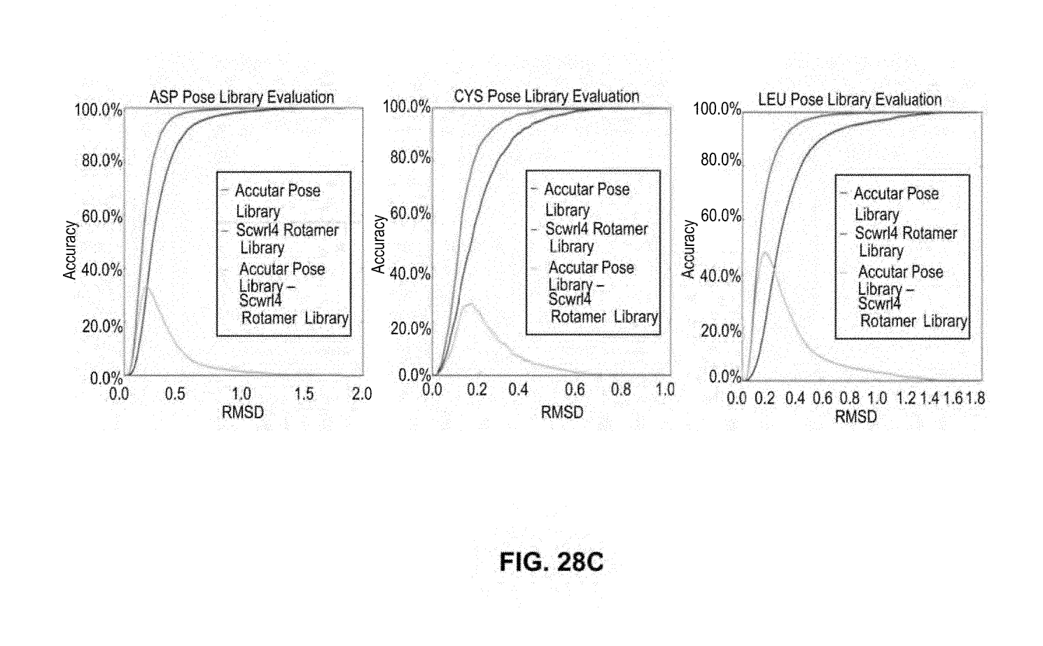

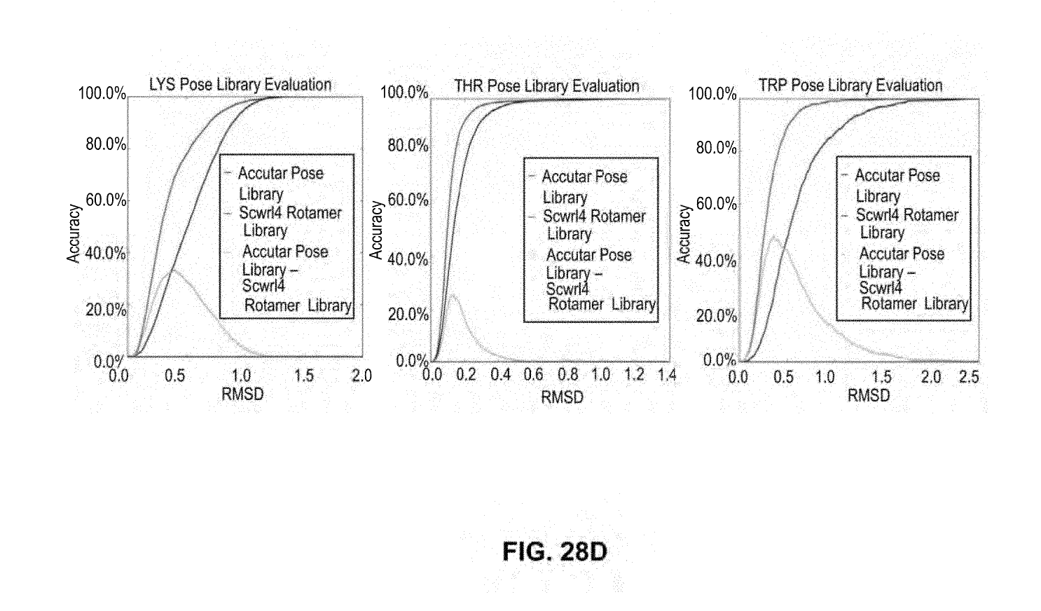

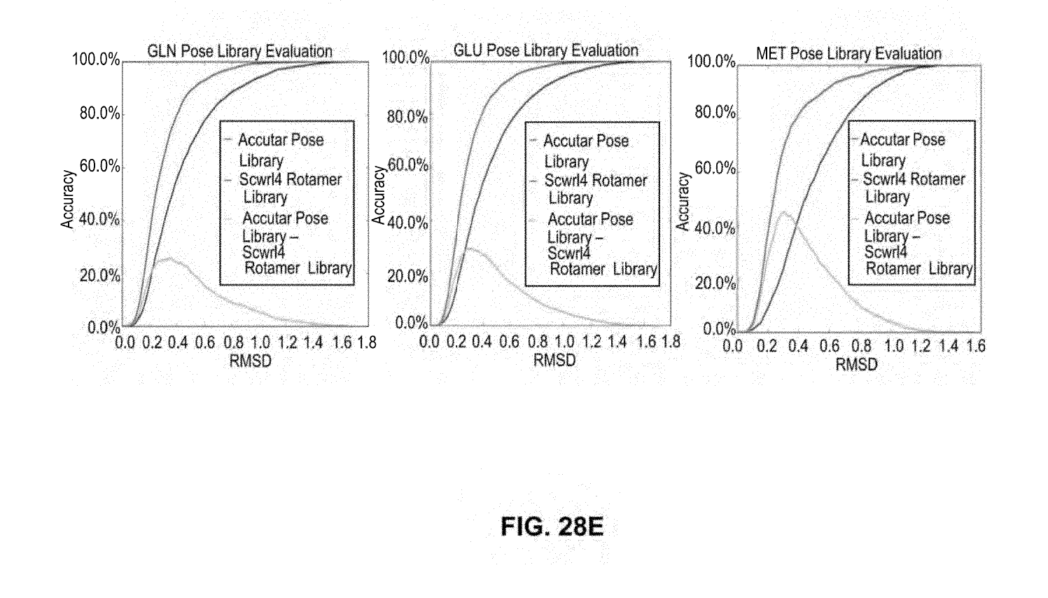

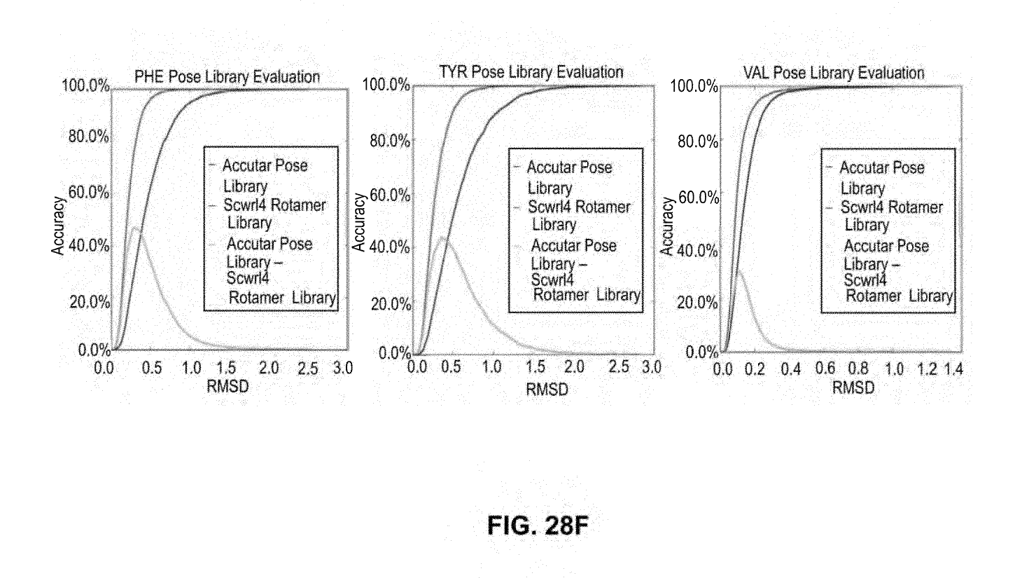

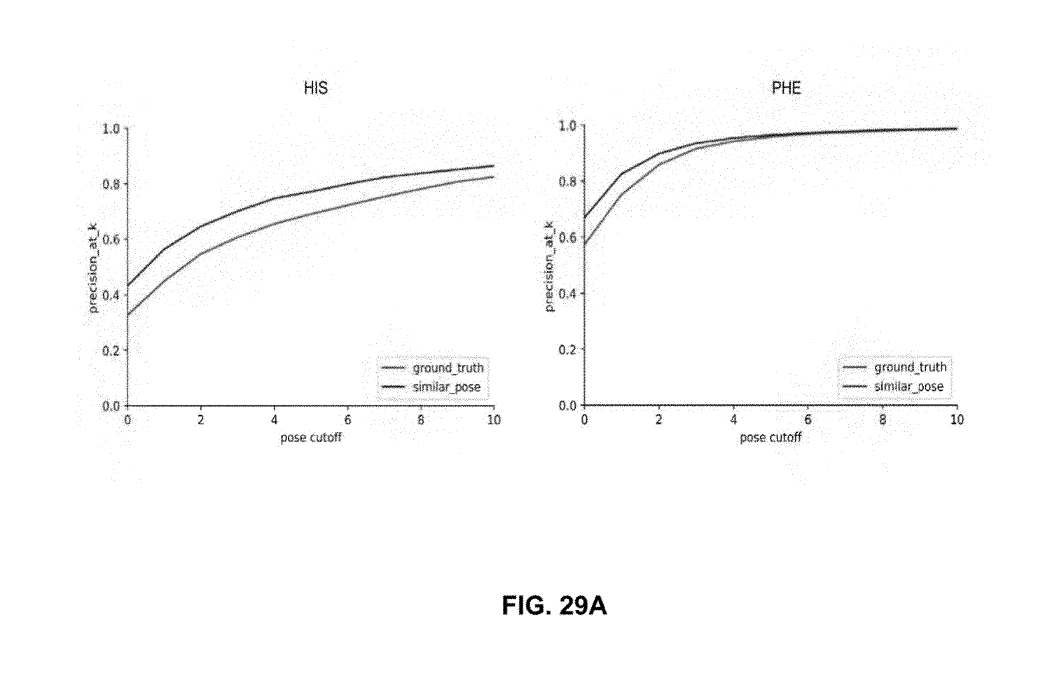

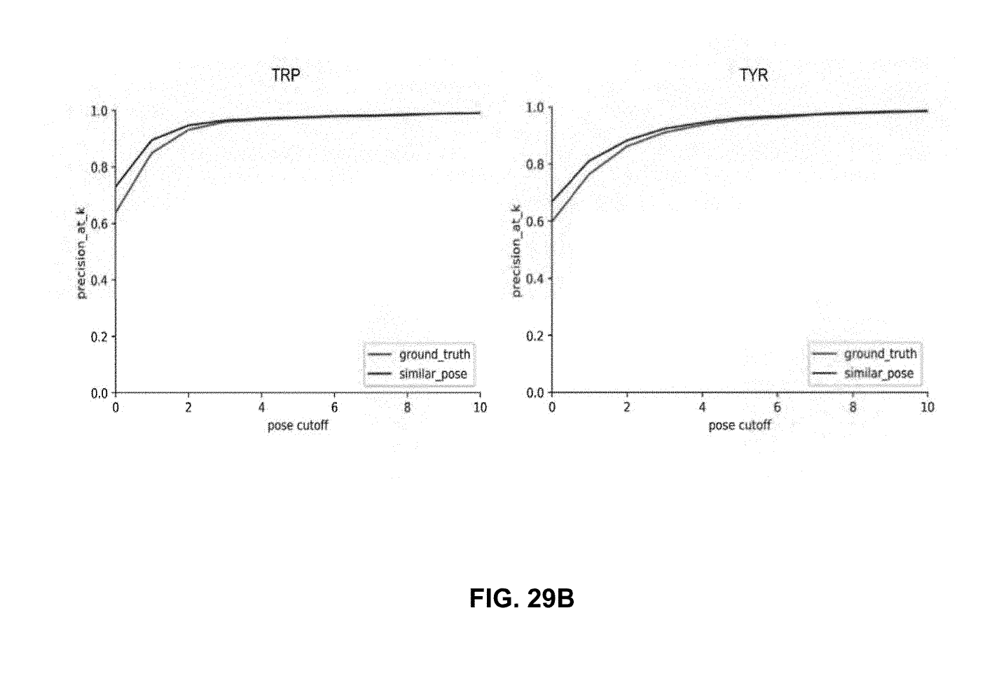

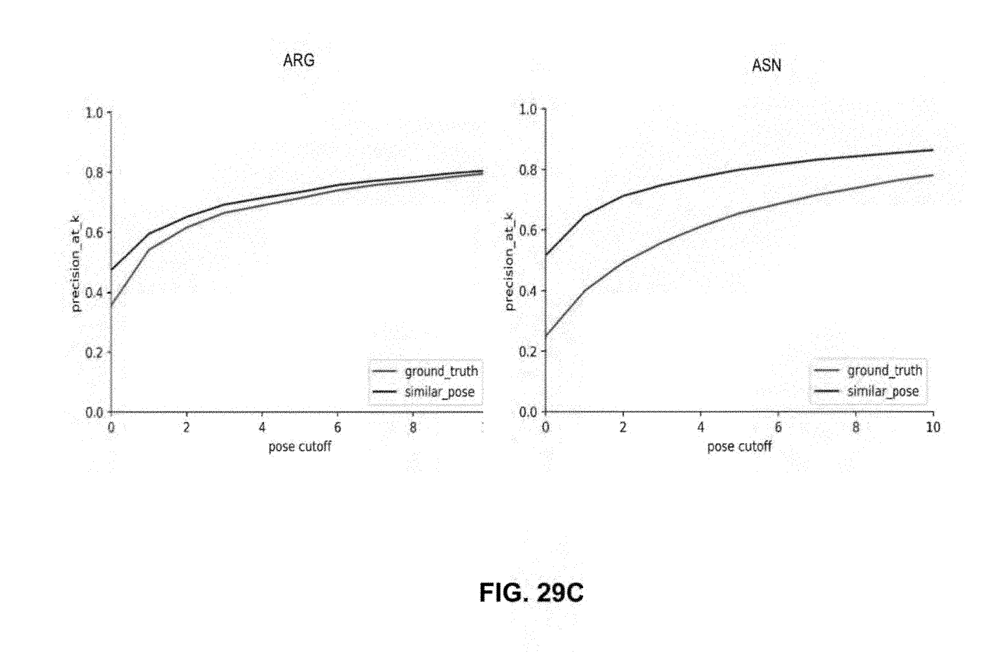

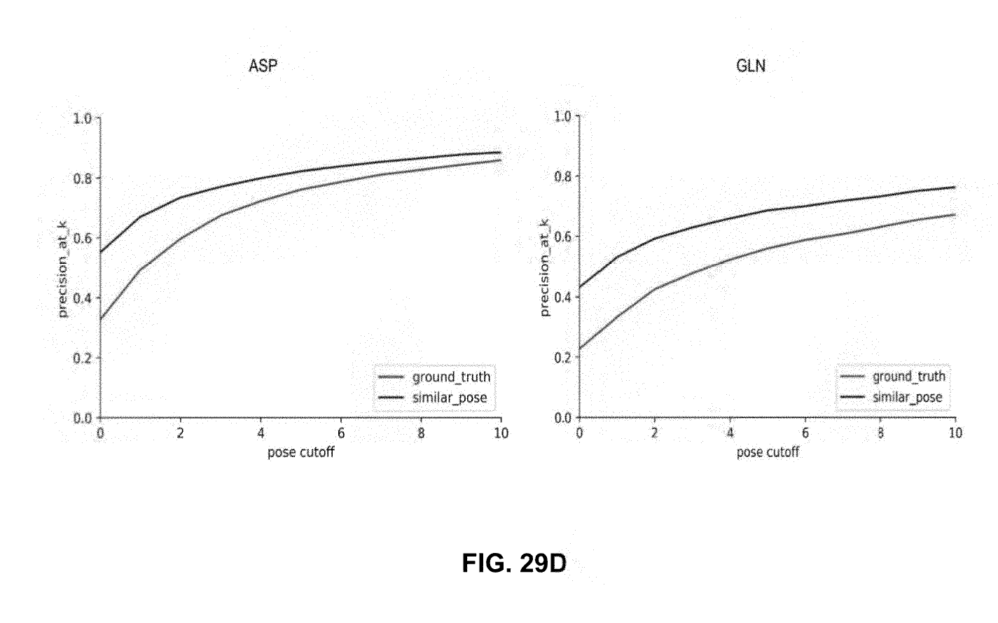

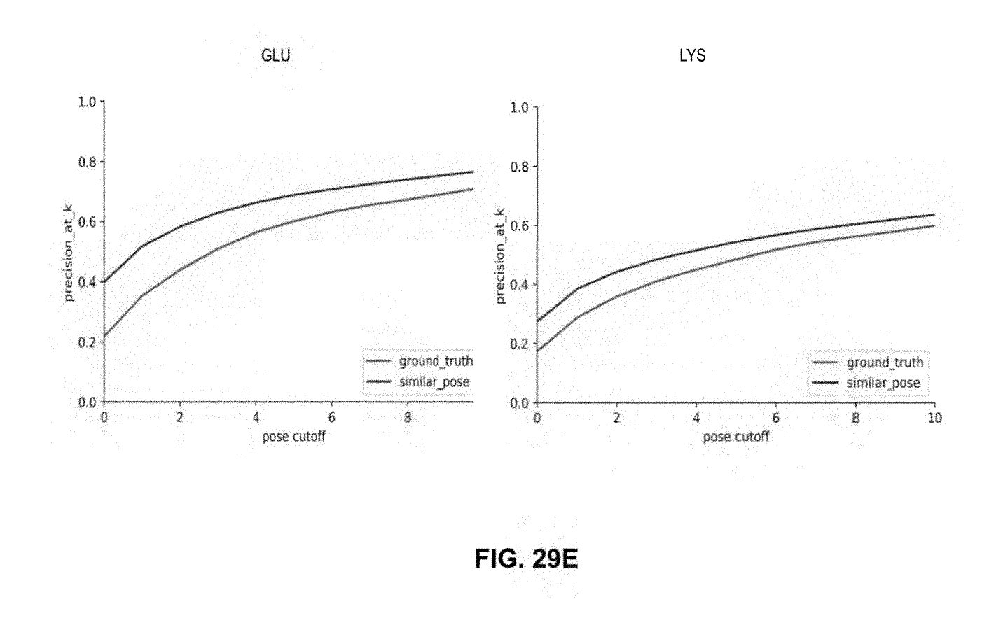

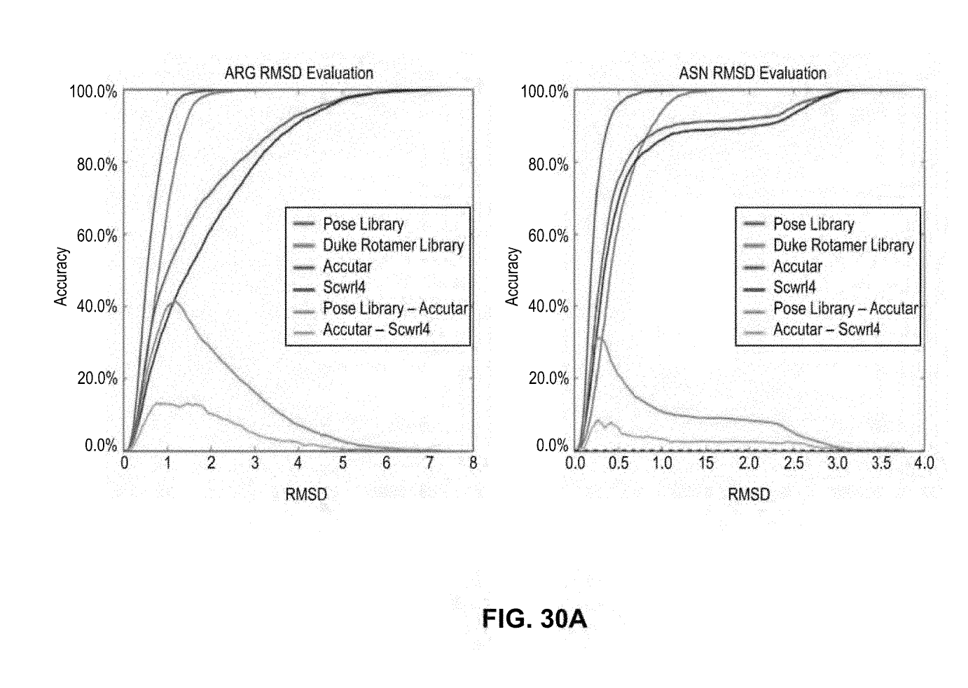

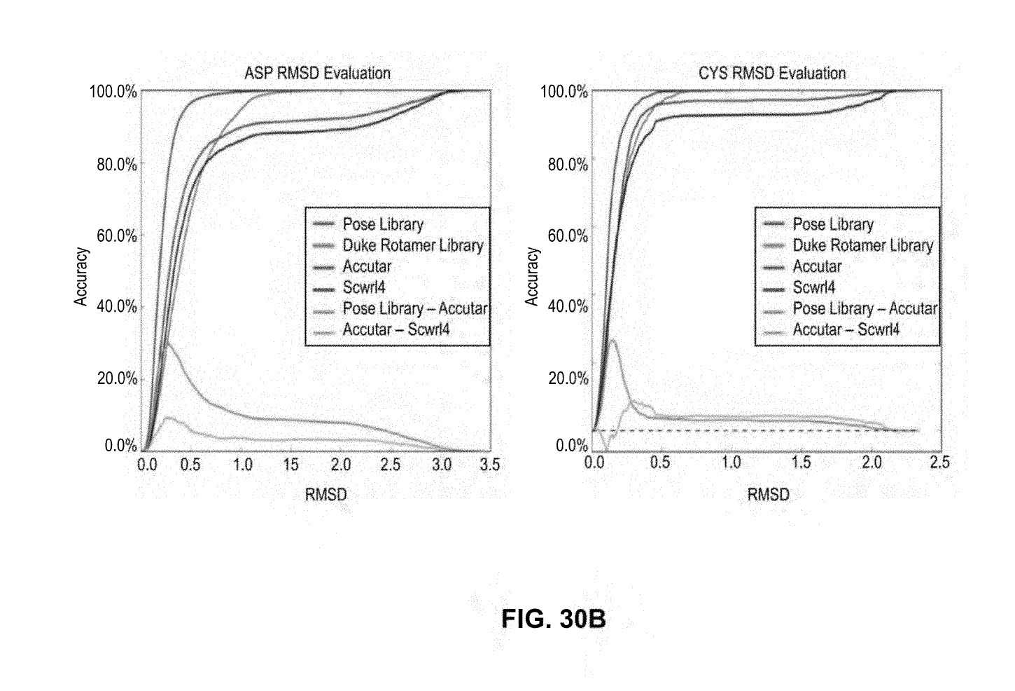

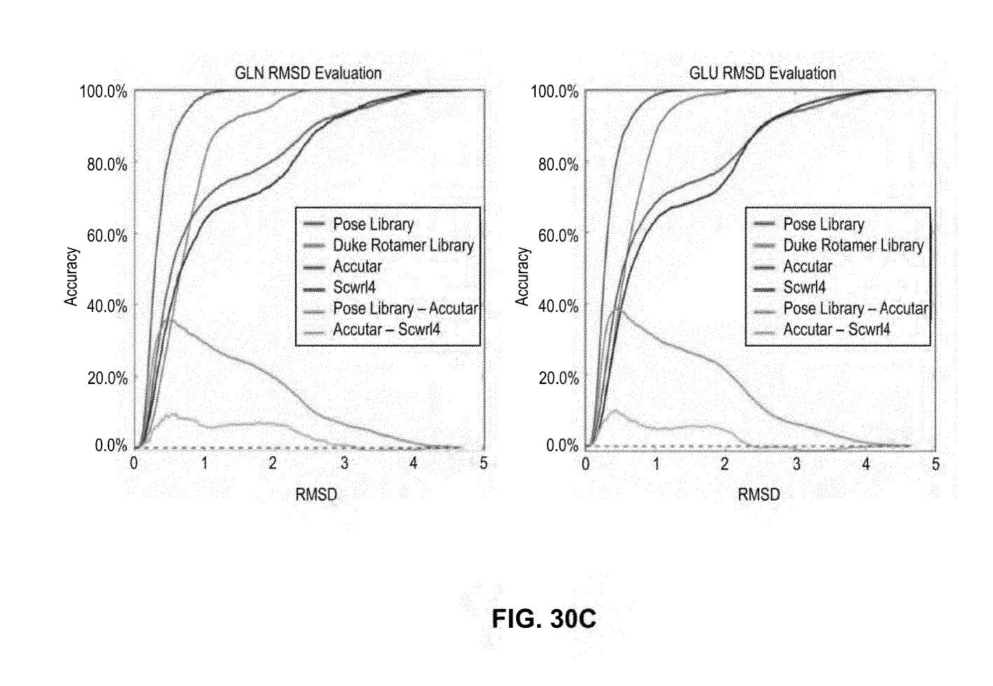

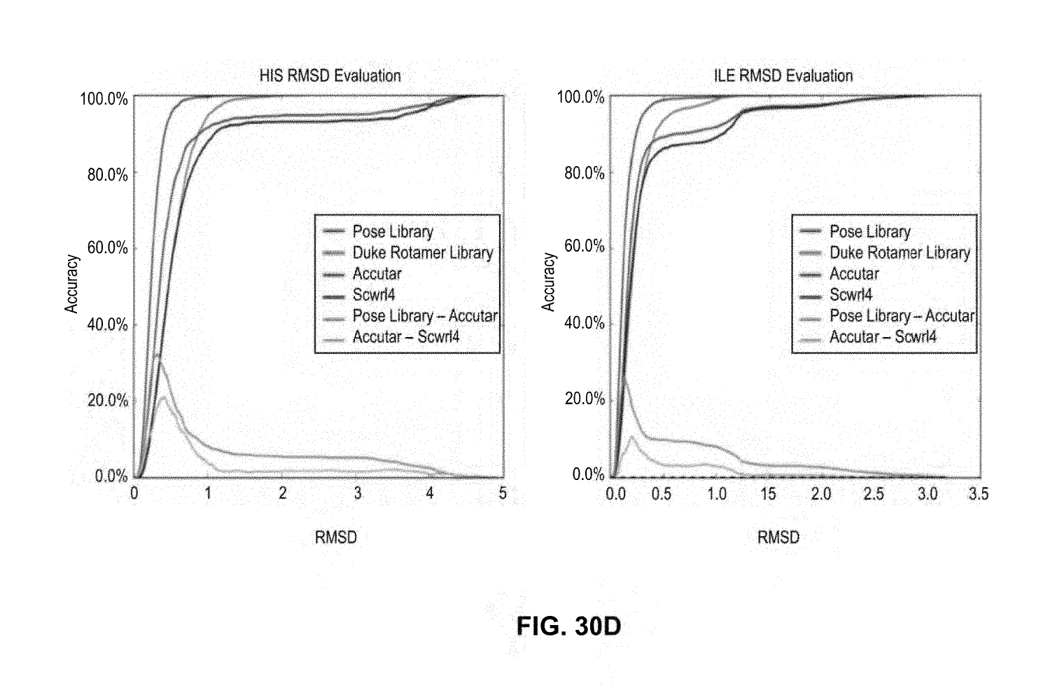

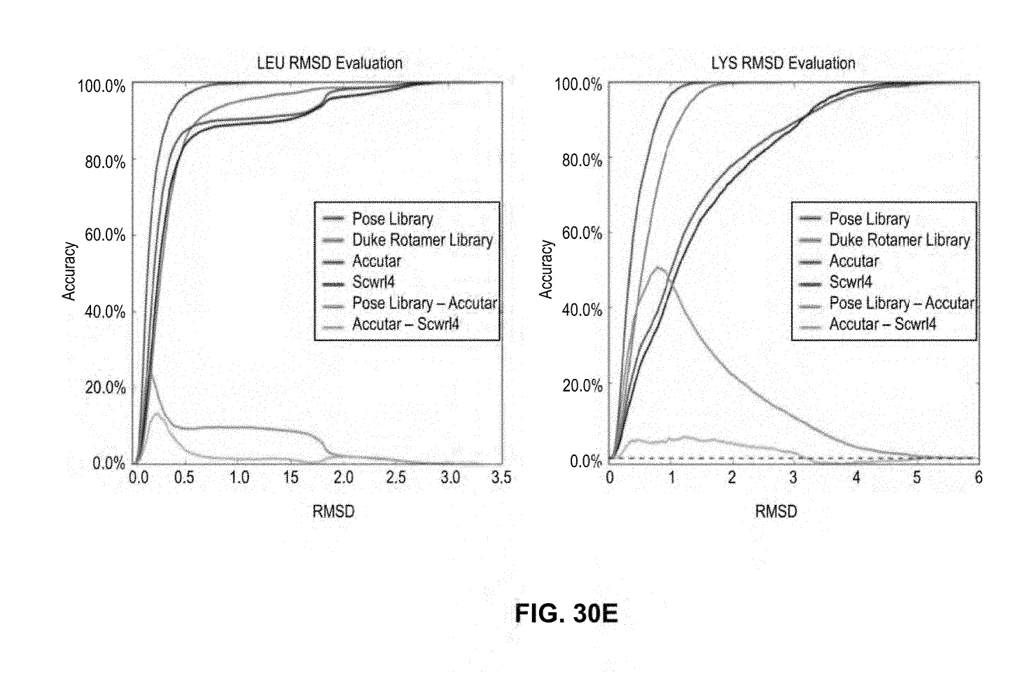

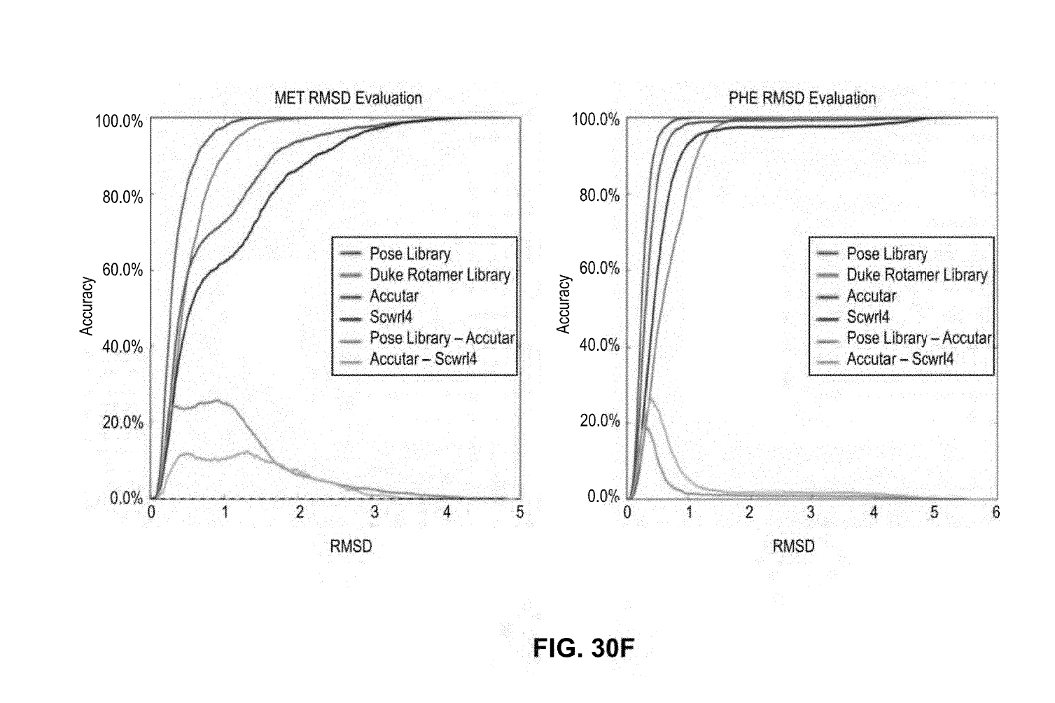

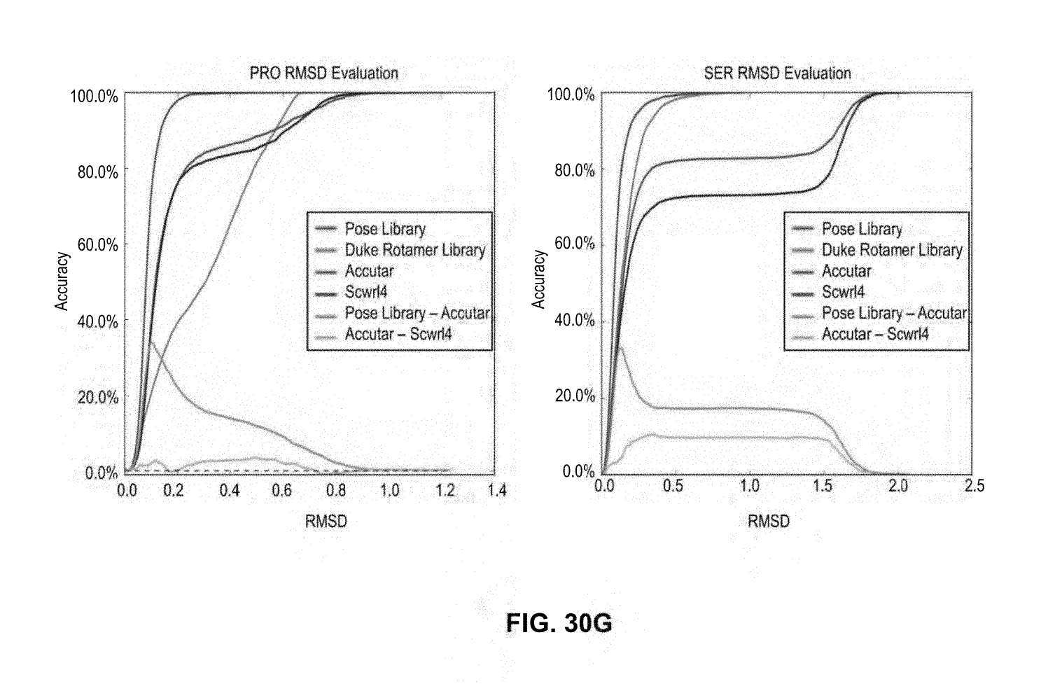

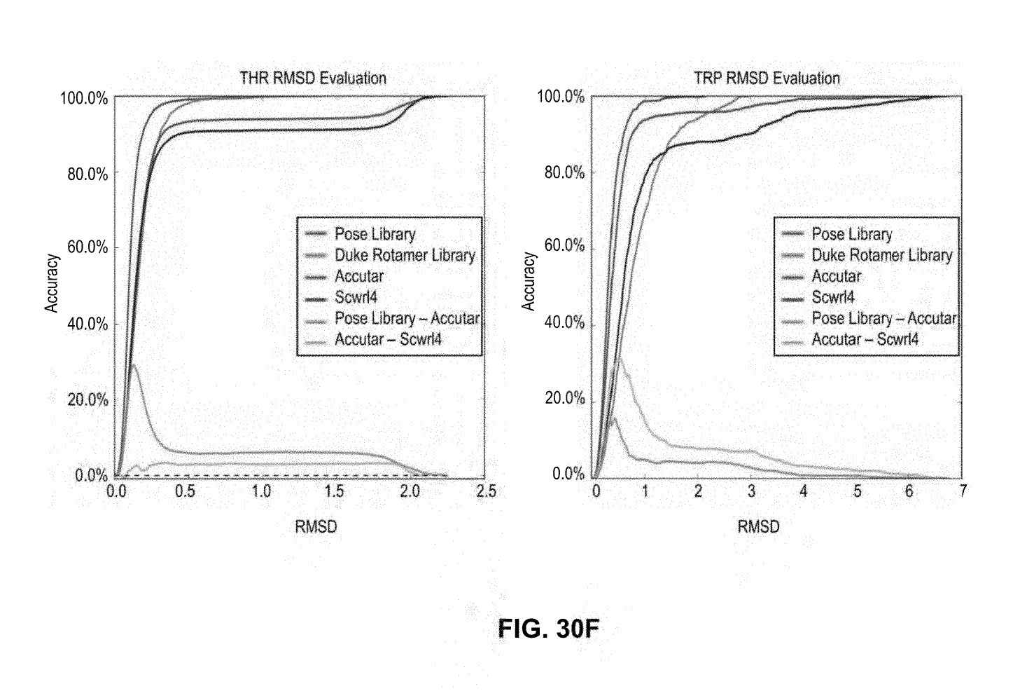

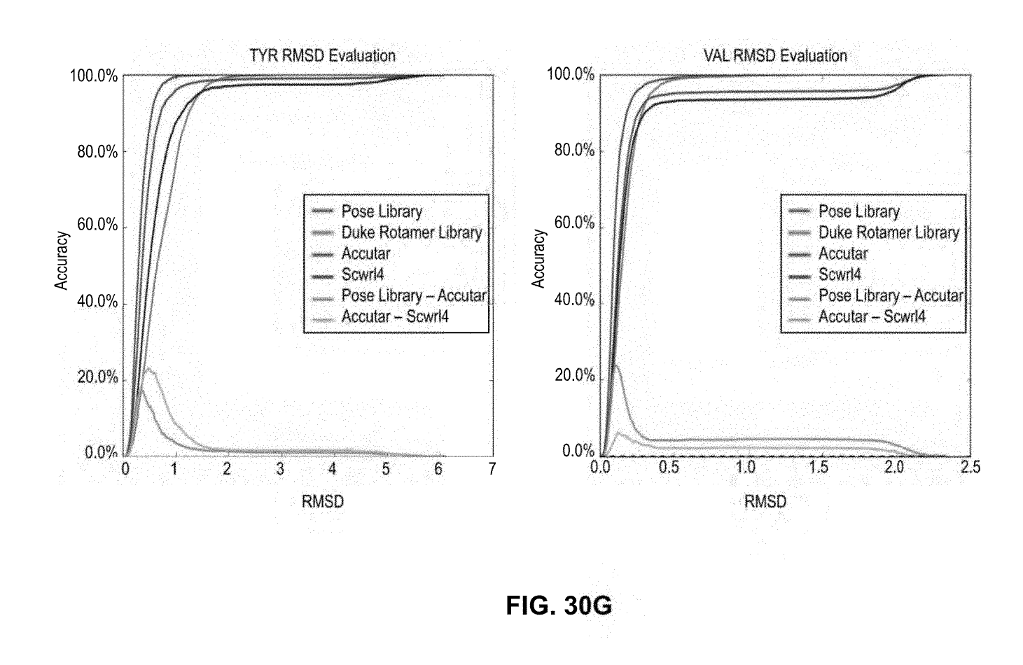

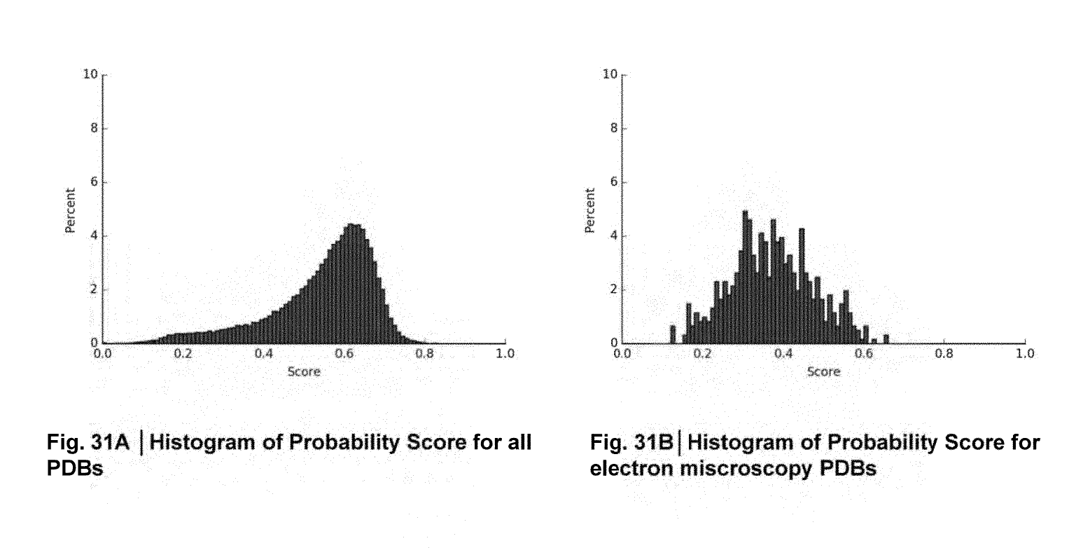

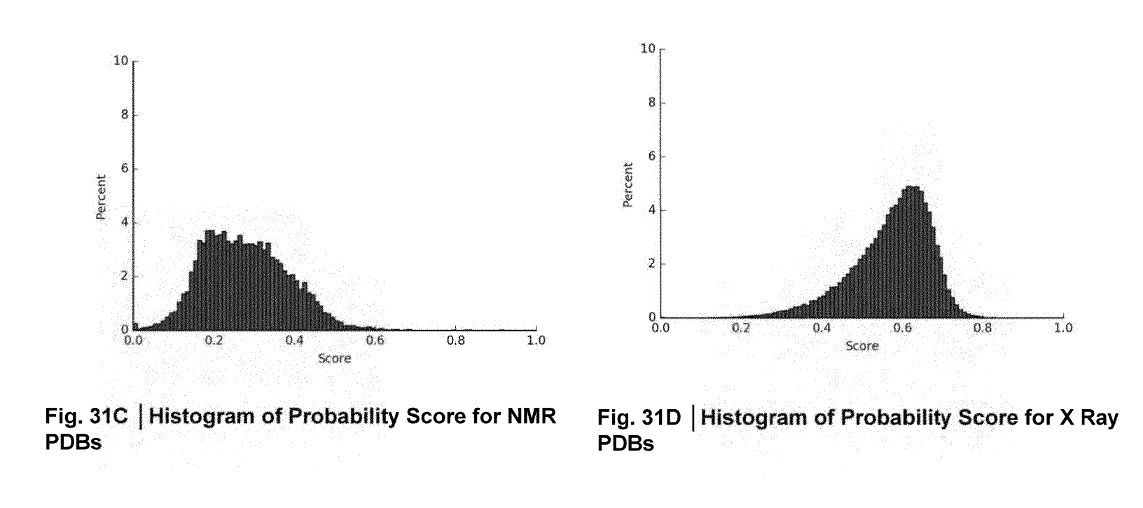

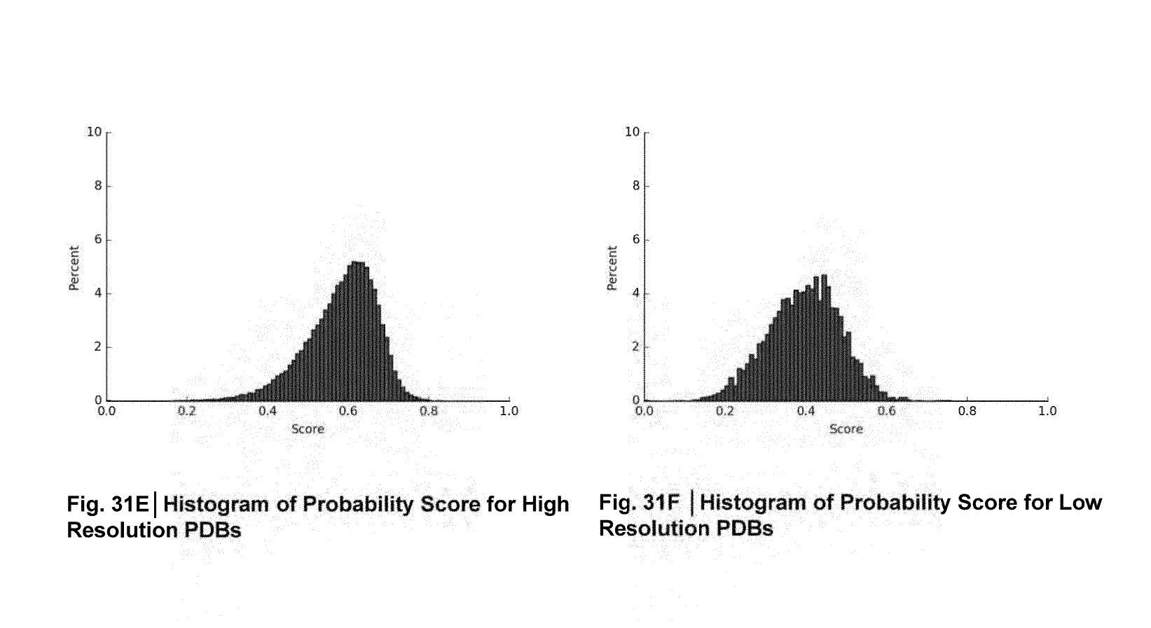

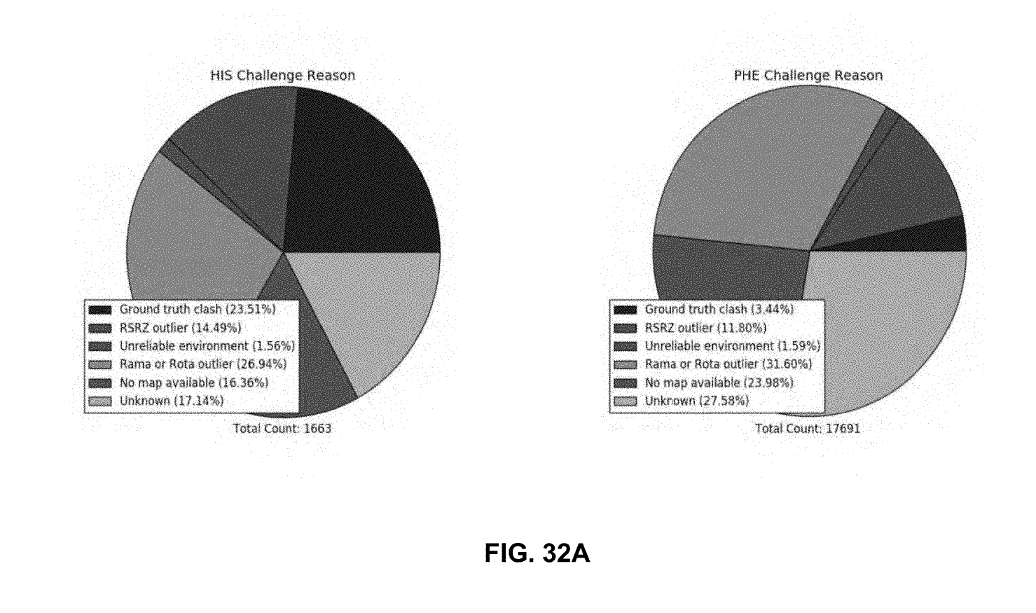

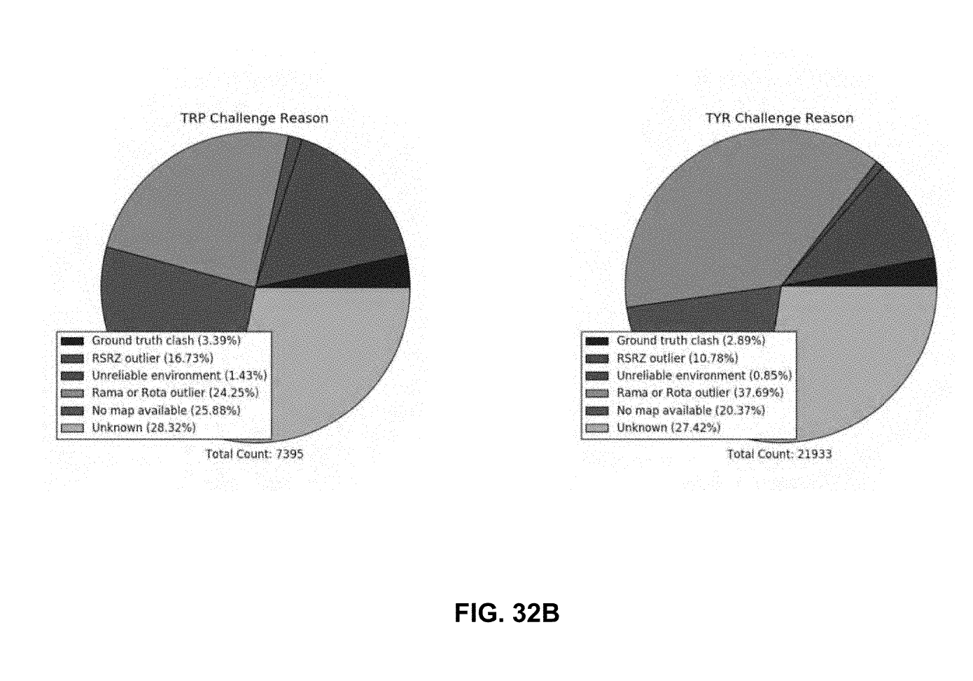

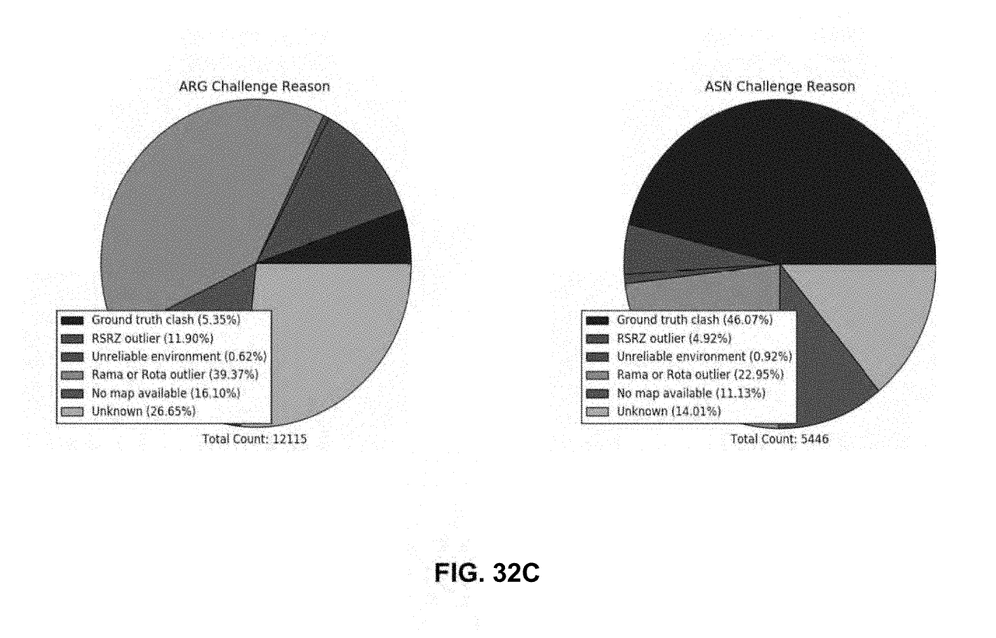

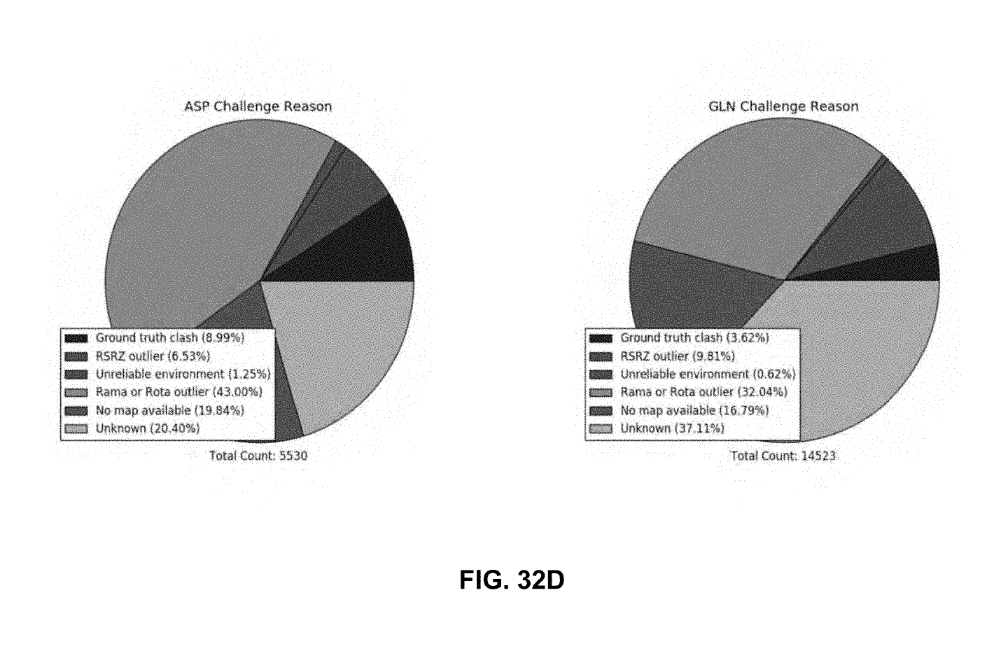

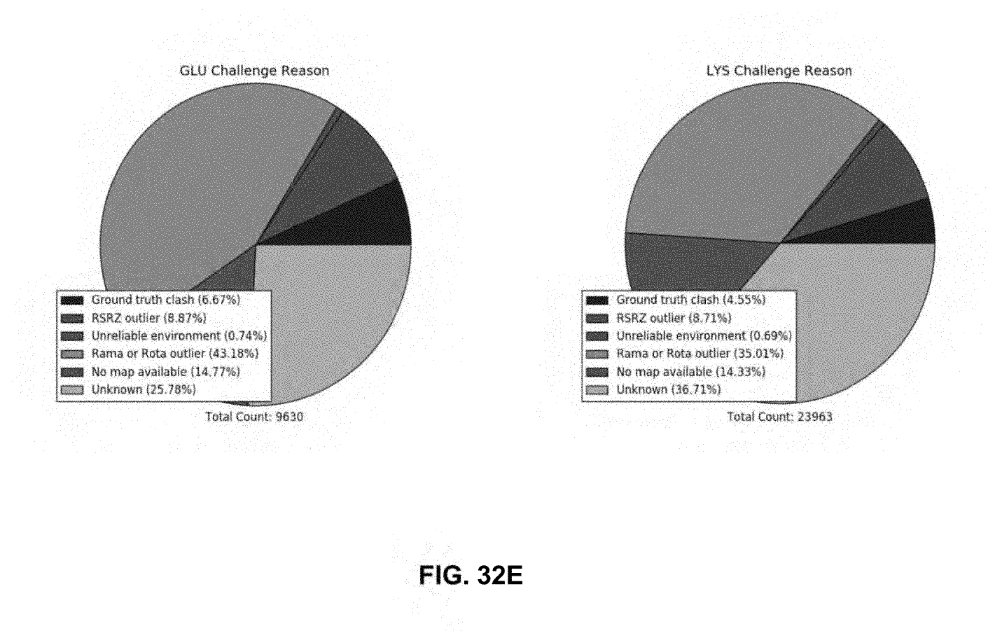

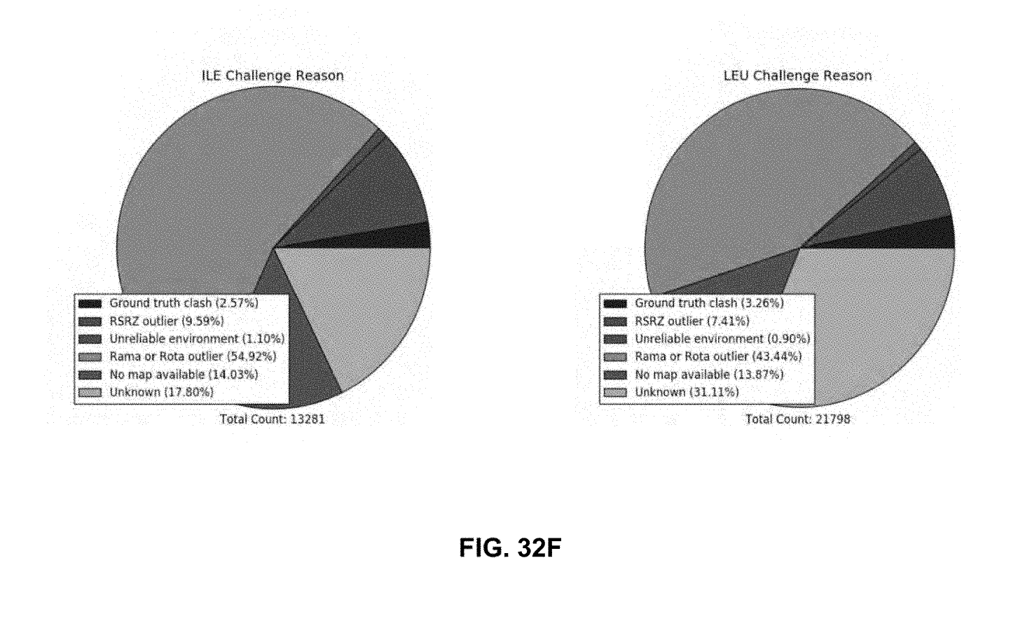

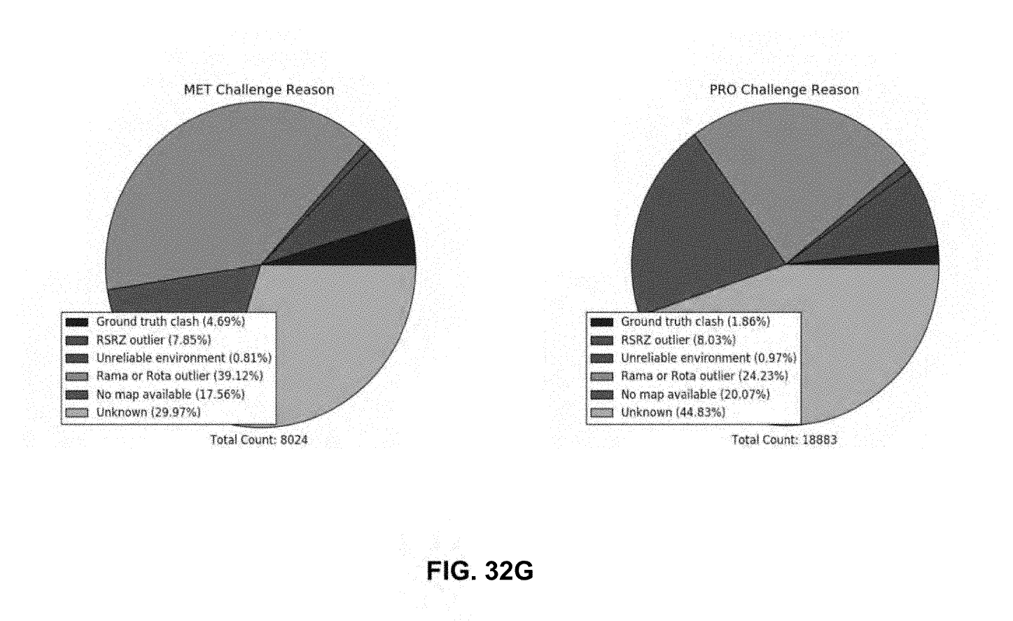

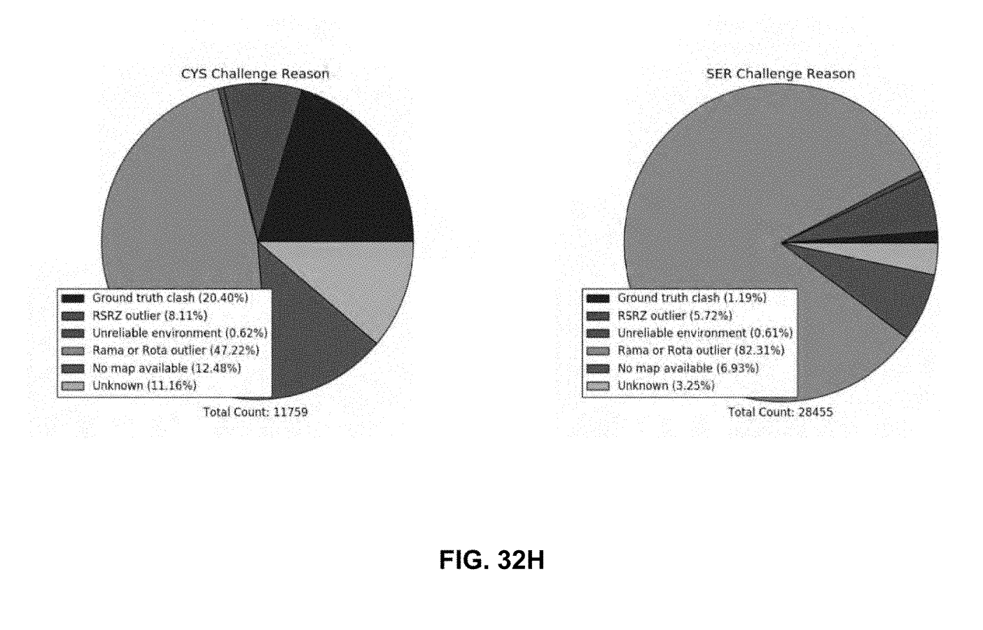

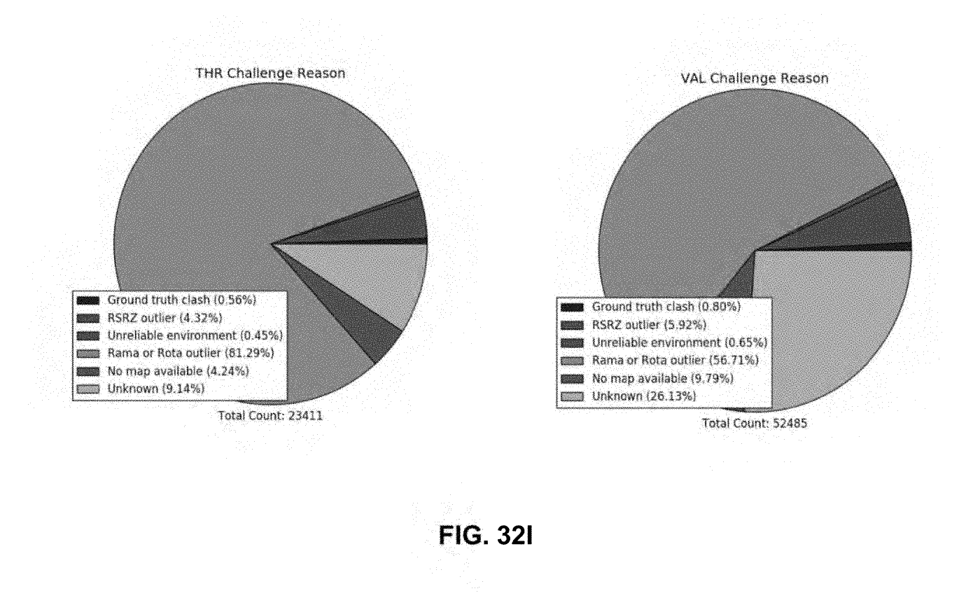

As shown in FIG. 23, across all amino acid types, the disclosed rotamer Library (colored red in FIG. 23) covered more conformational space than the current standard backbone-dependent rotamer library, the SCWRL4 Rotamer Library by ˜20% (colored blue in FIG. 23, left panel) and outperforms the backbone-independent Duke Rotamer Library (colored blue in FIG. 23, right panel) by ˜25%. The RMSD values measuring the deviation from genuine structure for each amino acid of the rotamer library versus those derived from SCWRL4 rotamer library are provided in FIGS. 28A-28F. FIGS. 28A-28F are schematic diagrams showing CDF plot for each amino acid type in the disclosed rotamer library (shown in red), SCWRL4 rotamer library (shown in blue), and their difference (shown in green).

1.3.2 Construction of Neural Network Architecture

To model amino acid side chain information with 3D images, side chains were encoded by 23 atom types which can be considered as 23-color channels for the image. The detailed parametrization procedure is explained in the 1.4 Methods section. Through this parametrization procedure, the side chain conformation prediction problem could be considered as an image processing problem for which the CNN method has been successfully integrated previously (see. e.g., Qi, C. R. et al. Volumetric and Multi-View CNNs for Object Classification on 3D Data, <http://www.cv-foundation.org/openaccess/content_cvpr_2016/papers/Qi_Volumetric_and_M ulti-View_CVPR_2016_paper.pdf> (2016); Ji, S. X., W, Yang, M. & Yu, K. 3D convolutional neural networks for human action recognition (2010)).

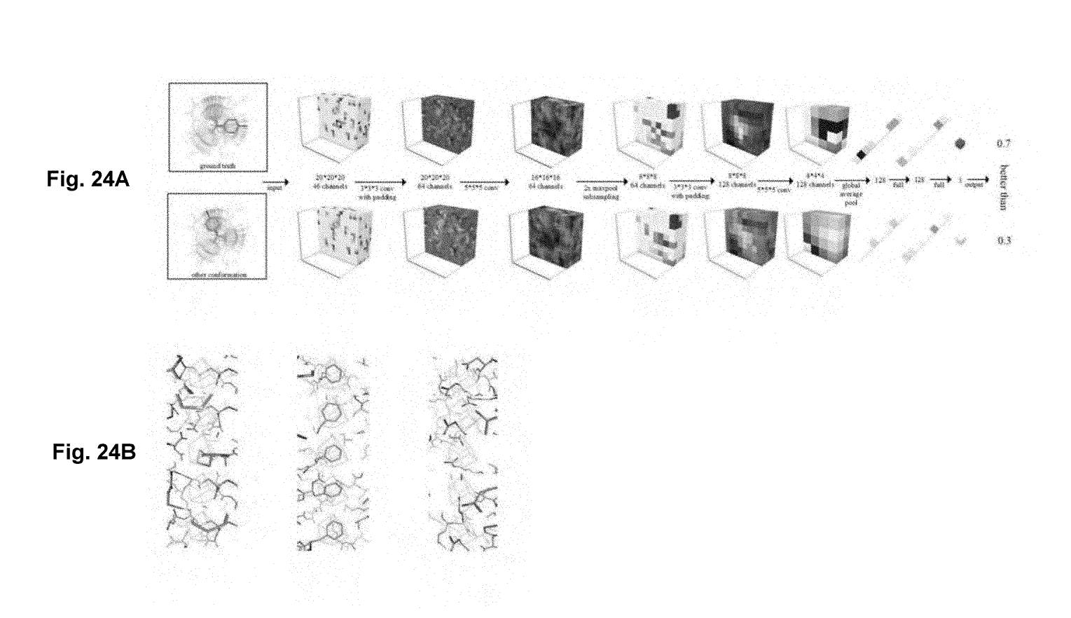

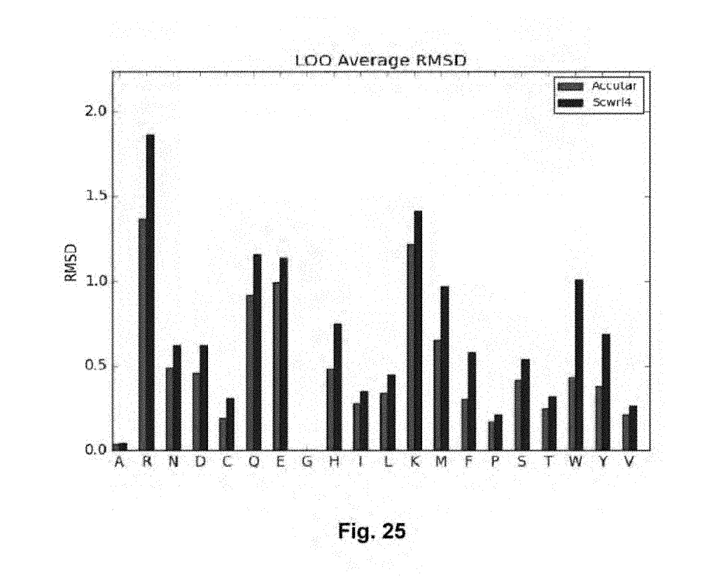

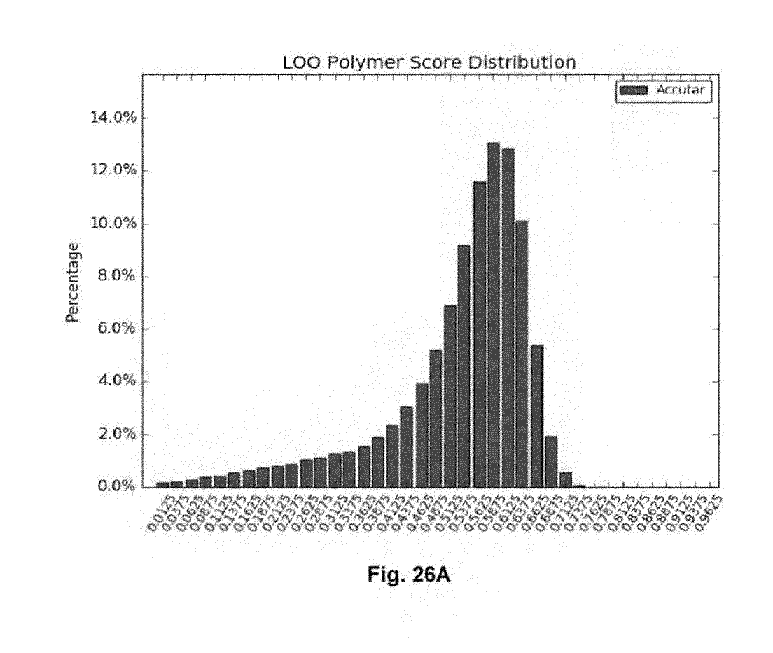

In the disclosed embodiment, a 3D CNN architecture implemented with the Microsoft Cognitive Toolkit (CNTK) (see. e.g., Zeiler, M. D. & Fergus, R. in Computer Vision—ECCV 2014: 13th European Conference, Zurich, Switzerland, Sep. 6-12, 2014, Proceedings, Part I (eds David Fleet, Tomas Pajdla, Bernt Schiele, & Tinne Tuytelaars) 818-833 (Springer International Publishing, 2014)) is used to model the protein side chain conformation from its environment. FIGS. 25a and 25b are schematic diagrams showing construction of a convolutional neural network architecture for side chain conformation prediction. In FIG. 24a, data flow is shown from left to right: a pose of an amino acid (for example, pose #4 of tyrosine) is represented as a grid of 20*20*20 voxels. In order to convert the concrete amino acid pose to an input feature map to CNN, each amino acid pose and related environment were encoded by 23 atom type and represented as a smoothly interpolated sphere in the grid using the soft-bin fill algorithm, as shown in FIG. 31. Atoms of the side chain conformation to be predicted and of its environment were extracted into separated channels to be able to distinguish them. As a result, a total of 46 input channels were used (layer 0). The neural network used a voxel grid of the quantized amino acid environment and approximates a piecewise ranking score. The 20*20*20 voxel was fed through a 3*3*3 convolutional layer and a 5*5*5 convolutional layer, with a 2*2*2 max pool subsampling. Then another 3*3*3 and 5*5*5 convolutional layers were applied. Finally, a global average pooling layer was used to aggregate information from the entire grid and several fully connected layers were applied subsequently to project the output to a scalar score. ReLU non-linearity was used throughout the process except the output layer, where a sigmoid non-linearity was used to map the output to probability of range (0, 1).

This network accepts graphic input of an amino acid adopting certain pose with its environment, and it outputs a probability score of different potential poses. Every input amino acid was aligned by their Cα, amine and carboxyl group so that the amino acid to be predicted and its neighboring environment were firstly quantized into a 3D voxel grid (see. e.g., Maturana, D. & Scherer, S. in IEEE/RSJ International Conference on Intelligent Robots and Systems, September, 2015) representing the position and interaction of all related atoms. The voxel grid was then fed through several 3D convolutional and pooling layers to predict a feasibility score for each conformation. The modeled feasibility score was trained over a large protein structure database so that different conformations could be compared to predict the most favorable conformation of an amino acid given its environment.

To understand how the CNN model represents and learns useful atomic interaction features, the trained CNN model is analyzed by visualizing its convolutional layer filters (see. e.g., Zeiler, M. D. & Fergus, R. in Computer Vision—ECCV 2014: 13th European Conference, Zurich, Switzerland, Sep. 6-12, 2014, Proceedings, Part I (eds David Fleet, Tomas Pajdla, Bernt Schiele, & Tinne Tuytelaars) 818-833 (Springer International Publishing, 2014)). The input patches, which maximally activate a filter in the first convolution layer, are shown in FIG. 24b. FIG. 24b shows signature chemical patches (disulfide bonds, benzene and ion pairs), which maximally activated a filter in the first convolution layer. Each group of five patches in one column in the figure corresponds to a single filter in the first convolution layer. The red cube designates the input region. As can be seen, the neural network was able to capture many interesting and useful features, such as disulfide bonds (left panel of FIG. 24b), benzene bonds (middle panel of FIG. 24b), and electrostatic interaction (right panel of FIG. 24b). The fact that the CNN model learned these useful chemical moieties without any prior chemistry domain knowledge partially explains how the CNN model learns the concrete image models of amino acid side chains.

1.3.3 Internal Ranking Model Performance of CNN Architecture

The CNN architecture centered on a ranking model-based training algorithm (FIG. 24b) (the detailed ranking algorithm is provided in 1.4 Methods), because, for every querying residue with an amino acid type specified, the CNN needed to rank the likelihood of all possible poses in that specific position. The internal ranking model performance with respect to different amino acid types are provided in FIG. 29. In FIG. 29, the ranking model used in CNN training algorithm was evaluated by plotting the accuracy at the kth rank. The evaluation metric is similar to precision@k (see, e.g., Manning, C. D. R., P & Schütze, H. Chapter 8: Evaluation in information retrieval <http://nlp.stanford.edu/IR-book/pdf/08eval.pdf> (2009)). For every amino acid in the test set, all poses of its kind were retrieved, and then their predicted scores were compared with the predicted score for ground truth. The top K ranked poses were used for inspection. In the “ground truth” evaluation scheme, if the ground truth occurs in the top K ranked poses, the scoring for this amino acid was considered correct. In the “similar pose” evaluation scheme, if any poses with an RMSD with ground truth less than a predefined small value and is within the top K value, the scoring for this amino acid was considered correct. The accuracy for the entire test set was then defined as the average correctness rate for each amino acid type. FIG. 29 shows the ranking model had a precision rate of ˜60% for top picks for most amino acid types including aromatic residues, whereas the performances were relatively modest in charged amino acids. More specifically, the precision rates occurred in the range of 30-40% for top picks for Lys, Glu and Gin which suggested there is room to improve on this in the future.

1.3.4 Leave-One-Out (LOO) Side Chain Prediction Test to Evaluate the Predictor

Traditionally, the performances of different protein side chain conformation prediction programs are hard to compare due to different judgement criteria or different testing sets used. In order to evaluate the disclosed CNN method head-to-head against the current popular SCWRL4 method, a more unbiased leave-one-out (LOO) test is adopted, using the same 379 PDB testing datasets from the original SCWRL4 paper. To avoid using evaluation data in training procedure, the structures with a sequence similarity of 70% of any testing structures were excluded from CNN training sets. Using this approach the two methods were allowed to run a sequential prediction for every individual amino acid along the protein sequence with all other residues conformations given for each test. After the LOO test was allowed to run through all the structures in the testing set and instead of using the Chi-angle criteria used previously, a more unbiased RMSD criteria is used to evaluate the deviations between the predicted model and experimentally determined model (set as ground truth), which allows the comparison of the relative performance of the SCWRL4 method and the disclosed CNN method. Overall, the disclosed CNN method outperforms the SCWRL4 method in all 20 amino acid subtypes in RMSD values (FIG. 25). In FIG. 25, the prediction accuracy for each amino acid type by different methods were compared by RMSD criteria. All residues from the test set constituting 379 pdbs were allowed to run a LOO test (see main text). The RMSD for each residue type averaged over all residues are shown in the figure with the disclosed method shown in red and SWCRL4 method shown in blue. Using the RMSD value of 0.5 Å as a cut-off (i.e. by only comparing the accuracy rate of predicted side chain conformation deviates from the observed side chain conformation by a per-atom distance of within 0.5 Å RMSD range), the CNN method on average showed ˜25% higher accuracy rate than that of SCWRL4 method. More striking performance improvements of ˜40% were observed in aromatic residues and long side-chain residues (FIGS. 30A-30G). As will be appreciated by those skilled in the art, performance improvement of this scale is unprecedented since the side chain prediction problem first surfaced 20 years ago.

1.3.6 LOO-Score as a Structure Model Quality Indicator

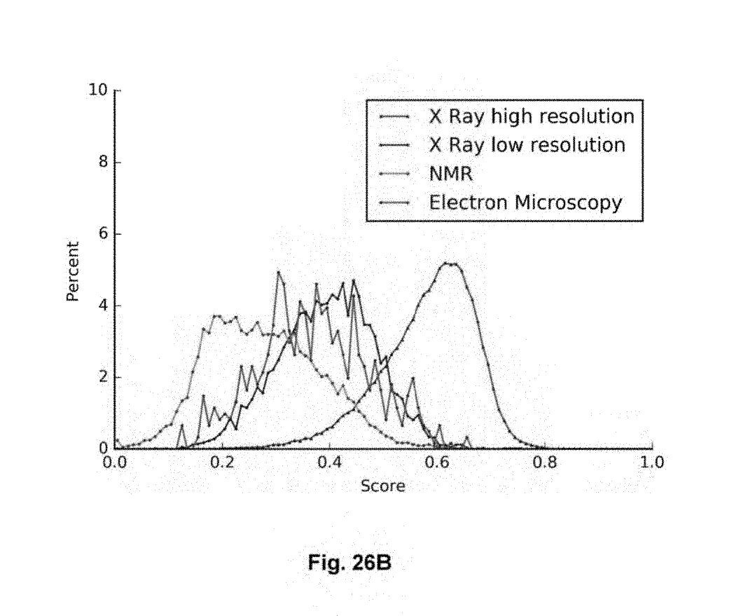

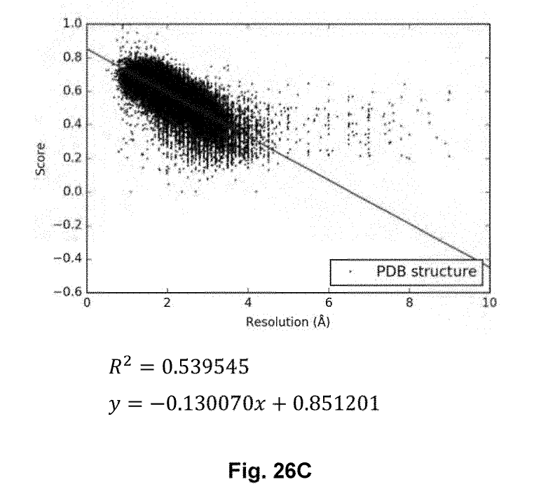

The present disclosure also aims to determine whether the CNN-based amino acid side chain predictor has other applications in structural biology. First, distribution of average LOO score of all PDB structures is examined. The LOO score assumed a unimodal distribution skewed to the right (FIG. 26A). In FIG. 26A, pan-PDB side-chain LOO scores could be used to judge model quality. This figure shows the probability distribution function plot of pan-PDB side-chain LOO scores. To the far-left end of the x-axis, the structures with poor LOO scores are enriched with NMR structure models; electron microscopy (EM) and Cryo-EM models occur next in the higher LOO score region, followed by X-ray structure models with higher resolution more or less localized to the right side of the figure (FIG. 268B). FIG. 26B shows probability distribution of LOO scores for all PDBs and three subsets. This figure shows the probability distribution of LOO scores categorized by different model types with high resolution (<3 A) x-ray model plot in green and low resolution x-ray model plot in blue, EM model plot in cyan and NMR model plot in red The LOO score has an excellent linear relationship with resolution of structure models with R-square of ˜0.5 for sample size of ˜50,000 models (FIG. 26C). FIG. 26C shows scatter plot of X Ray PDB Resolution and Probability distribution of its LOO score. This figure shows a scatter plot of atomic Resolution of X Ray structures and their associated LOO score with an observed Spearman score of 0.75. The present disclosure also aims to determine whether the LOO scores for individual side chains deposited in PDB database could be used as a side chain model quality metric. At present, side chain model quality can only be verified by Ramachandra statistics and by checking the deviations between the model and electron density map in real space. Given the observed strong correlation between the model LOO score and model quality in addition to its probability distribution, the present disclosure also aims to determine whether the LOO score of an individual side chain has predicative value for the model quality of individual side chain. As such, individual side chain LOO scores of all PDB structures using deposited conformations are calculated.

Ranked by how much the observed LOO score deviates from mean value of the LOO score calculated from CNN training process, thousands of LOO score outliers can be picked up from published structures (FIGS. 27A and 27B). (A detailed list and respective maps for top 1000 outliers for each amino acid type are provided in the Supplementary data section).

FIG. 27A shows a pie chart of side chain LOO score outliers of all PDB structures. Statistics based on amino acids whose unnormalized scores falls behind 3 sigmas of average score of its amino kind, are shown in the pie chart. The outliers were plotted by following six classes: ground truth dashes (blue), RSRZ outliers(green), unreliable environment (red), Ramachandran/rotamer outlier (cyan) and no map available (purple), unknown (yellow). The calculation of RSRZ, Ramachandran and rotamer outliers uses the same protocol as RCSB X-ray validation process (see, e.g., Worldwide PDB protein data bank. <http://wwpdb.org/validation/legacy/XrayValidationReportHelp>; ones, T. A., Zou, J.-Y., Cowan, S. W. & Kjeldgaard, M. Improved methods for building protein models in electron density maps and the location of errors in these models. Acta Cryst A47, 110-119 (1991); Chen, V. B. et al. MolProbity: all-atom structure validation for macromolecular crystallography. Acta Cryst D66, 12-21 (2010)). The following description outlines the keys used in FIG. 27A:
Ground truth clash: At least one atom in the amino acid has a too close contact with another atom. The close contact may occur inside the amino acid, between this amino and another amino, or between this amino and a hetero. Both residue and backbone atoms in this amino is checked for clash.
RSRZ outlier: RSRZ is a normalization of real-space R-value (RSR) which measures the quality of fit between the amino acid and the data in real space. A residue is considered an RSRZ outlier if its RSRZ value is greater than 2.
Unreliable environment an excessive number (>=5) of clashes have been detected near the amino acid (<=10 A).
Rama or Rota outlier: This amino acid is considered a Ramachandran plot outlier (for backbone) or a rotamer outlier (for residue). The outlier is assessed as with MolProbity. This type of outlier indicates the amino acid having unusual torsion angles, not similar to any preferred combinations.
No map available: There is no specific errors detected with this amino acid, except the quality of fit between the amino acid and the density map cannot be checked due to the lack of density map data.
Unknown: There are no specific errors detected with this amino acid.

FIG. 27B shows examples of the disclosed side chain predictor can predict side chain conformational error of published high resolution crystal structure (examples)

By systematically examining the top 1000 outliers for each amino acid type, ˜50% of the outliers could be confirmed to fall into the following three categories: 1) steric clashes which account for ˜4% of outliers picked up, (shown in green in FIG. 27A), 2) residues with mis-assigned conformers as independently confirmed by RSRZ outlier analysis (see, e.g., Kleywegt. G. J. et al. The Uppsala Electron-Density Server. Acta Crystallographica Section D 60, 2240-2249, doi:doi:10.1107/S0907444904013253 (2004); Jones, T. A., Zou, J. Y., Cowan, S. W. & Kjeldgaard, M. Improved methods for building protein models in electron density maps and the location of errors in these models. Acta crystallographica. Section A, Foundations of crystallography 47 (Pt 2), 110-119 (1991)) which accounted for ˜8% of the outliers (shown in green), and 3) mis-assigned conformers not identified by RSRZ outliers, 48.31%, (shown in cyan). Steric dash errors could be easily verified by checking the model itself and the models determined as Ramachandran or rotamer outlier could be hard to judge unambiguously. The third type of error (i.e. error associated with mis-assigned conformers) is therefore further explored, with possible mis-assignment of side chain conformations; the representative outliers for three amino acid types, with predicted models shown in brown and deposited models shown in green (FIG. 27B). The 2Fo-Fc maps contoured at 1.0 sigma are shown in blue and the Fo-Fc maps contoured at 3.0 sigma shown in red/green. In all cases, the predicted side chain poses pointed to the positive density region whereas original poses deposited in the database were in the negative electron density area.

The present disclosure demonstrates for the first time applying deep learning method to accurately predict amino acid side conformation. The “LOO” statistics described here allows the disclosed method to be systematically compared with current standard method SCWRL4 in large scale. In this large-scale test, the disclosed CNN platform can improve the prediction accuracy by over 25% across amino acid type. The capability of identifying conformational outliers deposited in PDB without supplying structure factors warrants its potential applications in multiple fields from structural model validation, structural model auto-building in crystallography & Cryo-EM to side-chain flexible mode small molecule docking.

### 1.4 Methods

1.4.1 Atom Type

Atom type is a unique index assigned to each atom in a polymer, including both atoms of amino acids and hetero atoms. The mapping table between atoms in a polymer and the atom types is provided in Table 6. In general, atoms of different elements will have different atom type indices, while atoms of the same element may also have different atom type indices if these atoms are chemically different or in a different environment. Atom types allow abstraction of atoms of different amino types.

TABLE 6
Atom Type Mapping table

| Index | Description | Count | Atoms |
|---|---|---|---|
| 0 | | | ATOM_TYPE_NON |
| 1 | Planar carbon | 29 | ALA C; ARG C; ASN C; ASN CG; ASP C; |
| | with one single | | ASP CG; CYS C; GLN C; GLN CD; GLU C; |
| | bond and two | | GLU CD; GLY C; HIS C; HIS CG; ILE C; |
| | double bonds | | LEU C; LYS C; MET C; PHE C; PHE CG; |
| | | | PRO C; SER C; THR C; TRP C; TRP CG; |
| | | | TYR C; TYR CG; TYR CZ; VAL C; |
| 2 | Tetrahedral | 23 | ALA CA; ARG CA; ASN CA; ASP CA; CYS |
| | carbon with three | | CA; GLN CA; GLU CA; HIS CA; ILE CA; ILE |
| | single bonds | | CB; LEU CA; LEU CG; LYS CA; MET CA; |
| | | | PHE CA; PRO CA; SER CA; THR CA; THR |
| | | | CB; TRP CA; TYR CA; VAL CA; VAL CB; |
| 3 | Carbon with only | 9 | ALA CB; ILE CD1; ILE CG2; LEU CD1; LEU |
| | one single bond | | CD2; MET CE; THR CG2: VAL CG1; VAL |
| | | | CG2; |
| 4 | Backbone | 20 | ALA N; ARG N; ARG NE; ASH N: ASP N; |
| | nitrogen atom | | CYS N; GLN N; GLU N; GLY N; HIS N; ILE |
| | with one double | | N: LEU N; LYS N; MET N; PHE N; SER N; |
| | bond and one | | THR N; TRP N; TYR N; VAL N; |
| | single bond | | |
| 5 | Oxygen atom with | 26 | ALA O; ARG O; ASN O; ASN OD1; ASP O; |
| | one double bond | | ASP OD1; ASP OD2; CYS O; GLN O; GLN |
| | | | OE1; GLU O; GLU OE1; GLU OE2; GLY O; |
| | | | HIS O; ILE O; LEU O; LYS O; MET O; PHE |
| | | | O; PRO O; SER O; THR O; TRP O; TYR O; |
| | | | VAL O; |
| 6 | Carbon with two | 27 | ARG CB; ARG CD; ARG CG; ASN CB; ASP |
| | single bonds | | CB; CYS CB; GLN CB; GLN CG; GLU CB; |
| | | | GLU CG; GLY CA; HIS CB; ILE CG1; LEU |
| | | | CB; LYS CB; LYS CD; LYS CE; LYS CG; |
| | | | MET CB; MET CG; PHE CB; PRO CB; PRO |
| | | | CD; PRO CG; SER CB; TRP CB; TYR CB; |
| 7 | Planar carbon | 3 | ARG CZ; TRP CD2; TRP CE2; |
| | with three double | | |
| | bonds | | |
| 8 | Nitrogen atom | 4 | ARG NH1; ARG NH2; ASN ND2; GLN NE2; |
| | with one double | | |
| | bond | | |
| 9 | Sulfur with one | 1 | CYS SG; |
| | single bond | | |
| 10 | Carbon with two | 16 | HIS CD2; HIS CE1; PHE CD1; PHE CD2; |
| | double bonds | | PHE CE1; PHE CE2; PHE CZ; TRP CD1; |
| | | | TRP CE3; TRP CH2; TRP CZ2; TRP CZ3; |
| | | | TYR CD1; TYR CD2; TYR CE1; TYR CE2; |
| 11 | Nitrogen with two | 3 | HIS ND1; HIS NE2; TRP NE1; |
| | double bonds | | |
| 12 | Nitrogen with one | 1 | LYS NZ; |
| | single bond | | |
| 13 | Sulfur with two | 1 | MET SD; |
| | single bonds | | |
| 14 | Nitrogen with | 1 | PRO N; |
| | three single | | |
| | bonds | | |
| 15 | Oxygen atom with | 3 | SER OG; THR OG1; TYR OH; |
| | one single bond | | |
| 16 | Other carbon | | Other C |
| | atom | | |
| 17 | Other oxygen | | Other O |
| | atom | | |
| 18 | Other nitrogen | | Other N |
| | atom | | |
| 19 | Other sulfide | | Other S |
| | atom | | |
| 20 | Phosphor atom | | P |
| 21 | Halogen atom | | F; CL; BR; I; |
| 22 | Metallic atom | | Mg; Fe; Zn; etc |

1.4.2 Datasets

All available PDB data files are used to derive atom types and the rotamer library. The evaluation dataset was the same as used by SCWRL4. The training dataset was generated by using all public structures derived using X-ray crystallography from RCSB, excluding those with a resolution above 1.7 Å, those with missing atoms or having dashed atoms, and those with chains similar to one in the evaluation dataset. There was a total of 12809 PDB files and ˜3,840,000 amino acids in the training dataset, and 379 PDB files and ˜72,000 amino acids in the evaluation dataset.

1.4.3 Data Preparation

Only structures obtained using X-ray diffraction were kept. Symmetry mates were added to the original protein structure prior to training and evaluation to restore the original crystal structure environment.

1.4.4 Input Quantization

Every input conformation was represented as a grid of 20*20*20 voxels, each voxel representing a 1 Å³ volume. Each atom in an amino acid and related environment is represented as a smoothly interpolated sphere in the grid, using the soft-bin fill algorithm. Each of the 23 atom types forms a channel in the input feature map. Atoms of the side chain conformation to be predicted and of its environment are extracted into separated channels to be able to distinguish them. Therefore, a total of 46 input channels are used.

The softbin grid fill algorithm takes an input atom and fills the voxel grid region the atom occupies. The occupation ratio is obtained by treating the atom as a 1×1×1 cube and calculating the intersection volume between the cube and a voxel. The occupation ratio is further normalized to make sure all occupation ratio of an atom sums up to one.

1.4.6 Negative Sampling

The original conformation of each amino acid in the training dataset was set to be ground truth. In order to obtain negative samples, a hybrid global and local sampling approach may be used, unlike SCWRL4 which only uses a global conformer library. As with previous approaches, a conformer library may be first obtained by aggregating and clustering amino acid conformations from all available protein structure data. Using this library, many different conformations can be sampled for a given ground truth. However, since the conformer library is globally averaged, and due to the fact the potential number of conformers is very large (up to 5 dihedral angles), globally clustered conformer library is insufficient in some cases. To overcome this issue, an algorithm may be additionally used to perturb the conformation of amino acids and obtain localized negative conformations.

The perturbation algorithm starts with a perturbation angle predefined by the type of the amino acid. Then it iteratively processes each dihedral angle in reversing order. For each dihedral angle, it generates two samples by rotating the dihedral angle by the perturbation angle back and forth. A decay is applied after each dihedral. This procedure gives more flexibility to dihedral angles in the far end than dihedrals near the backbone.

1.4.6 Training Algorithm

All training data was organized as <a,b> pairs such that the conformation a should be ranked better than conformation b. Several types of ranking pairs were extracted for training:

1. Ground truth conformer (the closest conformer in the conformer library to the ground truth) was ranked better than all other conformers in conformer library.
2. Ground truth was ranked better than the most similar conformer in the rotamer library.
3. Ground truth was ranked better than all locally perturbed conformations.

During ranking pair generation, if the RMSD between the two conformations was lower than predefined threshold, the pair was thought to be ambiguous and discarded from the training dataset. This may happen, for example, when the ground truth is very similar to the ground truth conformer, in which it is hard to determine which one is better.

For example, Microsoft's CNTK toolkit may be used for training the neural network. The neural network takes input a voxel grid of quantized amino acid environment and approximates a piecewise ranking score. The 20*20*20 voxel is fed through a 3*3*3 convolutional layer and a 5*5*5 convolutional layer, with a 2*2*2 max pool subsampling. Then another 3*3*3 and 5*5*5 convolutional layers are applied. Finally, a global average pooling layer is used to aggregate information from the entire grid and several fully connected layers are applied subsequently to project the output to a scalar score. Rectified Linear Unit (ReLU) non-linearity is used throughout the process except the output layer, where a sigmoid non-linearity is used to map the output to probability of range (0, 1).

During training, the scores of the ranking pair a and b are calculated and compared. The training loss is defined to favor correct pairwise ranking predictions.

1.4.7 Inference Algorithm

During inference, the correct conformation of an amino acid given its ground truth environment needs to be predicted. This was carried out using a two-phase algorithm. First, all global conformers for the amino acid were sampled with their conformational score predicted. The conformer with the best score was kept as the most probable conformer. Second, the conformer is further optimized through an iterative fine tuning process. In each iteration, all possible perturbation with angle α of current conformer is enumerated, then evaluated. The one with highest score is kept for next iteration. The angle α is divided by 3 after each iteration, so that each conformation enumerated is not the same with each other, and all conformations are uniformly covering the dihedral combinations similar to the initial one.

The fine tuning algorithm starts with a maximum depth and an amino acid. It generates samples by enumerating all combination of chi angle rotations with a certain angle interval. A decay rate is applied to the perturbation angle as the Perturb algorithm.

Extended Data Figures

FIGS. 28A-28F|CDF plot for each amino acid type in the disclosed rotamer library (shown in red), SCWRL4 rotamer library (shown in blue) and their difference (shown in green) are shown.

FIGS. 29A-29E|CNN ranking model evaluation

The ranking model used in CNN training algorithm was evaluated by plotting the accuracy at the kth rank. The evaluation metric is similar to precision@k. For every amino acid in the test set, all poses of its kind were retrieved, and then their predicted scores were compared with the predicted score for ground truth. The top K ranked poses were used for inspection. In the “ground truth” evaluation scheme, if the ground truth occurs in the top K ranked poses, the scoring for this amino acid was considered correct. In the “similar pose” evaluation scheme, if any poses with an RMSD with ground truth less than a predefined small value and is within the top K value, the scoring for this amino acid was considered correct. The accuracy for the entire test set was then defined as the average correctness rate for each amino acid type.

FIGS. 30A-30G|The disclosed method out-performs the SCWRL4 method by RMSD criteria

CDF function for each amino acid prediction accuracy rate with respect RMSD were plotted with the disclosed model shown in red, the SCWRL4 model in blue and their difference shown in yellow.

FIGS. 31A-41F|Histogram of Probability Score for all PDBs

This figure is related to FIG. 26B. The probability distribution functions of the LOO scores for different model types were individually plotted by histogram.

FIGS. 32A-32I|LOO Outiler Analysis

This figure is related to FIG. 27A, the pie chart of the LOO outliers for each amino acid type were created using same color label as in FIG. 27A.

Supplementary Tables

SUPPLEMENTARY TABLE 1
RMSD values for each amino acid in the disclosed pose library

| Amino | Pose | Chi | Chi | Chi | Chi | Chi |
|---|---|---|---|---|---|---|
| type | number | angle 1 | angle 2 | angle 3 | angle 4 | angle 5 |
| ALA | 0 | | | | | |
| ARG | 0 | −1.04675 | 2.98455 | −3.01832 | 1.59654 | −0.00275 |
| | 1 | −3.03765 | 3.13808 | −1.10239 | 1.9646 | −0.01294 |
| | 2 | 1.1308 | −3.06838 | 1.21496 | 1.39321 | 0.006762 |
| | 3 | 1.03607 | −3.07725 | −1.03257 | 2.8889 | 0.037129 |
| | 4 | −1.1957 | −3.05257 | −3.06189 | 1.73844 | 0.079245 |
| | 5 | −1.17894 | −1.27709 | −3.01154 | 3.09138 | −0.02047 |
| | 6 | 1.14289 | 3.07635 | −3.11094 | 2.80708 | 0.088315 |
| | 7 | −1.05271 | −3.12785 | −3.01701 | 3.13863 | 0.002262 |
| | 8 | −3.06692 | −3.0417 | −1.08893 | 2.93915 | 0.000839 |
| | 9 | −1.03943 | −1.30476 | 1.40579 | −2.93863 | 3.13826 |
| | 10 | −0.92327 | −1.08101 | −2.94196 | −1.84031 | 3.12169 |
| | 11 | 3.05146 | 1.14619 | 1.12913 | −2.82164 | 0.003159 |
| | 12 | −1.29709 | −3.09978 | 3.07323 | −1.59559 | −0.03166 |
| | 13 | −2.98805 | −3.10419 | −0.9319 | −1.52884 | −0.00589 |
| | 14 | −3.03172 | 2.93809 | 1.22178 | 1.55738 | −0.0252 |
| | 15 | −1.13662 | −2.92957 | 1.22595 | −2.16558 | 0.019862 |
| | 16 | −1.15738 | 3.04876 | −1.09455 | 2.99623 | 0.004476 |
| | 17 | 3.12213 | 2.94104 | −1.11451 | 2.87308 | 0.001188 |
| | 18 | −1.22416 | −1.34076 | −1.12112 | 2.41225 | −3.11867 |
| | 19 | −1.10269 | −2.91578 | −1.0812 | 3.05526 | 3.11406 |
| | 20 | −3.13648 | 1.15558 | −3.11149 | −1.51005 | −0.08625 |
| | 21 | −0.99433 | −2.98492 | 1.21543 | 3.09036 | −0.00055 |
| | 22 | −1.164 | 2.806 | −1.13372 | 3.05936 | −0.02106 |
| | 23 | −1.22407 | −3.11585 | 3.0474 | 3.03781 | −0.01621 |
| | 24 | −3.06301 | 2.95129 | 1.0567 | −3.05879 | 0.005266 |
| | 25 | −1.06978 | −1.14339 | −3.07328 | −2.84368 | −0.00424 |
| | 26 | −1.18263 | −3.07635 | −3.06058 | −1.4923 | −0.00482 |
| | 27 | −3.07132 | −2.86472 | 1.16942 | 1.39082 | −0.02657 |
| | 28 | −1.42949 | 1.37883 | 2.98883 | 2.98653 | 0.017935 |
| | 29 | −1.04123 | −1.1315 | −3.12386 | 1.50405 | −0.00402 |
| | 30 | −1.26099 | 3.00896 | 3.10753 | 2.79139 | −0.00502 |
| | 31 | −2.93594 | −2.76538 | −0.95474 | −2.84332 | 0.044949 |
| | 32 | −1.2686 | −2.95962 | −1.21072 | −1.54204 | 0.005779 |
| | 33 | −1.22545 | −3.07571 | −1.16673 | 1.91772 | −0.00558 |
| | 34 | −3.13982 | 3.08822 | −1.20607 | −1.48297 | 0.00426 |
| | 35 | −3.07598 | 3.00197 | −3.07901 | −3.08138 | −0.01618 |
| | 36 | −2.94048 | 1.21369 | 2.83111 | −2.9289 | −0.03371 |
| | 37 | −2.89775 | 2.81635 | −1.12092 | −1.43221 | 0.015495 |
| | 38 | 3.11484 | 3.10927 | 3.01217 | 1.52412 | 0.001114 |
| | 39 | −1.24704 | −2.98438 | 2.95034 | −2.94607 | −0.00296 |
| | 40 | 3.09027 | 2.98434 | −1.9109 | −3.06026 | −0.06005 |
| | 41 | −1.16652 | −1.48883 | 1.22869 | 1.45392 | −0.02114 |
| | 42 | −1.13473 | −1.18488 | −3.08255 | −1.60652 | −0.01906 |
| | 43 | −0.97941 | −1.08215 | −1.13289 | −1.5081 | 0.01129 |
| | 44 | −1.21948 | 2.92312 | 3.03205 | 1.36238 | −3.12866 |
| | 45 | −2.91471 | 3.06424 | 3.10042 | 1.55323 | −0.00372 |
| | 46 | −3.13172 | −3.07151 | 2.97421 | −2.94482 | −0.02856 |
| | 47 | −1.1602 | 2.81534 | −1.09265 | −1.4988 | −0.00406 |
| | 48 | 3.03057 | 1.35636 | −1.27774 | 3.13881 | −0.01145 |
| | 49 | 1.11051 | 3.0763 | −1.05968 | −1.93125 | −0.00801 |
| | 50 | −1.13879 | 3.0486 | 1.01307 | −2.06528 | −0.00559 |
| | 51 | −1.19037 | 2.88937 | 1.11912 | −2.99184 | 3.13927 |
| | 52 | 1.10631 | −3.03246 | 3.06975 | −2.98922 | 0.014513 |
| | 53 | 1.2369 | −3.04336 | 1.0694 | −2.77406 | 3.04269 |
| | 54 | −1.07511 | 3.0366 | −2.95568 | 2.68705 | 0.073773 |
| | 55 | −1.16715 | −2.90244 | −0.93659 | −1.51949 | 3.14143 |
| | 56 | −1.03266 | −1.32681 | −1.17178 | 3.0017 | −3.08673 |
| | 57 | −2.97545 | −3.06309 | 1.1878 | −3.13461 | −0.00905 |
| | 58 | −3.0914 | 1.13316 | 3.0767 | 3.10789 | 0.008466 |
| | 59 | −0.97883 | −0.98837 | −1.02635 | 2.84383 | −0.00592 |
| | 60 | −1.15728 | 2.90962 | 1.09395 | 1.59043 | −3.11446 |
| | 61 | −1.32139 | 3.04576 | −1.31745 | −3.11844 | 0.015307 |
| | 62 | −1.09332 | −3.05376 | −3.07886 | −2.69742 | 0.009823 |
| | 63 | −1.35195 | −3.01008 | 3.00979 | 1.54525 | 0.068054 |
| | 64 | −3.03056 | −2.74696 | 1.02028 | −2.47998 | −0.0063 |
| | 65 | 1.07924 | 2.97673 | −3.13646 | 1.44827 | −0.00111 |
| | 66 | 3.07986 | 1.1873 | 0.938949 | 1.56929 | −0.00792 |
| | 67 | −1.03482 | 3.13229 | −2.93758 | −1.49394 | 0.013541 |
| | 68 | −1.18113 | −1.23363 | −0.99104 | −1.48063 | 0.021192 |
| | 69 | 3.13658 | −3.02665 | 3.02181 | −1.61125 | −0.00591 |
| | 70 | −3.05233 | 3.02447 | 1.08276 | −1.98232 | 0.006521 |
| | 71 | −3.04023 | 3.05164 | −2.98993 | −1.51683 | 0.002999 |
| | 72 | −1.07661 | −3.01964 | 1.25138 | 1.45565 | 0.034974 |
| | 73 | 1.17734 | −2.9832 | −3.09635 | −1.44982 | −0.00477 |
| | 74 | −1.17211 | 3.1253 | 1.16682 | −2.99117 | 0.029311 |
| | 75 | −1.03063 | −1.20073 | 1.4147 | 1.47213 | −0.00018 |
| | 78 | 3.13029 | 1.15904 | −3.09077 | 1.45876 | −0.01627 |
| | 77 | −1.24741 | 3.14036 | 1.01011 | 1.45655 | 0.0042 |
| | 78 | 3.08528 | 3.07108 | 1.01085 | 1.36964 | −0.01331 |
| | 79 | 3.09169 | 1.15316 | 3.07802 | 2.62611 | −0.00609 |
| | 80 | 2.87116 | 1.2691 | 3.08413 | 1.33925 | 0.034586 |
| ASN | 0 | −2.66568 | 0.618128 | | | |
| | 1 | −1.01315 | −1.24623 | | | |
| | 2 | −1.37625 | 0.22431 | | | |
| | 3 | 1.08862 | 0.306274 | | | |
| | 4 | −1.34623 | −0.31858 | | | |
| | 5 | 1.19365 | −0.28597 | | | |
| | 6 | −1.03028 | −0.51588 | | | |
| | 7 | −2.57294 | −0.48831 | | | |
| | 8 | −1.29291 | −0.74953 | | | |
| | 9 | −2.86746 | 0.214598 | | | |
| | 10 | 1.03065 | 0.989735 | | | |
| | 11 | −1.19033 | −0.17953 | | | |
| | 12 | 3.10964 | 0.961966 | | | |
| | 13 | 3.12313 | 0.217978 | | | |
| | 14 | −1.43638 | −1.37569 | | | |
| | 15 | −1.19615 | −0.48422 | | | |
| | 16 | −1.12757 | 0.974179 | | | |
| | 17 | −1.09222 | −0.82304 | | | |
| | 18 | −1.94423 | 0.486203 | | | |
| | 19 | 1.09738 | −0.87992 | | | |
| | 20 | −1.21313 | −1.29185 | | | |
| | 21 | −3.0384 | −0.35222 | | | |
| | 22 | −2.98217 | −0.87025 | | | |
| | 23 | −0.87163 | −0.91941 | | | |
| | 24 | −2.93042 | 0.730362 | | | |
| | 25 | −3.08881 | −1.43735 | | | |
| | 26 | −1.57487 | −0.62657 | | | |
| ASP | 0 | −3.09645 | −0.10181 | | | |
| | 1 | −3.00555 | −0.46689 | | | |
| | 2 | 1.12705 | 0.228888 | | | |
| | 3 | −1.30996 | −0.25884 | | | |
| | 4 | 3.06329 | 1.12679 | | | |
| | 5 | −2.55585 | −0.58844 | | | |
| | 6 | 3.04829 | 0.317533 | | | |
| | 7 | 0.99741 | −0.18083 | | | |
| | 8 | −1.98629 | 0.175414 | | | |
| | 9 | −1.1527 | −1.20192 | | | |
| | 10 | −1.2204 | −0.58723 | | | |
| | 11 | −3.00742 | 1.16176 | | | |
| | 12 | −1.04866 | −0.50067 | | | |
| | 13 | −1.48795 | −0.05415 | | | |
| | 14 | 1.23759 | −0.28171 | | | |
| | 15 | −1.09036 | 0.934336 | | | |
| | 16 | −0.87521 | −1.00058 | | | |
| | 17 | −2.77999 | 0.019313 | | | |
| | 18 | −1.17689 | −0.24758 | | | |
| | 19 | −2.77209 | 0.704797 | | | |
| | 20 | −1.48141 | −0.77888 | | | |
| | 21 | −1.29438 | 0.087882 | | | |
| | 22 | −2.98999 | 0.431676 | | | |
| | 23 | −2.97581 | −1.10208 | | | |
| | 24 | 1.06736 | −0.99461 | | | |
| | 25 | 0.973518 | 0.833716 | | | |
| | 26 | −1.07821 | −0.86417 | | | |
| CYS | 0 | −1.11928 | | | | |
| | 1 | −0.90691 | | | | |
| | 2 | 1.28018 | | | | |
| | 3 | 3.1029 | | | | |
| | 4 | −2.92853 | | | | |
| | 5 | −1.31079 | | | | |
| | 6 | 1.02507 | | | | |
| GLN | 0 | −1.41534 | 1.2249 | 0.774213 | | |
| | 1 | 3.06047 | 1.1354 | −1.07026 | | |
| | 2 | −1.24223 | −1.39421 | 0.387031 | | |
| | 3 | −1.08461 | −1.99191 | −0.18214 | | |
| | 4 | −0.98802 | −1.19408 | −0.17501 | | |
| | 5 | −1.33852 | −2.71708 | −0.72468 | | |
| | 6 | −1.14644 | 2.84698 | 0.406171 | | |
| | 7 | −0.84486 | −0.8831 | −0.7692 | | |
| | 8 | −1.19153 | −2.98468 | −0.66048 | | |
| | 9 | 2.86042 | 1.09397 | 0.368513 | | |
| | 10 | 3.12831 | −2.79036 | 0.800643 | | |
| | 11 | 3.0468 | 1.17714 | 0.98854 | | |
| | 12 | −3.01959 | 2.91517 | −0.75704 | | |
| | 13 | −1.08042 | 3.02841 | 1.16743 | | |
| | 14 | −1.1937 | 1.34671 | 0.454371 | | |
| | 15 | 3.11873 | 1.05254 | 0.533111 | | |
| | 16 | −1.08565 | −1.30895 | 0.990194 | | |
| | 17 | −2.95607 | 2.97404 | 1.03623 | | |
| | 18 | −1.1132 | 2.97652 | −0.61417 | | |
| | 19 | −0.99449 | −1.76441 | 0.555644 | | |
| | 20 | −1.12117 | 2.77346 | −0.09398 | | |
| | 21 | −1.15985 | −1.16925 | −0.45322 | | |
| | 22 | 1.19031 | −1.507 | 0.239575 | | |
| | 23 | −1.1078 | 3.08633 | 0.674082 | | |
| | 24 | −2.86258 | 2.68468 | 0.277109 | | |
| | 25 | −0.97135 | 1.51676 | 0.48045 | | |
| | 26 | −0.97786 | −1.01725 | −0.85376 | | |
| | 27 | −1.30707 | −2.80952 | 0.63242 | | |
| | 28 | −3.03599 | 3.00189 | −0.07342 | | |
| | 29 | −3.04363 | 1.12025 | 0.933222 | | |
| | 30 | −1.10583 | −1.03335 | −0.91889 | | |
| | 31 | −2.90217 | 1.12433 | 0.780589 | | |
| | 32 | −1.14942 | 3.05342 | −1.20145 | | |
| | 33 | −1.08939 | 2.78214 | −1.03732 | | |
| | 34 | −1.07765 | 1.65202 | −0.62728 | | |
| | 35 | −3.0497 | 1.54433 | 2.44504 | | |
| | 36 | −1.15673 | −3.13633 | 0.226635 | | |
| | 37 | −3.09193 | 1.2851 | 0.180371 | | |
| | 38 | 3.13431 | −3.1389 | −0.96678 | | |
| | 39 | −1.19895 | −3.01516 | 0.683236 | | |
| | 40 | −2.68642 | 1.25721 | 0.426618 | | |
| | 41 | −3.01289 | 2.98728 | 0.491175 | | |
| | 42 | −1.35258 | −1.29729 | −0.66589 | | |
| | 43 | −1.22016 | −1.17405 | −0.97502 | | |
| | 44 | −3.11735 | −3.09657 | 0.433439 | | |
| | 45 | −1.19121 | 3.08939 | −0.79002 | | |
| | 46 | −1.21716 | −3.01033 | −1.15424 | | |
| | 47 | −1.19308 | −2.99519 | −0.13172 | | |
| | 48 | −3.08835 | −3.1015 | 1.01308 | | |
| | 49 | 1.15486 | −3.07765 | 0.708161 | | |
| | 50 | −3.12852 | −3.07399 | −0.20626 | | |
| | 51 | 1.09553 | −3.12182 | −0.71245 | | |
| | 52 | −2.9961 | −1.52622 | −0.37546 | | |
| | 53 | 3.03047 | −2.76699 | −0.56767 | | |
| | 54 | 1.04872 | 1.59115 | 0.313985 | | |
| | 55 | −1.16201 | 2.99732 | −0.10496 | | |
| | 56 | −1.18574 | 3.09417 | −0.4305 | | |
| | 57 | −0.89078 | 2.65832 | 0.959273 | | |
| | 58 | −1.70257 | −1.27603 | 0.011815 | | |
| | 59 | −1.14913 | −3.02656 | 1.10277 | | |
| GLU | 0 | −1.21377 | −2.98694 | −0.44973 | | |
| | 1 | −1.34182 | −2.72306 | −0.11894 | | |
| | 2 | −1.02938 | 1.59108 | −0.43378 | | |
| | 3 | 2.95295 | 1.03309 | 0.564522 | | |
| | 4 | 1.20944 | 3.00751 | 0.074781 | | |
| | 5 | −1.03334 | −1.2107 | −0.18522 | | |
| | 6 | −2.75094 | −1.40227 | −0.50423 | | |
| | 7 | −2.98913 | 2.9208 | 0.937637 | | |
| | 8 | 1.30387 | −1.36183 | −0.03806 | | |
| | 9 | −1.36976 | 1.23787 | 0.58592 | | |
| | 10 | −1.22327 | 3.0336 | −0.3591 | | |
| | 11 | −1.17148 | 3.116 | −0.79347 | | |
| | 12 | −1.27647 | −2.74357 | −0.97119 | | |
| | 13 | −1.18357 | 3.13996 | −0.10172 | | |
| | 14 | −1.44426 | −1.07681 | −0.82584 | | |
| | 15 | 3.09282 | 1.11976 | 0.341362 | | |
| | 16 | −1.12259 | −3.1256 | 1.07109 | | |
| | 17 | −1.74068 | −1.34315 | −0.16172 | | |
| | 18 | −1.06064 | −0.96925 | −0.78938 | | |
| | 19 | −1.20242 | −1.43692 | 0.708673 | | |
| | 20 | −1.22772 | −1.05671 | −0.69215 | | |
| | 21 | 1.16701 | −3.10495 | 0.851762 | | |
| | 22 | 3.13347 | −3.1018 | −0.58619 | | |
| | 23 | −1.24126 | −2.85457 | 0.802781 | | |
| | 24 | −3.1352 | −3.07925 | 1.07285 | | |
| | 25 | −3.05004 | 2.96094 | −0.35974 | | |
| | 26 | −1.13587 | 2.92929 | −0.39306 | | |
| | 27 | −1.19513 | −3.07164 | −1.17871 | | |
| | 28 | −1.19651 | −1.31388 | −0.12273 | | |
| | 29 | −1.119 | 2.91032 | −1.07536 | | |
| | 30 | −2.81971 | 2.66761 | 0.069261 | | |
| | 31 | −3.10115 | 3.12784 | −0.03862 | | |
| | 32 | 3.0035 | −2.7949 | 2.36368 | | |
| | 33 | −2.8169 | 1.23093 | 0.455437 | | |
| | 34 | −1.14869 | −1.06843 | −0.98328 | | |
| | 35 | −1.24556 | −1.34246 | 2.13813 | | |
| | 36 | −1.11923 | 3.07087 | 0.266164 | | |
| | 37 | −3.06194 | 3.00935 | −1.04748 | | |
| | 38 | −0.82839 | −1.01135 | −0.55793 | | |
| | 39 | −3.12744 | 1.3516 | −0.25671 | | |
| | 40 | −3.05518 | −1.50969 | −0.41952 | | |
| | 41 | −0.96545 | 2.66068 | −0.2676 | | |
| | 42 | 3.10237 | −2.92972 | −0.00555 | | |
| | 43 | −1.207 | 1.48692 | −0.07474 | | |
| | 44 | −1.14064 | 1.29716 | 0.544884 | | |
| | 45 | 1.02652 | 1.54059 | 0.359361 | | |
| | 46 | 1.16436 | 3.05983 | −0.82974 | | |
| | 47 | −0.74914 | 1.51036 | −2.26886 | | |
| | 48 | 1.03432 | −2.87442 | 2.16029 | | |
| | 49 | −3.0188 | 2.96218 | 0.202906 | | |
| | 50 | −1.16314 | −3.07798 | 0.527527 | | |
| | 51 | −1.03638 | 2.92187 | 0.851104 | | |
| | 52 | 1.09128 | −2.97402 | 0.046425 | | |
| | 53 | −1.17623 | 2.93525 | −0.01678 | | |
| | 54 | −3.12331 | −3.11579 | 0.487864 | | |
| | 55 | −1.20004 | −2.97138 | 0.068336 | | |
| | 56 | −3.02667 | 1.08155 | 0.683036 | | |
| | 57 | −1.13801 | 2.79723 | 0.282011 | | |
| | 58 | 1.05248 | −1.59537 | 0.531635 | | |
| | 59 | −0.98704 | −1.86134 | 0.174151 | | |
| HIS | 0 | 0.984196 | 1.33336 | | | |
| | 1 | −1.44233 | −1.32534 | | | |
| | 2 | −1.01387 | −0.97964 | | | |
| | 3 | −1.12383 | 3.01339 | | | |
| | 4 | 3.13254 | −1.56528 | | | |
| | 5 | −1.6898 | −1.19359 | | | |
| | 6 | −1.17103 | 1.43849 | | | |
| | 7 | 1.20405 | −1.32218 | | | |
| | 8 | −3.08288 | 1.19998 | | | |
| | 9 | −1.0191 | 1.43252 | | | |
| | 10 | 0.854569 | −1.39053 | | | |
| | 11 | −1.44571 | −2.89339 | | | |
| | 12 | −0.77364 | −1.13233 | | | |
| | 13 | 1.46074 | −1.48888 | | | |
| | 14 | −0.91015 | −1.22838 | | | |
| | 15 | −2.90031 | 1.19195 | | | |
| | 16 | −1.03985 | −1.33009 | | | |
| | 17 | −2.47382 | 0.890998 | | | |
| | 18 | −0.79221 | 1.39548 | | | |
| | 19 | −3.07272 | −2.93158 | | | |
| | 20 | −1.34571 | 1.32801 | | | |
| | 21 | −1.17864 | −1.43226 | | | |
| | 22 | −2.76196 | −1.241 | | | |
| | 23 | 2.86957 | 1.26748 | | | |
| | 24 | 1.04836 | −1.30967 | | | |
| | 25 | 1.20245 | 1.45612 | | | |
| | 26 | −1.16881 | 2.53601 | | | |
| | 27 | −0.98315 | 2.73608 | | | |
| | 28 | −1.16355 | −1.05523 | | | |
| | 29 | 3.05455 | 1.19772 | | | |
| | 30 | −1.21088 | −2.79056 | | | |
| | 31 | −2.7843 | 2.96946 | | | |
| | 32 | −1.29398 | 2.92722 | | | |
| | 33 | −1.31197 | −1.17817 | | | |
| | 34 | −2.95869 | −1.35717 | | | |
| | 35 | 0.985837 | −2.82385 | | | |
| ILE | 0 | −0.93558 | 3.03569 | | | |
| | 1 | −1.01175 | 1.59211 | | | |
| | 2 | −1.12099 | 2.98797 | | | |
| | 3 | −1.3913 | 1.08096 | | | |
| | 4 | −1.1552 | 2.81032 | | | |
| | 5 | −1.02151 | 2.80756 | | | |
| | 6 | −0.99469 | −1.04706 | | | |
| | 7 | −0.91371 | −0.99248 | | | |
| | 8 | −1.30373 | −3.14041 | | | |
| | 9 | −1.15776 | −1.17079 | | | |
| | 10 | −1.01704 | 2.47061 | | | |
| | 11 | −1.05413 | 2.9398 | | | |
| | 12 | −0.84505 | 2.92643 | | | |
| | 13 | −1.2824 | −1.26402 | | | |
| | 14 | −2.86214 | 2.88322 | | | |
| | 15 | −1.01304 | 3.13688 | | | |
| | 16 | 1.14557 | 2.94125 | | | |
| | 17 | 1.01208 | 1.51861 | | | |
| | 18 | −0.77815 | −1.05475 | | | |
| | 19 | −3.04955 | 1.11676 | | | |
| | 20 | −1.1586 | 3.09874 | | | |
| | 21 | 0.991828 | 3.02797 | | | |
| | 22 | −2.81472 | 1.20732 | | | |
| | 23 | −3.07702 | 2.95675 | | | |
| | 24 | −1.21631 | 2.88693 | | | |
| | 25 | −1.27713 | 2.94569 | | | |
| | 26 | −1.08176 | −1.06418 | | | |
| LEU | 0 | −3.12088 | 0.999697 | | | |
| | 1 | −2.98134 | 1.01808 | | | |
| | 2 | −1.24528 | 3.07056 | | | |
| | 3 | 1.04329 | 1.43226 | | | |
| | 4 | −1.10602 | 3.10078 | | | |
| | 5 | −3.04315 | 2.67973 | | | |
| | 6 | −2.47899 | −2.91583 | | | |
| | 7 | −1.12832 | −2.98987 | | | |
| | 8 | −1.72336 | 0.55876 | | | |
| | 9 | −2.96502 | −1.33931 | | | |
| | 10 | 3.05511 | 1.06117 | | | |
| | 11 | 2.95063 | 1.16504 | | | |
| | 12 | −1.14483 | 2.94793 | | | |
| | 13 | −1.3697 | 2.9111 | | | |
| | 14 | −1.00644 | 2.97177 | | | |
| | 15 | −0.988 | −3.09818 | | | |
| | 16 | −2.91741 | 1.24135 | | | |
| | 17 | −3.12317 | 1.20771 | | | |
| | 18 | −2.62068 | 0.996958 | | | |
| | 19 | −1.10358 | 1.56735 | | | |
| | 20 | −1.4679 | 1.06661 | | | |
| | 21 | −0.85868 | 3.1085 | | | |
| | 22 | −1.22029 | −0.84263 | | | |
| | 23 | 1.26677 | 2.88234 | | | |
| | 24 | −1.23659 | 2.83589 | | | |
| | 25 | −1.61227 | −3.12218 | | | |
| | 26 | −1.5614 | −1.21062 | | | |
| LYS | 0 | −1.23927 | −1.19254 | −2.57183 | 1.24141 | |
| | 1 | −0.94937 | −1.02653 | −3.03241 | −1.23408 | |
| | 2 | 1.1442 | −3.07618 | 3.13195 | −1.15481 | |
| | 3 | −3.12521 | 3.11189 | 3.08827 | 3.10539 | |
| | 4 | −1.16084 | −1.11993 | −3.10686 | −3.12026 | |
| | 5 | 1.21332 | 3.13575 | −3.08123 | 3.10311 | |
| | 6 | −1.2536 | −3.01959 | 2.89346 | 1.04097 | |
| | 7 | −1.46598 | −2.81907 | −1.41081 | −2.78727 | |
| | 8 | −1.1667 | −1.21782 | −2.9913 | −1.19178 | |
| | 9 | −2.96316 | 2.98675 | −3.05264 | 3.0844 | |
| | 10 | −3.10177 | 2.97985 | −3.12223 | 3.04288 | |
| | 11 | −2.86232 | 2.95125 | −2.77035 | 3.03659 | |
| | 12 | −3.05979 | −3.04159 | 3.09466 | −2.81972 | |
| | 13 | 1.1312 | 3.077 | 3.01143 | 1.12566 | |
| | 14 | −1.05266 | −1.14045 | −3.12147 | 1.03252 | |
| | 15 | −3.10832 | −3.04901 | 1.03065 | 1.53295 | |
| | 16 | −2.98958 | 1.25375 | 3.03658 | 3.07201 | |
| | 17 | −1.15967 | 2.79921 | 1.14398 | 3.05446 | |
| | 18 | −1.18378 | −3.01759 | 1.27233 | 1.17858 | |
| | 19 | −1.3174 | 1.20467 | 2.78421 | 3.02012 | |
| | 20 | −1.13041 | −3.1115 | −1.12415 | −1.12847 | |
| | 21 | −3.06777 | 3.02472 | 1.12451 | 3.07549 | |
| | 22 | −1.06289 | −1.18852 | 1.82467 | −3.05228 | |
| | 23 | −1.16219 | −2.90749 | 1.64357 | 2.98543 | |
| | 24 | −2.97627 | 3.08635 | −1.1125 | −1.38189 | |
| | 25 | −0.99716 | −1.29274 | −2.95846 | 3.07141 | |
| | 26 | −1.15937 | 3.09742 | −3.131 | 3.09185 | |
| | 27 | 3.09932 | 1.14933 | 2.9998 | 1.25106 | |
| | 28 | −1.14284 | −2.85713 | −1.18155 | 1.30071 | |
| | 29 | −1.26275 | −2.98362 | 3.00706 | −1.29329 | |
| | 30 | −1.06857 | 3.11901 | −2.92669 | −1.00413 | |
| | 31 | −0.99696 | 2.99537 | −2.92242 | 3.03167 | |
| | 32 | −3.0179 | 3.02021 | −2.90898 | −1.12842 | |
| | 33 | −1.2537 | 2.94651 | 1.04407 | 0.964988 | |
| | 34 | 3.13905 | 3.13902 | 3.13328 | −1.20113 | |
| | 35 | −1.0264 | −1.03159 | −3.08976 | −3.03206 | |
| | 36 | 3.06284 | −2.94435 | 2.82723 | −2.95878 | |
| | 37 | −1.24901 | −3.04633 | 3.03804 | −3.09418 | |
| | 38 | −1.1057 | −3.03759 | 3.12686 | −2.99991 | |
| | 39 | 1.35412 | 3.11281 | −2.74135 | 1.29009 | |
| | 40 | −2.94889 | 1.19797 | 2.80376 | −1.07864 | |
| | 41 | 1.06196 | −3.01018 | 3.07168 | −3.07605 | |
| | 42 | 3.05826 | −3.13203 | 2.98092 | 3.10893 | |
| | 43 | −1.30241 | −2.90099 | 2.97589 | −3.03546 | |
| | 44 | 1.12572 | −3.07527 | −1.12036 | −3.10964 | |
| | 45 | −1.2726 | 3.12583 | 3.09311 | 2.9868 | |
| | 46 | −1.1774 | −3.037 | −1.25482 | −2.99426 | |
| | 47 | −1.27065 | 3.02108 | 1.02468 | −3.12964 | |
| | 48 | −3.0852 | 1.10709 | 1.24758 | −3.11452 | |
| | 49 | −1.15673 | 2.04564 | −1.21337 | −2.7854 | |
| | 50 | −3.0756 | 3.10161 | 3.06549 | 1.12393 | |
| | 51 | −1.17055 | −2.88709 | −1.08654 | 3.1347 | |
| | 52 | −1.17216 | −3.1263 | −3.09672 | −1.15455 | |
| | 53 | −1.13622 | 2.99341 | −1.27804 | −3.05917 | |
| | 54 | −1.02765 | 3.03992 | −2.89851 | 1.41887 | |
| | 55 | −1.10097 | 3.04671 | −3.05007 | 3.0681 | |
| | 56 | −1.08079 | −1.14532 | −1.12248 | −3.09638 | |
| | 57 | −1.33379 | −2.9205 | 1.12905 | 3.11361 | |
| | 58 | 1.20049 | −3.035 | 1.03907 | 2.97817 | |
| | 59 | −3.02118 | 3.07966 | −3.12155 | −3.00283 | |
| | 60 | 1.01814 | 1.56092 | 2.97609 | 2.68789 | |
| | 61 | −1.25467 | −1.32358 | −3.02509 | 3.12322 | |
| | 62 | −1.12369 | 3.10485 | 1.30416 | 3.02196 | |
| | 63 | 3.07873 | −3.11395 | 2.91329 | 1.00946 | |
| | 64 | −3.07795 | −3.10883 | −1.14348 | −3.13011 | |
| | 65 | −1.12862 | −3.10733 | 3.09072 | 1.16582 | |
| | 66 | −2.94272 | 2.9458 | −3.07438 | 1.17992 | |
| | 67 | 1.108 | −1.28425 | 3.07756 | −2.90953 | |
| | 68 | 3.09926 | 1.2195 | 3.12129 | −1.06655 | |
| | 69 | −0.86315 | −1.01147 | −3.08086 | −3.08277 | |
| | 70 | 3.08412 | 1.13554 | 3.0628 | 2.99523 | |
| | 71 | −3.05428 | −1.61048 | −3.06125 | −2.90756 | |
| MET | 0 | −1.12981 | −1.11865 | 3.12706 | | |
| | 1 | 1.17698 | −1.25018 | −1.4516 | | |
| | 2 | −1.04321 | −0.97061 | −1.14705 | | |
| | 3 | −1.20804 | −3.12264 | 1.21939 | | |
| | 4 | −1.23536 | −1.18907 | −1.27153 | | |
| | 5 | −1.03744 | −3.07889 | −1.13881 | | |
| | 6 | −3.01638 | 1.1978 | −1.96538 | | |
| | 7 | −3.09136 | −1.43983 | −1.28901 | | |
| | 8 | −1.05585 | −1.05636 | 1.72981 | | |
| | 9 | −3.02699 | 0.998872 | 0.964917 | | |
| | 10 | −3.02311 | 1.22962 | 1.31068 | | |
| | 11 | −1.33131 | −1.18476 | 3.14153 | | |
| | 12 | −0.90217 | −1.22208 | −1.48888 | | |
| | 13 | −3.0399 | −3.02691 | −1.02293 | | |
| | 14 | 1.17247 | −3.06692 | 3.13436 | | |
| | 15 | −2.9554 | 1.17996 | 3.11724 | | |
| | 16 | −3.12496 | 3.06812 | 1.24881 | | |
| | 17 | −0.88528 | −0.95718 | −1.14751 | | |
| | 18 | −1.01871 | 3.06354 | 1.38066 | | |
| | 19 | −2.9163 | 2.94437 | −2.94243 | | |
| | 20 | 1.11655 | −2.99828 | −1.11562 | | |
| | 21 | −3.05103 | 2.851 | 1.02217 | | |
| | 22 | 3.13163 | −3.04466 | 2.84285 | | |
| | 23 | 3.07562 | 1.08532 | 1.30988 | | |
| | 24 | −1.10928 | −1.11173 | 2.32526 | | |
| | 25 | −1.25732 | −3.0039 | −1.33854 | | |
| | 26 | −1.34597 | 3.05994 | 0.802491 | | |
| | 27 | −3.10048 | −2.92935 | 1.32047 | | |
| | 28 | −1.29598 | 1.26347 | 1.39197 | | |
| | 29 | 3.07424 | 1.10827 | −3.07931 | | |
| | 30 | −1.06532 | 3.07355 | −2.77767 | | |
| | 31 | −1.12844 | 2.84303 | 1.07247 | | |
| | 32 | −3.11273 | 3.05329 | −1.30238 | | |
| | 33 | −0.9126 | −0.9997 | 3.06475 | | |
| | 34 | −1.15792 | 3.1047 | −3.08254 | | |
| | 35 | −1.04133 | −2.97616 | 1.41127 | | |
| | 36 | −1.19896 | −1.04935 | −1.1108 | | |
| | 37 | −1.42717 | −1.209 | −1.1931 | | |
| | 38 | −1.27851 | −3.10482 | 2.98214 | | |
| | 39 | −2.71239 | 1.20228 | 1.18051 | | |
| | 40 | −3.08103 | 3.09794 | −3.10911 | | |
| | 41 | −1.15602 | −0.87932 | −1.01583 | | |
| | 42 | 1.12107 | 3.00791 | −1.32214 | | |
| | 43 | −1.36737 | −1.00628 | −0.89851 | | |
| | 44 | −1.05573 | −1.14707 | −1.29205 | | |
| | 45 | −1.11555 | 2.77336 | −1.36893 | | |
| | 46 | −1.2165 | −1.18073 | 1.69195 | | |
| | 47 | −1.20567 | −2.83971 | −1.05927 | | |
| | 48 | −1.29849 | −2.89544 | 1.30271 | | |
| | 49 | −1.13366 | −1.34244 | −1.37587 | | |
| | 50 | −1.17313 | 3.08015 | −1.39681 | | |
| | 51 | 1.185 | −3.07725 | 1.21737 | | |
| | 52 | 1.07045 | 1.35744 | 1.39991 | | |
| | 53 | −1.18187 | 3.00205 | 1.17926 | | |
| PHE | 0 | −1.82351 | −2.24202 | | | |
| | 1 | −2.92626 | 0.172714 | | | |
| | 2 | −1.07244 | −1.39174 | | | |
| | 3 | 3.07871 | 0.878712 | | | |
| | 4 | −2.73549 | 1.18353 | | | |
| | 5 | 2.97028 | 1.32055 | | | |
| | 6 | 1.35409 | −1.29717 | | | |
| | 7 | −1.39944 | 1.27402 | | | |
| | 8 | 1.17666 | −1.72567 | | | |
| | 9 | −1.4593 | 0.525787 | | | |
| | 10 | −1.26071 | 1.36355 | | | |
| | 11 | −0.98724 | −0.55066 | | | |
| | 12 | 0.981052 | 1.40969 | | | |
| | 13 | −1.30127 | −0.94087 | | | |
| | 14 | −3.0955 | 1.35121 | | | |
| | 15 | −0.97196 | −1.26928 | | | |
| | 16 | −3.02286 | 0.955968 | | | |
| | 17 | −1.51907 | −1.24204 | | | |
| | 18 | −1.15563 | −0.31065 | | | |
| | 19 | −1.10351 | −0.78377 | | | |
| | 20 | −1.55146 | 1.18603 | | | |
| | 21 | −1.30815 | 0.036003 | | | |
| | 22 | −0.99572 | 1.41908 | | | |
| | 23 | 2.8284 | 1.20596 | | | |
| | 24 | −2.42637 | −0.71821 | | | |
| | 25 | 0.780339 | 1.34122 | | | |
| | 26 | −1.3363 | −1.33898 | | | |
| | 27 | −1.1258 | −1.11922 | | | |
| | 28 | 3.07923 | 1.33496 | | | |
| | 29 | −1.19824 | −1.3783 | | | |
| | 30 | 1.10252 | 1.7358 | | | |
| | 31 | −2.94618 | 1.33425 | | | |
| | 32 | −1.14071 | 1.42086 | | | |
| | 33 | −0.87457 | −1.08709 | | | |
| | 34 | −0.73983 | −0.96583 | | | |
| | 35 | −2.93285 | −1.29521 | | | |
| PRO | 0 | −0.12829 | 0.354331 | | | |
| | 1 | −0.29629 | 0.504634 | | | |
| | 2 | 0.563393 | −0.65759 | | | |
| | 3 | 0.155206 | −0.31867 | | | |
| | 4 | −0.40493 | 0.604818 | | | |
| | 5 | −0.56784 | 0.704934 | | | |
| | 6 | 0.321887 | −0.52516 | | | |
| | 7 | 0.494904 | −0.63672 | | | |
| | 8 | 0.421669 | −0.60601 | | | |
| | 9 | 0.633035 | −0.64722 | | | |
| | 10 | −0.48852 | 0.665734 | | | |
| | 11 | 0.315323 | −0.28933 | | | |
| SER | 0 | 0.938101 | | | | |
| | 1 | 3.01241 | | | | |
| | 2 | −1.00418 | | | | |
| | 3 | 1.14067 | | | | |
| | 4 | −1.2191 | | | | |
| | 5 | 1.3464 | | | | |
| | 6 | −3.00889 | | | | |
| THR | 0 | 0.901874 | | | | |
| | 1 | −0.87362 | | | | |
| | 2 | −1.03404 | | | | |
| | 3 | 1.24815 | | | | |
| | 4 | −1.16967 | | | | |
| | 5 | 1.07291 | | | | |
| | 6 | −3.02091 | | | | |
| TRP | 0 | −2.83637 | −0.56758 | | | |
| | 1 | 0.956887 | −1.59779 | | | |
| | 2 | 1.10658 | 1.57421 | | | |
| | 3 | 2.98643 | 1.42647 | | | |
| | 4 | −1.62349 | 1.8766 | | | |
| | 5 | −1.18781 | −1.37604 | | | |
| | 6 | −1.13961 | −0.16265 | | | |
| | 7 | 3.01936 | −2.03938 | | | |
| | 8 | −0.89124 | −1.31008 | | | |
| | 9 | 1.12569 | 0.064237 | | | |
| | 10 | −1.26253 | 1.22477 | | | |
| | 11 | 1.13694 | −1.15673 | | | |
| | 12 | −0.88961 | 1.90672 | | | |
| | 13 | −3.1065 | −2.0002 | | | |
| | 14 | −2.53619 | −1.81161 | | | |
| | 15 | −2.87208 | −0.03198 | | | |
| | 16 | −1.29432 | −1.67144 | | | |
| | 17 | −3.05614 | 1.55944 | | | |
| | 18 | −1.10653 | −1.64086 | | | |
| | 19 | −2.90089 | −1.49416 | | | |
| | 20 | −0.98428 | −0.65181 | | | |
| | 21 | 2.85484 | 1.23356 | | | |
| | 22 | 3.10462 | 1.52284 | | | |
| | 23 | −2.79742 | −1.9372 | | | |
| | 24 | 3.03635 | 0.695987 | | | |
| | 25 | −0.95736 | 1.60034 | | | |
| | 26 | −0.96952 | 2.33168 | | | |
| | 27 | 0.700231 | 1.38644 | | | |
| | 28 | −1.20394 | 2.01871 | | | |
| | 29 | −1.30085 | 1.63789 | | | |
| | 30 | −3.06766 | 0.339418 | | | |
| | 31 | −1.64252 | −1.84887 | | | |
| | 32 | −0.87362 | 1.30586 | | | |
| | 33 | −1.2273 | 1.80177 | | | |
| | 34 | 3.04038 | −1.66291 | | | |
| | 35 | −3.00035 | 0.882616 | | | |
| | 36 | −1.31105 | −0.57128 | | | |
| | 37 | −3.02349 | −1.8019 | | | |
| | 38 | −1.07761 | 1.3363 | | | |
| | 39 | −1.17665 | 1.52642 | | | |
| | 40 | 1.30712 | 1.68092 | | | |
| | 41 | 3.13437 | 1.22389 | | | |
| | 42 | −1.04598 | −0.36723 | | | |
| | 43 | −0.73164 | 2.16729 | | | |
| | 44 | 1.12091 | −1.56829 | | | |
| | 45 | −1.09969 | 1.73692 | | | |
| | 46 | −3.12399 | −1.34363 | | | |
| | 47 | 1.30513 | −1.55522 | | | |
| | 48 | −2.94296 | 1.63319 | | | |
| | 49 | −1.44072 | 1.60199 | | | |
| | 50 | −1.2539 | 0.68055 | | | |
| | 51 | 0.777071 | −1.71828 | | | |
| | 52 | −1.46534 | 0.892956 | | | |
| | 53 | 2.8007 | −1.9844 | | | |
| | 54 | −1.38627 | 1.96662 | | | |
| | 55 | −2.72645 | 1.59805 | | | |
| | 56 | −1.33781 | 0.276317 | | | |
| | 57 | −1.23813 | 0.034072 | | | |
| | 58 | −1.04827 | 1.94868 | | | |
| | 59 | 0.916347 | 1.52237 | | | |
| TYR | 0 | −1.24649 | 1.35514 | | | |
| | 1 | −1.40474 | 1.28138 | | | |
| | 2 | −1.06901 | −0.98635 | | | |
| | 3 | −1.94855 | 2.45936 | | | |
| | 4 | −1.28945 | −0.01512 | | | |
| | 5 | −2.73772 | −0.80021 | | | |
| | 6 | 0.849111 | 1.35644 | | | |
| | 7 | −1.15944 | −1.35352 | | | |
| | 8 | 1.34572 | 1.34623 | | | |
| | 9 | −3.0764 | 0.989076 | | | |
| | 10 | −1.12502 | −0.34171 | | | |
| | 11 | 3.1413 | 1.3452 | | | |
| | 12 | −1.11449 | 1.4013 | | | |
| | 13 | 3.02971 | 1.34225 | | | |
| | 14 | −1.46025 | 0.380864 | | | |
| | 15 | 2.71802 | 1.22414 | | | |
| | 16 | 3.04945 | 0.889491 | | | |
| | 17 | 1.23094 | −1.23318 | | | |
| | 18 | −3.01121 | 1.3124 | | | |
| | 19 | −1.30007 | −1.3243 | | | |
| | 20 | −1.46673 | −1.15267 | | | |
| | 21 | −0.95161 | 1.36018 | | | |
| | 22 | 2.90947 | 1.27066 | | | |
| | 23 | −2.87091 | 1.19322 | | | |
| | 24 | −2.63882 | 1.20498 | | | |
| | 25 | 1.10468 | 1.36428 | | | |
| | 26 | −0.95946 | −0.53998 | | | |
| | 27 | −1.6202 | 1.10778 | | | |
| | 28 | −1.0341 | −1.3658 | | | |
| | 29 | −2.96249 | 0.364077 | | | |
| | 30 | −1.24018 | −0.9017 | | | |
| | 31 | 1.50596 | −0.93641 | | | |
| | 32 | −0.73635 | −1.07187 | | | |
| | 33 | 0.638835 | 1.3188 | | | |
| | 34 | 0.974714 | 1.31877 | | | |
| | 35 | −0.90823 | −1.20687 | | | |
| VAL | 0 | −0.99582 | | | | |
| | 1 | −1.16271 | | | | |
| | 2 | 1.13505 | | | | |
| | 3 | 3.1272 | | | | |
| | 4 | 3.02197 | | | | |
| | 5 | −3.0276 | | | | |
| | 6 | 2.90399 | | | | |

What is claimed is:

1. A method for generating a molecular pose library, the method comprising:
obtaining structure data representing a plurality of conformations of a compound;
determining structural differences among the conformations;
classifying, based on the structural differences, the conformations into one or more dusters;
determining representative conformations of the clusters, wherein an average structural difference between a representative conformation of a cluster and conformations in the cluster is below a predetermined threshold; and
determining the representative conformations as poses of the compound.

2. The method of claim 1, wherein determining the structural differences comprises:
determining root-mean-square deviations (RMSDs) among the conformations; and
determining the structural differences based on the RMSDs.

3. The method of claim 2, wherein classifying the conformations comprises:
using a spectral clustering method to classify the conformations based on the RMSDs.

4. The method of claim 1, wherein determining the structural differences comprises:
computing, based on the structure data, dihedral angles descriptive of the conformations; and
using a K-means clustering method to classify the conformations based on the dihedral angles.

5. The method of claim 4, wherein:
the structure data includes coordinates of atoms in the compound; and
computing the dihedral angles comprises:
computing the dihedral angles based on the coordinates, predetermined bond lengths of the compound, and predetermined bond angles of the compound.

6. The method according to claim 1, wherein:
the structure data includes first data representing a first conformation; and
obtaining the structure data comprises at least one of:
when determining that the first data is missing an atom of the compound, rejecting the first data;
when determining that two non-bonded atoms represented by the first data are separated by a distance less than a predetermined distance value, rejecting the first data; or
when determining that a bond length represented by the first data differs from a standard length by more than a predetermined length, rejecting the first data.

7. The method of claim 1, wherein:
the structure data includes first data representing a first conformation; and
obtaining the structure data comprises:
computing dihedral angles descriptive of the first conformation, based on the first data, predetermined bond lengths of the compound, and predetermined bond angles of the compound;
generating second data based on the dihedral angles, the predetermined bond lengths, and the predetermined bond angles; and
when determining a difference between the first and second data exceeds a predetermined data difference, rejecting the first data.

8. The method according to claim 1, wherein the compound is an amino acid.

9. The method according to claim 1, wherein obtaining the structure data comprises:
extracting the structure data from at least one of a Protein Data Bank (PDB) file, an Extensible Markup Language (XML) fde, or a macromolecular Crystallographic Information File (mmCIF).

10. A molecular pose library generated by the method of claim 1.

11. A non-transitory computer-readable storage medium storing instructions that, when executed by one or more processors, cause the processors to perform a method for generating a molecular pose library, the method comprising:
obtaining structure data representing a plurality of conformations of a compound;
determining structural differences among the conformations;
classifying, based on the structural differences, the conformations into one or more clusters;
determining representative conformations of the clusters, wherein an average structural difference between a representative conformation of a cluster and conformations in the cluster is below a predetermined threshold; and
determining the representative conformations as poses of the compound.

12. A method for predicting a conformation of an amino acid side chain, the method comprising:
determining one or more poses of the side chain in a protein or peptide environment, the poses being representative conformations of the side chain;
extracting features associated with the poses of the side chain;
constructing, based on the extracted features, feature vectors associated with the poses of the side chain;
computing, based on the feature vectors, energy scores of the poses; and
determining a proper conformation for the side chain based on the energy scores.

13. The method of claim 12, wherein determining one or more poses of the side chain in a protein or peptide environment comprises:
obtaining the one or more poses of the side chain from a molecular pose library of the side chain.

14. The method of claim 12, wherein determining the proper conformation comprises:
a) selecting a pose with the highest energy score;
b) generating a structural variation of the selected pose;
c) computing an energy score of the structural variation; and
d) when the computed energy score of the structural variation from step c) equals to or is smaller than the energy score of step a), determining the structural variation as the proper conformation.

15. The method according to claim 12, wherein:
the energy scores are dot products of the feature vectors and a weight vector; and
the method further comprising:
running a machine-learning algorithm to generate the weight vector.

16. The method of claim 15, further comprising:
using linear regression to solve the weight vector.

17. The method according to claim 12, wherein:
the energy scores are computed using a classification model; and
the method further comprising:
running a machine-learning algorithm to generate the classification model.

18. The method of claim 17, wherein the classification model includes at least one of logistic regression, support vector machines (SVM), or gradient boosting decision tree (GBDT).

19. The method according to claim 12, wherein:
the energy scores are computed using a ranking model; and
the method further comprising:
running a machine-learning algorithm to generate the ranking model.

20. The method of claim 19, wherein the ranking model includes at least one of RankLinear, RankSVM, or LambdaMART.

21. The method according to claim 12, wherein the features comprise:
self-potential features related to self-potential energy of the side chain;
solvent-exposure-potential features related to solvent exposure potential energy of the side chain; and
atom-pairwise-potential features related to atom pairwise potential energy of the side chain.

22. The method according to claim 21, further comprising:
identifying a backbone to which the side chain attaches;
determining one or more poses of the backbone in the protein or peptide environment; and
generating the self-potential features based on the poses of the side chain and the poses of the backbone.

23. The method of claim 22, wherein the backbone comprises l preceding amino acids of the side chain and r subsequent amino acids of the side chain, wherein l and r are integers, 0≦/≦3, and 0≦/≦3.

24. The method of claim 23, wherein determining the poses of the backbone comprises:
obtaining structure data representing a plurality of conformations of backbones, the backbones having a length of (l+r+1) amino acids;
determining structural differences among the conformations;
classifying, based on the structural differences, the conformations into one or more clusters;
determining representative conformations of the clusters, wherein an average structural difference between a representative conformation of a cluster and conformations in the cluster is below a predetermined threshold; and
determining the representative conformations as the poses of backbones that have the length of (l+r+1) amino acids.

25. The method of claim 21, further comprising:
identifying one or more atoms nearby the side chain;
determining solvent exposure areas of the atoms when the side chain is absent;
determining deviations of the solvent exposure areas when the side chain is present;
grouping the deviations according to types of the atoms; and
generating the solvent-exposure-potential features based on the grouped deviations.

26. The method of claim 25, wherein determining a solvent exposure area of an atom comprises:
generating probe points uniformly distributed around the atom;
identifying probe points that do not clash with other atoms; and
determining the solvent exposure area based on a number of the probe points that do not clash with other atoms.

27. The method of claim 21, further comprising:
identifying a pair of atoms forming a pairwise interaction;
determining a distance separating the two atoms;
identifying types of the two atoms;
determining an angle score associated with the pairwise interaction; and
generating the atom-pairwise-potential features based on the distance, the types of the atoms, and the angle score.

28. The method according to claim 12, wherein the energy scores of the poses are computed using a deep neural network.

29. A non-transitory computer-readable storage medium storing instructions that, when executed by one or more processors, cause the processors to perform a method for predicting a conformation of an amino acid side chain, the method comprising:
determining one or more poses of the side chain in a protein or peptide environment, the poses being representative conformations of the side chain;
extracting features associated with the poses of the side chain;
constructing, based on the extracted features, feature vectors associated with the poses of the side chain;
computing, based on the feature vectors, energy scores of the poses; and
determining a proper conformation for the side chain based on the energy scores.
